(19) United States
(12) Patent Application Publication
(10) Pub. No.: US 2004/0142683 A1
(43) Pub. Date: Jul. 22, 2004

(54) Programming interface layer of a service provider for data service delivery

(76) Inventors: Matt Clark, Carnation, WA (US); Shane Meyer, Redmond, WA (US); Chris Romanzin, Seattle, WA (US); Brian C. Roundtree, Kirkland, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/705,456

(22) Filed: Nov. 10, 2003

Related U.S. Application Data
(60) Provisional application No. 60/425,165, filed on Nov. 8, 2002.
(60) Provisional application No. 60/424,832, filed on Nov. 8, 2002.
(60) Provisional application No. 60/424,905, filed on Nov. 8, 2002.
(60) Provisional application No. 60/424,906, filed on Nov. 8, 2002.
(60) Provisional application No. 60/424,910, filed on Nov. 8, 2002.

(51) Int. Cl. H04M 3/00

(52) U.S. Cl. 455/418

(57) ABSTRACT

A programming interface layer and associated method, computer readable medium and apparatus are provided for service provider delivery of solutions to wireless mobile devices. The programming interface layer including solution delivery functions usable by any of a plurality of vendors to deliver solutions via the service provider.

### CROSS-REFERENCE TO RELATED APPLICATIONS

This application claims the benefit of U.S. Provisional Application No. 60/425,165, filed on Nov. 8, 2002, entitled VENDOR APPLICATION PROGRAMMING INTERFACE OF A SERVICE PROVIDER APPLICATION FOR CLIENT-SERVER BASED SERVICE DELIVERY; U.S. Provisional Application No. 60/424,832, filed on Nov. 8, 2002, entitled SERVICE-VENDOR REQUEST PROCESSING FOR CLIENT-SERVER SERVICE DELIVERY; U.S. Provisional Application No. 60/424,905, filed on Nov. 8, 2002, entitled APPLICATION PACKAGING AND BRANDING IN A FEATURE/SERVICE/SOLUTION CLIENT-SERVER DELIVERY ENVIRONMENT; U.S. Provisional Application No. 60/424,906, filed on Nov. 8, 2002, entitled FEATURE-BASED SOLUTION PROVISIONING FOR CLIENT-SERVER DATA SERVICES; and U.S. Provisional Application No. 60,424,910, filed on Nov. 8, 2002, entitled FEATURE/CONCEPT BASED LOCAL REQUEST FORMATION FOR CLIENT-SERVER DATA SERVICES, the specifications and drawings of which are incorporated herein in full by reference.

### FIELD OF THE INVENTION

The present invention relates to the fields of data processing and wireless communications. More specifically, the present invention relates to request formulation on a client device for consumption of server-based data services, having particular application to data service consumption using wireless mobile communication devices.

### BACKGROUND OF THE INVENTION

Historically, client-server based service delivery has often been server centric, that is, with the servers performing the bulk of the processing, and the clients being tightly coupled and/or persistently connected to the servers. This is especially true in the case of the “thin” clients.

With advances in microprocessor and related technologies, the processing power of client devices, including wireless client devices such as wireless mobile phones and personal data assistants (“PDAs”), has increased significantly. While, increasingly, more processing is being distributed onto the client devices, e.g. through the use of distributed applets, client-server based service delivery, especially browser/web based service delivery, continues to require tight coupling and/or substantially persistent connections between the client devices and the servers.

With the advance of the Internet, World Wide Web (“WWW”), and most recently a new generation of wireless “telephony” network, the potential for delivery of a wide range of services to users of client devices continues to expand.

However, accessing services through the WWW, in particular, through wireless mobile devices, such as wireless mobile phones, has proved to be cumbersome and undesirable.

A number of “integration” technologies are emerging to enable different web-based services to be more easily integrated and presented as a “single” application. However, the approach is “integrator” centric. Further, the approach continues to require substantially persistent connections between the client devices and the servers, which is undesirable for wireless mobile devices consuming data services through the wireless telephony network, as the consumption of network resources, such as “air time” is costly.

### BRIEF DESCRIPTION OF DRAWINGS

The present invention will be described by way of exemplary embodiments, but not limitations, illustrated in the accompanying drawings in which like references denotes similar elements, and in which:

FIG. 1 is a pictorial diagram of a number of devices connected to a network which provide a client device also connected to the network with data services in accordance with embodiments of the present invention.

FIG. 2 is a block diagram of a client device that provides an exemplary operating environment for an embodiment of the present invention.

FIG. 3 is a block diagram of a framework server that provides an exemplary operating environment for an embodiment of the present invention.

FIG. 4 is a diagram illustrating the actions taken by devices in a framework system to provide data services in response to feature/concept based requests in accordance with embodiments of the present invention.

FIG. 5 is a flow diagram illustrating a concept gathering subroutine in accordance with embodiments of the present invention.

FIG. 6 is a flow diagram illustrating a solution rendering subroutine in accordance with embodiments of the present invention.

FIG. 7 is a flow diagram illustrating a request handling subroutine in accordance with embodiments of the present invention.

FIG. 8 is a flow diagram illustrating a solution processing subroutine in accordance with embodiments of the present invention.

FIG. 9 is a flow diagram illustrating a result handling subroutine in accordance with embodiments of the present invention.

FIG. 10 is a diagram illustrating the actions taken by devices in a framework system to provide data services in response to solution commands in accordance with embodiments of the present invention.

FIGS. 11a-d are exemplary screen shots of concept gathering displays in accordance with embodiments of the present invention.

FIG. 12 is a diagram of an exemplary feature tree in accordance with embodiments of the present invention.

FIGS. 13a-c illustrate exemplary solution data structures in accordance with embodiments of the present invention.

FIG. 14 is a diagram illustrating the actions taken by devices in a framework system to provide supplemental information in accordance with embodiments of the present invention.

FIG. 15 is an exemplary screen shot of a branded display in accordance with embodiments of the present invention.

### DETAILED DESCRIPTION OF EMBODIMENTS OF THE INVENTION

The detailed description which follows is represented largely in terms of processes and symbolic representations of operations by conventional computing components, including processors, memory storage devices for the processors, connected display devices and input devices, all of which are well-known in the art. These processes and operations may utilize conventional computing components in a heterogeneous distributed computing environment, including remote storage servers, computer servers, and memory storage devices, such processes, devices, servers and operations also being known to those skilled in the art and others. Each of these conventional distributed computing components may be accessible by the processors and devices via a communications network.

Embodiments of the present invention include feature/concept based request formations on a client device for the consumption of data services, having special application to the consumption of data services using a wireless mobile device. Such embodiments of the present invention may include installing features and complementary logic on a client device. Each feature may include a “feature tree” of associated “concept leaves”; and the complementary logic allows a user to locally formulate a request for any one of a wide ranges of data services by traversing the concept leaves of such a feature tree of the data service.

Other embodiments of the present invention may include provisioning of solutions in response to such feature/concept requests for data services on a client device. Such embodiments contemplate the installation of feature-based solution-related templates on one or more servers. For each feature, the solution-related templates may include at least a solution template describing how results returned for a request for service are to be organized and provided to the client device.

In various embodiments, the solution-related templates may also provide for an index fragment for organizing multiple results, such that multiple results may be provided in fragments for certain client devices, such as wireless mobile devices with small displays. Additionally such fragments may allow for the aggregation of multiple solution components from multiple vendor sources. In other various embodiments, the solution provisioning approach of the present invention may support provisioning of supplemental information while the user waits for a requested solution.

In still other embodiments of the present invention, the solution provisioning approach may support “buttons” for use by the user in viewing the solutions provided. Other further embodiments may provide a solution provisioning approach that supports “actions” to be taken by the user, e.g., purchasing, reserving and so forth (in e.g. the form of solution commands).

Yet further embodiments of the present invention may include a solution provisioning approach that supports the automatic updating of various data structures and/or databases of various applications that support “open” update of their data structures and/or databases, such as favorites, calendars and so forth.

Embodiments of the present invention may include a service-vendor based architecture for services, and vendor provisioning of services, to be added to a client-server based service delivery framework (“framework”). In one embodiment, the framework may include an engine and a service provider application controlling a number of service applications, which in turn interface with a number of vendors in actually providing the services. Any application the engine calls (through the service provider) to fulfill a user request is considered a service application, so long as it compatibly implements the vendor service provision protocols defined by the framework, which in one embodiment is extensible markup language (“XML”) based.

In various embodiments of the present invention, communications in the framework are conducted using the hypertext transfer protocol (“HTTP”). The feature/concept based request and subsequent reply for services are both formed with XML and communicated using HTTP. In such an embodiment, the service provider creates a request object from the incoming XML document, identifies the service class to use by mapping a feature identifier (“FID”) against configuration data, loads the service and passes the request object to the service within the command method specified in the request for service. The service executes the requested command and returns a response object to the service provider application as a return value of the command method. The service provider application then turns the response objects into the appropriate XML document for processing into a solution for the requesting client device. The service typically interfaces with one or more vendors to develop the response. In various embodiments, the service provider includes an application programming interface (“API”) for facilitating services development and interacting with vendors. Such an API may be in any appropriate programming format such as “JAVA” or “.NET” compatible programming languages. The API advantageously extracts the communication layer and XML formation so vendors may focus on the business rules associated with the services being implemented. One implementation of the API is set forth below.

Embodiments of the present invention may also include an application packaging and branding aspect. The packaging and branding of embodiments of the present invention is particularly suitable for a client server based service delivery environment, where each deliverable service comprises a number of features customized for a “brand”. Similarly, feature trees may be defined to assist in the formulation of request, and feature based solution templates may be defined to process results that return from requests for these feature-based services. These feature trees, solution templates, and so forth may then be used in conjunction with branding elements to form brandable service packs with applications having features and solutions. The application may also include one or more of: documents, cascading style sheets, images, favorites (cross applications updateable items), buttons, colors, fonts, text, labels, and the like.

As previously explained, embodiments of the present invention may operate in a wireless network to communicate between wireless mobile devices and other computing devices and/or servers. It will be appreciated by those of ordinary skill in the art that other networks may be used in addition to a wireless network, e.g., “the Internet” which refers to the collection of networks and routers that communicate between each other on a global level using the Internet Protocol (“IP”) communications protocol (a substantial portion of which is wireline based).

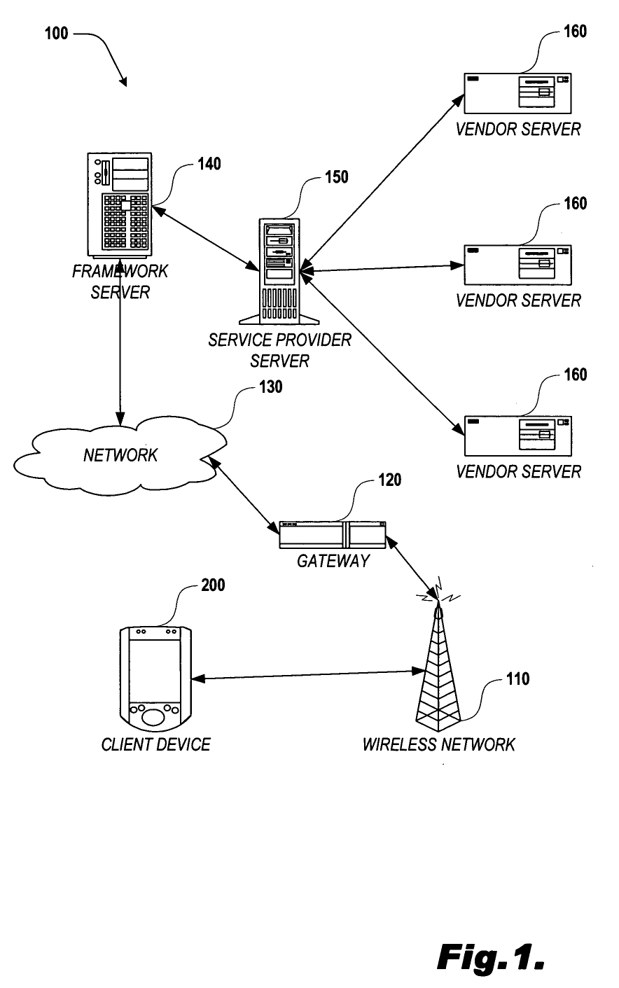

FIG. 1 is a pictorial diagram of an exemplary data service provisioning system (“framework system”) 100 for providing data services to wireless mobile devices such as client device 200 via a wireless network 110 and other networks 130. For ease of illustration, the client device 200 is shown pictorially as a personal data assistant (“PDA”) in FIG. 1, it being recognized that a large number of client devices in a variety of forms would be included in an actual framework system 100 employing embodiments of the present invention. In general, the client device 200 has computing capabilities and may be any form of device capable of communicating with the framework server 140 in various embodiments of the present invention. Thus, while client device 200 is pictorially shown as a PDA, a mobile computer, cellular phone or the like may be equally employed, although these are just representative devices and should be taken as illustrative and not limiting.

The framework system 100 functions in a distributed computing environment that includes a plurality of client devices 200, interconnected by a wireless network 110 via a gateway 120 to other networks 130 to a framework server 140. The framework server 140 in turn is also connected to a service provider server 150 in communication with vendor servers 160. All these communications and connections are interconnected via suitable network connections using suitable network communication protocols. In various embodiments, the service provider server 150 and vendor servers 160 communicate with each other in accordance with an API of one aspect of the present invention. The vendor servers 160 may be registered with service provider server 150. In alternate embodiments, the service provider server 150 and vendor servers 160 may communicate in accordance with open/standard protocols.

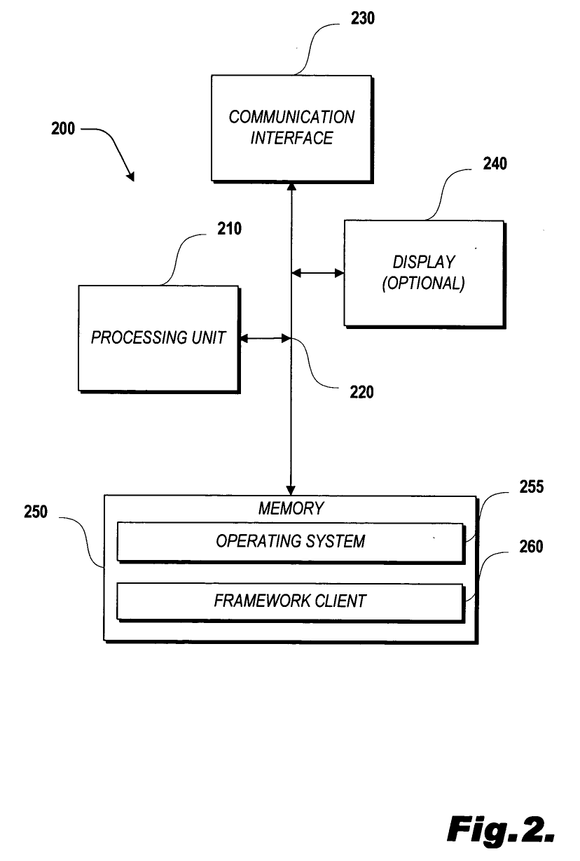

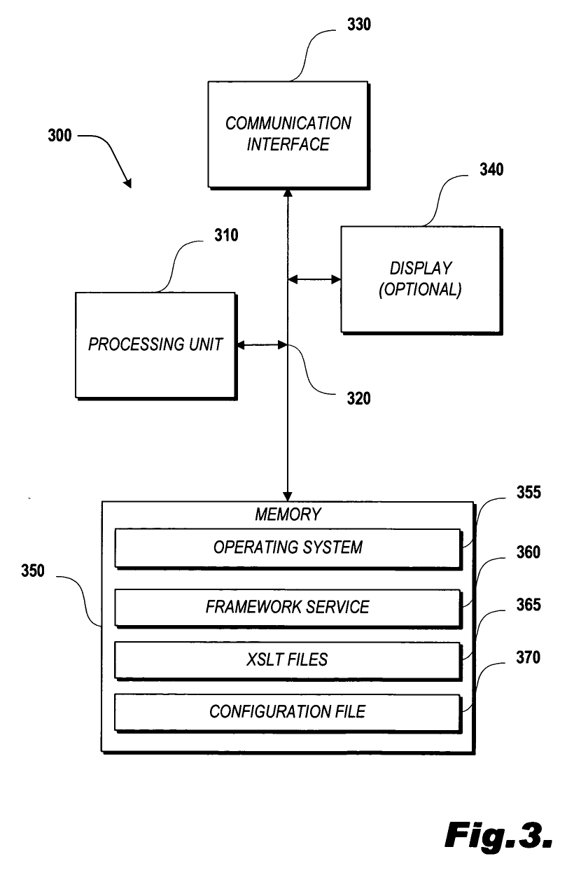

As will be appreciated by those of ordinary skill in the art, the framework server 140 may reside on any device accessible by the client device 200 shown in FIG. 1. An exemplary client device 200 is shown in FIG. 2 and described below. An exemplary combined framework server 300 is shown in FIG. 3 (combined with a service provider server 150) and described below.

It will also be appreciated that while the framework server 140 of the framework system 100 is illustrated as a single device, the framework server 140 may actually comprise more than a single device in an actual system practicing embodiments of the present invention. It will also be appreciated that the framework server 140 may be file servers, database servers or a mixture that includes file servers and database servers. It will further be appreciated by those of ordinary skill in the art, that while the framework server 140 and service provider server 150 are shown as separate devices, in other embodiments of the present invention the framework server 140 and service provider 150 may reside on a single device (as illustrated in FIG. 3). Similarly, the vendor services may be provided via remote vendor servers 160 or may reside on a device sharing either the framework server 140 functionality or service provider server 150 functionality.

FIG. 2 illustrates an exemplary client device 200 suitable for use in embodiments of the present invention. Those of ordinary skill in the art and others will appreciate that the client device 200 may include many more components than those shown in FIG. 2. However, it is not necessary that all of these generally conventional components be shown in order to disclose an enabling embodiment for practicing the present invention. As shown in FIG. 2, the client device 200 includes a communications interface 230 for connecting to remote devices. Those of ordinary skill in the art will appreciate that the communications interface 230 includes the necessary circuitry, driver and/or transceiver for such a connection and is constructed for use with the appropriate protocols for such a connection. In one embodiment of the present invention, the communication interface 230 includes the necessary circuitry for a wireless network connection.

The client device 200 also includes a processing unit 210, a display 240 and a memory 250, all interconnected along with the communications interface 230 via a bus 220. Those of ordinary skill in the art and others will appreciate that the display 240 may not be necessary in all forms of wireless computing devices and, accordingly, is an optional component. The memory 250 generally comprises random access memory (“RAM”), a read only memory (“ROM”) and a permanent mass storage device, such as a disk drive, flash RAM, and the like. The memory 250 stores an operating system 255 and a framework client 260 formed in accordance with embodiments of the present invention. In various embodiments, memory 250 also stores one or more feature trees (not shown), each comprising a number of concept leaves to facilitate local formulation of service requests in the form of goal statements for one or more services, and local rendering of returned solution sets to the service requests, to be described more fully below. As will be apparent from the description to follow the local formulation of service requests and rendering of returned solution sets may be performed requiring virtually no interactions with external servers, thereby saving air time (in the case of wireless client devices). Further, feature trees are particular suitable for service vendors to brand their services.

Additionally, framework client 260 may also maintain a list (not shown) of data items of various databases of applications (not shown) that support “open” update, i.e. allowing other applications to update these data items. Example of the data items include but are not limited to data items of a calendar application. In various embodiments, framework client 260 also maintains the method calls (not shown) to effectuate the updates. Examples of such methods may include Get and Put methods of a calendar application to allow reading from and writing into the calendar databases.

It will be appreciated that the software components (including the feature trees) may be loaded from a computer readable medium into memory 250 of the client device 200 using a drive mechanism (not shown) associated with the computer readable medium, such as a floppy, tape, DVD/CD-ROM drive, flash RAM or the communications interface 230.

The term “feature” as used herein refers to a prominent, significant, distinctive aspects of offered services, as the term is generally understood by those of ordinary skill in the art of online data service provision. Examples of features may include but are not limited Airline Reservation, Hotel Reservation, Car Reservation, Restaurant Reservation, and Location/Map Services.

The term “concept” as used herein refers to an abstract or generic idea of a feature, generalized from particular instances. It may have 1:1 or 1:n mappings to implementation data structures and/or items. Examples of concepts for an Airline Reservation feature may include but are not limited “departing city”, “arrival city”, “departure date”, “return date” and so forth.

The terms “object” and “methods” as used herein, unless the context clearly indicates to the contrary, are to be accorded their ordinary meanings as understood of those of ordinary skill in the art of object oriented programming.

Although an exemplary client device 200 has been described that generally conforms to conventional computing devices, those of ordinary skill in the art and others will appreciate that the client device 200 may be any of a great number of computing devices capable of communicating remotely with other devices. In various embodiments of the present invention, the client device 200 may be a cellular telephone, PDA, general purpose computing device or the like.

FIG. 3 illustrates an exemplary server 300 suitable for use as a combined framework server 140 and service provider 150 in embodiments of the present invention. Those of ordinary skill in the art and others will appreciate that the combined framework and service provider server 300 may include many more components than those shown in FIG. 3. However, it is not necessary that all of these generally conventional components be shown in order to disclose an enabling embodiment for practicing the present invention. As shown in FIG. 3, the combined framework and service provider server 300 includes a communications interface 330 for connecting to remote devices. Those of ordinary skill in the art will appreciate that the communications interface 330 includes the necessary circuitry, driver and/or transceiver for such a connection and is constructed for use with the appropriate protocols for such a connection. In one embodiment of the present invention, the communication interface 330 includes the necessary circuitry for a wired and/or wireless network connection.

The combined framework and service provider server 300 also includes a processing unit 310, a display 340 and a memory 350, all interconnected along with the communications interface 330 via a bus 320. Those of ordinary skill in the art and others will appreciate that the display 340 may not be necessary in all forms of computing devices and accordingly is an optional component. The memory 350 generally comprises RAM, ROM and a permanent mass storage device, such as a disk drive, flash RAM, or the like. The memory 350 stores an operating system 355, a framework service 360, extensible style sheet language (“XSL”) transformation (“XSLT”) files 365 and a configuration file 370 formed in accordance with embodiments of the present invention. It will be appreciated that the software components may be loaded from a computer readable medium into memory 350 of the combined framework and service provider server 300 using a drive mechanism (not shown) associated with the computer readable medium, such as a floppy, tape, DVD/CD-ROM drive, flash RAM or the communications interface 330.

Although an exemplary combined framework and service provider server 300 has been described that generally conforms to conventional computing devices, those of ordinary skill in the art and others will appreciate that the combined framework and service provider server 300 may be any of a great number of computing devices or clusters of computing devices capable of communicating remotely with other devices. In the latter case, the framework and service provider functions may be executed on separate servers, e.g. 140 and 150.

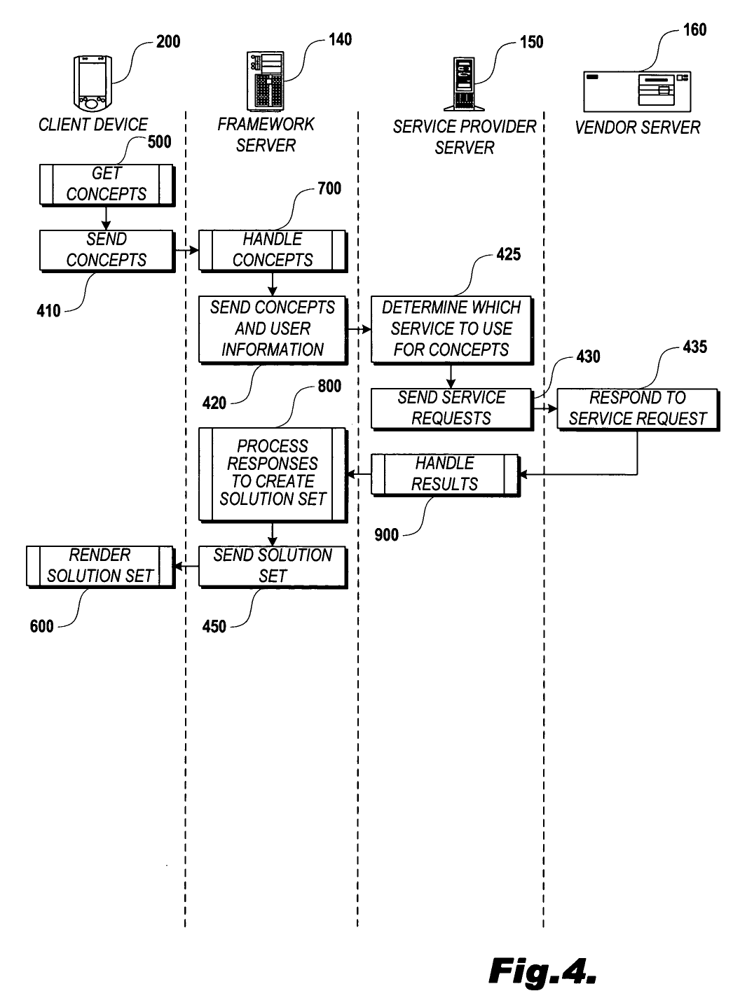

The operation of the feature/concept request formation and data service response formation of the framework system 100 shown in FIG. 1 will be understood by reference to FIG. 4, which includes one exemplary sequence of communication interactions between a client device 200, framework server 140, service provider server 150 and vendor server 160. It will be appreciated by those of ordinary skill in the art, that the communications between the devices illustrated in FIG. 4 may comprise any form of communication connections, including wireless signals (e.g., radio frequency “RF” signals, audio modulated signals, electromagnetic signals of other frequencies, optical signals, or combinations thereof) as well as conventional wire-based signals. Further, framework server 140 may involve multiple service provider servers 150 and in turn, multiple venders 160 in the service of a concept. Similarly, a service provider server 150 may on its own involve multiple vender servers 160 in the service of a concept. However, for ease of understanding, the description to follow will concentrate on the communication between framework server 140 and a service provider server 150, and between a service provider server 150 and a vendor server 160.

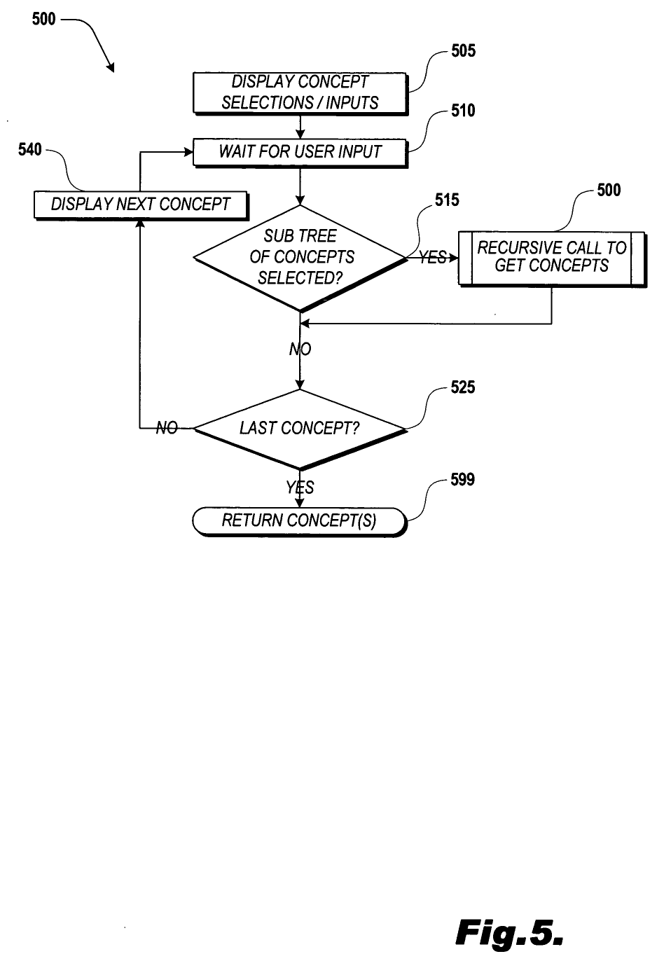

The exemplary communication interactions and processing shown in FIG. 4 begin at subroutine block 500 of framework client 260 on the client device 200 where one or more concepts of a feature are gathered for a data service request in the form of a goal statement. Subroutine 500 is illustrated in FIG. 5 and described in further detail below. The term “goal statement” as used herein refers to an aggregated expression of the concepts of a feature. An example of a goal statement for a Airline reservation feature may be “Flying from the Bay Area into the Chicago area in the middle of this week, and returning in the middle of next week”. Note that in the above example, the concepts of the departure and arrival “cities” and “time” are not particularized to any airport and hour. As will be apparent from the description to follow, the novel concept, goal statement and feature organization of embodiments of the present invention enables the client devices to be substantially sufficient in formulating a data service request without having to consume valuable air time. A factor that makes this possible is the service request in the form of a goal statement having concepts of a feature may be expressed without implementation details of the services (which prior art techniques like URL or SQL queries require).

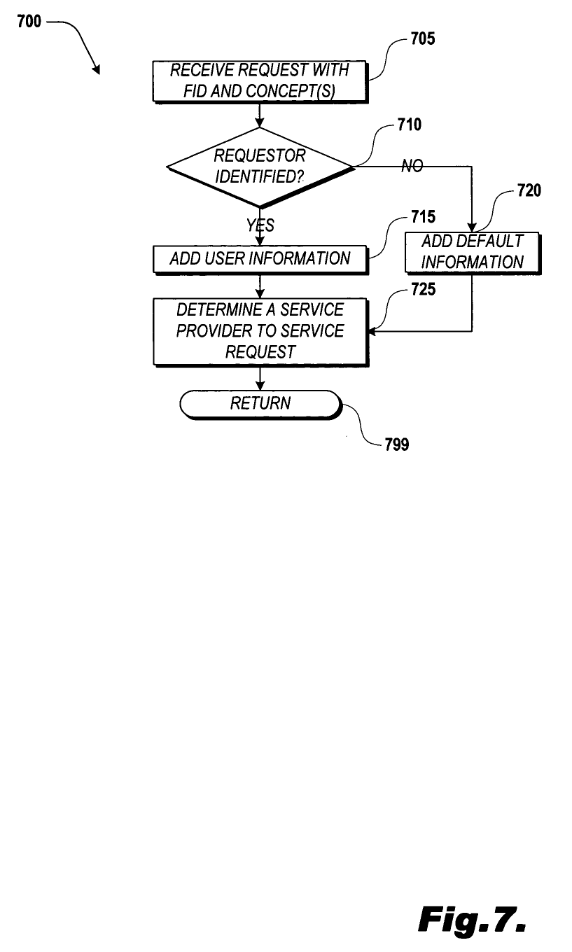

Processing then continues to block 410 where the client device 200 sends the concepts returned from subroutine 500 to the framework server 140. Next, in subroutine block 700, the framework server 140 (more specifically, to a service such as framework service 360) handles the received concepts, e.g., adds user and other “stable” and/or default information to the received concepts. Subroutine 700 is illustrated in FIG. 7 and described below. Once subroutine 700 returns, processing continues to block 420 where the framework server 140 sends the concepts augmented with user information to the service provider server 150. Examples of user and other “stable” and/or default information include but are not limited to, the user's name, addresses, phone numbers, email address, age, social security numbers, and so forth. Thus, while the service requests may be advantageously formulated on the client device, substantially without interaction with external servers, saving air time, the formulation is streamlined to avoid having the user to re-enter stable/default information.

As already noted above, in various embodiments of the present invention the framework server 140 and the service provider server 150 may reside on a single server. In such an embodiment, the framework server and service provider server may be separate processes running on the same physical server.

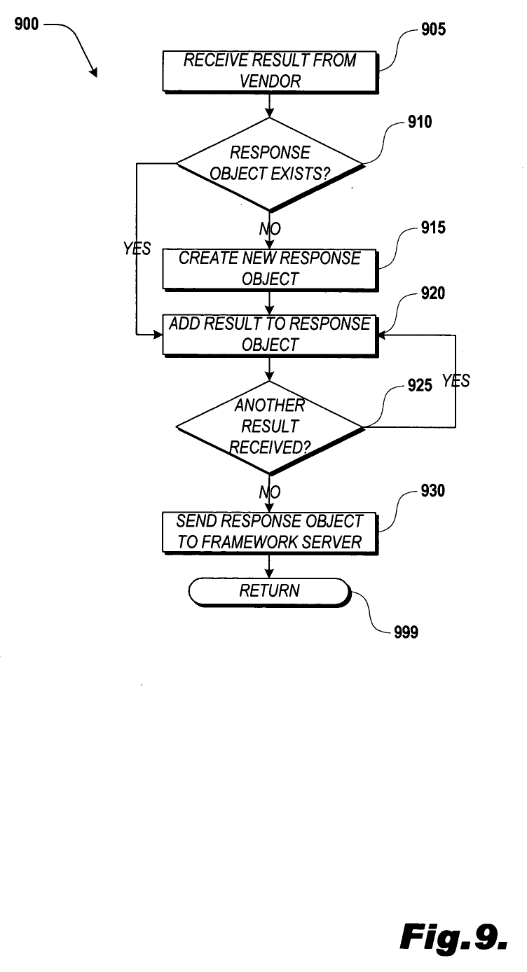

The service provider server 150 (more specifically, framework service 360) is next operative, in block 425, to determine which service to use to respond to the received service request comprising the feature/concepts Next, in block 430, the service provider server 150 formulates one or more service requests for one or more service vendors, and sends the service request (or requests) to the vendor server (or servers) 160 that were determined in block 425. At each vendor server 160 the service request is responded to in block 435, with the response being directed back to the service provider server 150. In subroutine block 900, the service provider server 150 handles received service results. Subroutine 900 is illustrated in FIG. 9 and described below.

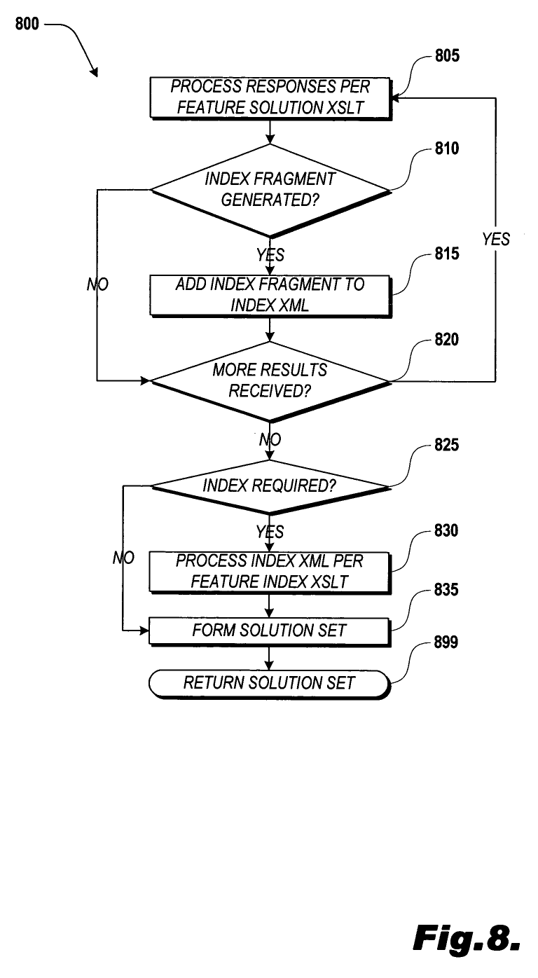

Once subroutine 900 returns, the framework server 140 processes the responses to create a solution set in subroutine block 800. Subroutine 800 is illustrated in FIG. 8 and described below.

In various embodiments, as alluded to earlier, and to be described in more detail below, the service results returned by a service vendor may include commands to be included in the solution set. The service results may also causes one or more new feature tree of concepts to be add to the client device, to allow the user of the client device to formulate a service request of a feature it did not have. For example, a client device may be initially loaded with a feature to make airline reservation. A hotel reservation feature and its concepts may be dynamically added to the client device as part of a reservation solution returned for a reservation request.

In various embodiments, the communications and cooperation with vendor servers 160 are effectuated via an API of one aspect of the present invention. The API advantageously allow multiple vendors to provide the offered services, including multiple vendors providing the same service, an aspect of great benefit to the data service consumers.

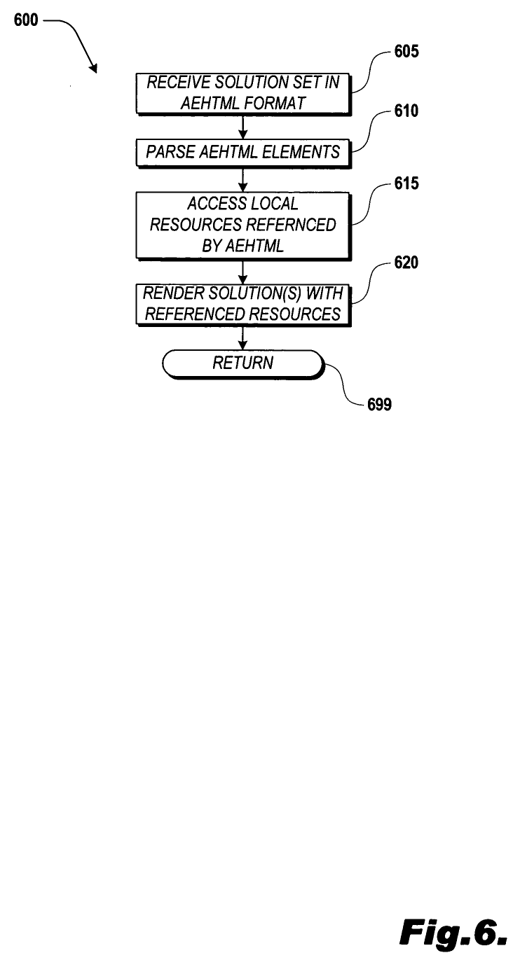

Once subroutine 800 returns with a solution set, in block 450 the framework server 140 sends the solution set back to the client device 200. On the client device 200 the solution set is processed by the framework client 260 and rendered in subroutine block 600, thereby providing a response to the feature/concepts data service request. Subroutine 600 is illustrated in FIG. 6 and described below.

The framework system 100, described herein, includes a client device 200 that gathers concepts to be used in requesting data services from the framework server 140. FIG. 5 is a flow diagram illustrating an exemplary client-side concept gathering subroutine 500 of framework client 260 suitable for implementation by the client device 200. Subroutine 500 begins at block 505, where the first concept selection/input is displayed to a user of the client device 200. Next the subroutine waits for user input at block 510. Once input has been received, processing proceeds to decision block 515 where a further determination is made whether the selection is the root of a sub-tree that requires additional user input. If so, processing continues to a recursive call to the get concepts subroutine 500. If, however, in decision block 515 it was determined that the input received was a concept leaf input, processing continues to decision block 525, where a determination is made whether subroutine 500 is finished getting concepts; if not, the next concept is displayed to the user in block 540 and processing loops back to before block 510. If, however, in decision block 525, it was determined that subroutine 500 is finished getting concepts, processing continues to block 599 where the selected concept or concepts are returned to the location where subroutine 500 was invoked.

In one embodiment of the present invention the results of a client device feature/concepts request are processed and rendered according to subroutine 600. FIG. 6 is a flow diagram illustrating an exemplary client-side result rendering subroutine 600 of framework client 260 suitable for implementation by the client device 200. Subroutine 600 begins at block 605, where a solution set in AEHTML format is received. Each solution in the solution set is an AEHTML file that is a combination of HTML and special AEHTML Elements in XML format. The XSLT that get applied to achieve a solution set in AEHTML format are chosen by the framework server based at least in part on a FID and type of client device 200.

Next the subroutine parses the AEHTML elements in block 610. Once the AEHTML input has been parsed, processing proceeds to block 615 where local resources references by the AEHTML are accessed. The framework client 260 then renders the solution or solutions in the framework set with the referenced local resources in block 620. When a solution is displayed on a client device 200, other resources (e.g., cascading style sheets, buttons, text and images) may combine to display the final solution. Processing then continues to block 699 where the solution set is returned to the point where subroutine 600 was called.

In embodiments of the present invention, the framework server 140 handles incoming feature/concept requests according to the logic of subroutine 700. FIG. 7 is a flow diagram illustrating an exemplary framework server request handling subroutine 700 suitable for implementation by the framework server 140. Subroutine 700 begins at block 705, where a feature/concepts request is received with an FID and at least one concept. The framework server 140 next determines whether the requestor was identified (and accordingly whether identifying information is available) in decision block 710. If so, then processing proceeds to block 715 where user identifying information is added to the feature/concept request. If, however, the requestor was not identified, the processing proceeds to block 720 there default information is added to the feature/concepts request.

Once information either user information or default information has been added to the feature/concepts request, subroutine 700 proceeds to block 725 where a determination is made as to which service provider server 150 will service the feature/concept request. Those of ordinary skill in the art and other will appreciate that if a single service provider server 150 exists, or if a single combined framework server 300 is in use, then all requests would go to the single server. Other determinations may rely on such factors a particular vendors registered with a service provider server 150, or conventional factors, such as load-balancing. Processing then continues to block 799 where processing returns to the point where subroutine 700 was called.

As noted above, the framework server 140 includes processing functionality (embodied e.g. in framework service 360) for processing solutions to requested data services that are to be delivered to a client device 200. Accordingly, FIG. 8 illustrates a response processing subroutine 800 for processing data service responses before providing them to a client device 200. Subroutine 800 begins at block 805 where the response or responses received from the service provider server 150 are processed according to a feature solution XSLT associated with a feature. Next, in decision block 810, a determination is made whether the processed response generated an index fragment. The term “index fragment” as used herein refers to a piece of a multi-part solution. As will be appreciated by those skill in the art, the employment of index fragment advantageously allows the solutions to be presented in a scalable manner, accommodating a wide range of display capabilities of various wireless mobile devices.

If an index fragment was generated, processing continues to block 815 where the index fragment is added to an index XML. The term “index XML” as used herein refers to a multi-part solution data structure. If, however, in decision block 810 (or after adding the index fragment to the index XML) it was determined that no index fragment was generated then processing continues to decision block 820. In decision block 820, a determination is made whether more results were received. If more results were received, processing loops back to block 805 where the additional response is processed per the feature solution XSLT. If, however, in decision block 820 it was determined that no more results were received, processing continues to decision block 825 where a determination is made whether an index required (i.e., a solution with multiple parts has been provided). If so, then in block 830, the index XML is processed per the feature index XSLT (a specific XSLT for processing multi-part solutions for delivery to a client device). If, in decision block 825 (or after processing the index XML per the feature index XSLT), it was determined that an index was not required, processing continues to block 835 where a solution set is formed. Processing then continues to block 899 where the solution set is returned to the point where subroutine 800 was called.

Embodiments of the present invention enable the service provider server 150 to handle incoming vendor results so as to provide the framework server 140 with a response object in which to process solutions for the client device 200. FIG. 9 is a flow diagram illustrating an exemplary service provider server result handling subroutine 900 suitable for implementation by the service provider server 150. Subroutine 900 begins at block 905, where a result is received from a vendor server 160 with at least one result to a feature/concepts request. Processing proceeds to decision block 910 where a determination is made whether a response object exists. If so, then processing proceeds directly to block 920. Otherwise, if no response object exists, then processing proceeds to block 915 where a new response object is created. Next, in block 920, the received response is added to the response object (e.g., by use of an “AppendResult” method from the service provider API). Processing proceeds to decision block 925 where a determination is made whether another result has been received. If so, then processing cycles back to block 920. Once it has been determines in decision block 925 that not more results have been received, processing proceeds to block 930 where the response object is sent to the framework server 150. Subroutine 900 continues to block 999 where processing returns to the point where subroutine 900 was called.

In various embodiments, the framework system 100 also advantageously allows issueable commands to be included as part of the returned solution sets (also referred to as “solution commands.” The solution commands may be inserted or caused to be inserted into the solution sets by the service vendor providing the services or by the framework and/or service provider server 140 and 150.

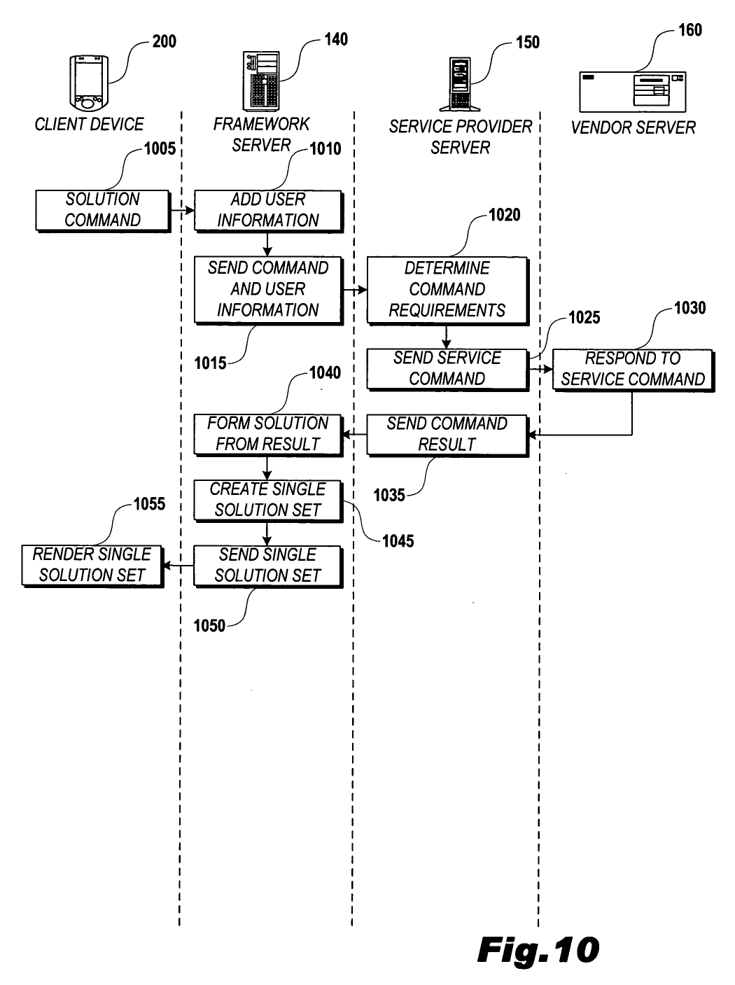

The solution commands are serviced in a similar manner as the feature/concept based service response, as illustrated in FIG. 4. In particular, once a solution has been returned to a client device 200, a command may be then issued in response to the solution. Example commands may include reserving, purchasing, accepting, canceling, modifying a returned solution. Those of ordinary skill in the art and other will appreciate that yet other command may be used in other embodiments of the present invention. FIG. 10 is a flow diagram illustrating an exemplary solution command and response scenario that includes one exemplary sequence of communication interactions and processes with reduced client device communications (and airtime usage) between a client device 200, framework server 140, service provider server 150 and vendor server 160. It will be appreciated by those of ordinary skill in the art, that the communications between the devices illustrated in FIG. 10 may comprise any form of communication connections, including wireless signals as well as conventional wire-based signals.

The exemplary communication interactions shown in FIG. 10 begin at block 1005 where the client device 200 (more specifically, framework client 260) sends a solution command to the framework server 140. Next in block 1010 the framework server 140 may likewise add user and/or other stable/default information to the sent command, and processing continues to block 1015 where the framework server 140 sends the solution commands augmented with user and/or stable/default information to the service provider server 150. The service provider server 150 is then operative, in block 1020, to determine which service to use to respond to the received command. Next, in block 1030, the service provider server 150 formulates one or more service commands for one or more service vendors, and sends the service command(s) to the vendor server(s) 160 associated with the service(s) determined in block 1020. Note that this may or may not be the service vendor(s) who provided the service(s) that led to the solution set including the solution command being processed. At each vendor server 160, each service command is responded to at block 1030 with the response being directed back to the service provider server 150. In block 1035, the service provider server sends the command result(s) to the framework server 140. The framework server 140 processes the result(s) to form a solution and, in block 1040, a single-solution solution set is created. Next, in block 1050, the framework server 140 sends the solution set back to the client device 200. On the client device 200, the single-solution solution set is processed and rendered in block 1055, thereby providing a response to the solution command.

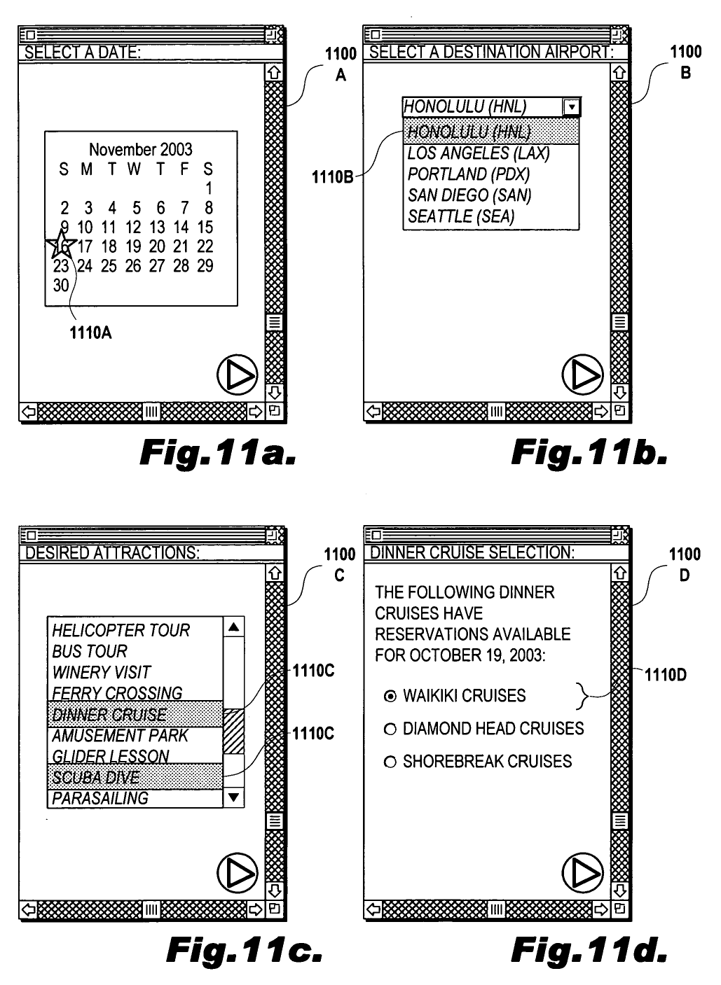

In addition to the diagrams illustrated in FIGS. 4-10 showing the gathering of concepts, commands and provision of solutions, FIGS. 11-13 illustrate alternate end-user views of the concept gathering and solution provisioning aspects of embodiments of the present invention. FIGS. 11a-b illustrate exemplary screen shots of concept gathering screens in a travel feature on a client device 200. FIG. 11a illustrates a selectable calendar screen shot 1100A in which a particular user interface date (a concept) component 1110A has been selected. FIG. 11b illustrates a destination airport (another concept) selection screen 1100B in which a destination airport user interface component 1110B has been selected. FIG. 111c illustrates an attraction selection screen shot 1100C in which attraction (still more concepts) user interface components 1110C have been selected. Finally, FIG. 11d illustrates a dinner cruise selection screen shot 1100D in which a particular dinner cruise (yet another concept) user interface component 1110D has been selected. Note that each concept may map to one or more implementation data structures and/or one or more data fields.

Viewed collectively, screen shots 1100A-D illustrate the gathering of various concepts of the “travel” feature to form a “goal sentence” in a particular feature by using user interface components. Concepts are the elements that are gathered at the client device 200 to determine what a data service request from remote servers. A goal sentence is one way of expressing the combined concepts used in requesting data services. An exemplary goal sentence formed from the concepts shown in FIGS. 11a-d might be: “traveling to Honolulu on Nov. 16, 2003, and requesting a scuba dive and a Waikiki Cruises dinner cruise.” Unlike previous systems, the concepts gathered at the client device 200 are gathered from the previously loaded into the memory 250 of the client device 200. Accordingly, instead of a communication-intensive interaction with remote servers, the concept gather occurs mainly on the client device 200 in embodiments of the present invention.

In some embodiments of the present invention, a goal sentence or a selection of concepts is maintained in a traversable data structure, such that individual concepts may be traversed to and modified. In such an embodiment, and other concepts that were dependent on a modified concept would be modified or removed accordingly.

Those of ordinary skill in the art and others will appreciate that a single goal sentence is not necessarily a complete specification of all aspects of the concepts included in the request. Accordingly, in some embodiments of the present invention, dynamic concepts are used such that incomplete goal sentences may be submitted to the framework server 140 which, possibly in communication with the service provider server 150 and/or the vendor servers 160, may return further queries that will allow a more complete goal sentence to be submitted for the acquisition of data services. FIGS. 11a-d are merely meant as illustrative examples of screenshots in which concepts may be gathered and are not meant to be limiting on the embodiments of the present invention. For example, if a selected feature embodied restaurants, then the concepts gathered for the restaurants feature would relate to the type of actions desired (e.g., recommendations, reservations, take-out, delivery, etc.) as well as relevant restaurant types, locations, etc.

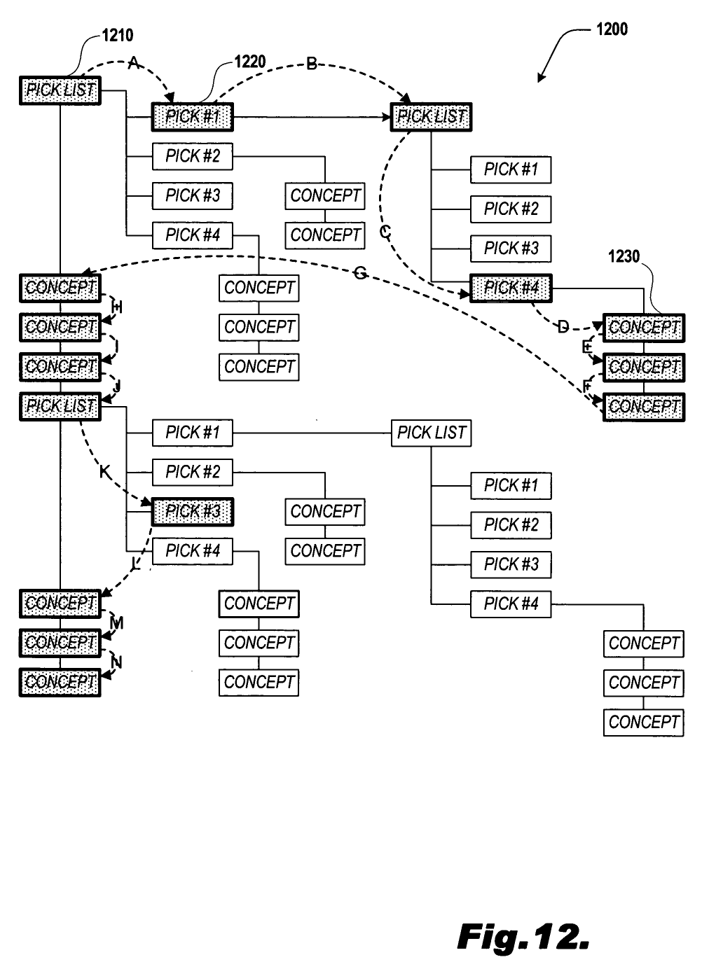

FIG. 12 illustrates an exemplary feature tree 1200 with pick lists 1210 and sub-pick lists 1220 that are used to select leaf nodes/concepts 1230 of the feature tree 1200. The feature tree 1200 illustrated in FIG. 12 shows a selection path indicated by curved arrows A-N in which various pick lists 1210, sub-pick lists 1220 and concepts 1230 are navigated through and selected to form a feature/concepts request such as would be formed in subroutine 500.

In embodiments of the present invention, each feature tree of concepts that is used to select features for requesting data services is expressed in XML. Complementary logic (e.g. generically implemented as part of framework client 260) is used to traverse the feature trees in order to retrieve concepts. In one exemplary embodiment, each feature XML file comprises sections that describe the resources that will be used in the feature, the labels, the behavior and the concept tree that the user will walk to build a request. One such exemplary “schema” is illustrated in Table 1 below.

TABLE 1

```
<!ELEMENT category (#PCDATA)>
<!ELEMENT cmd (#PCDATA)>
<!ELEMENT concepts (r | mail)>
<!ELEMENT label EMPTY>
<!ATTLIST label
    txt CDATA #REQUIRED
    icon CDATA #REQUIRED
    view (icon | list | menu) #IMPLIED
>
<!ELEMENT logo EMPTY>
<!ATTLIST logo
    id CDATA #REQUIRED
    pos (b | t) #REQUIRED
>
<!ELEMENT mail (cmd)>
<!ATTLIST mail
    y CDATA #REQUIRED
>
<!ELEMENT r EMPTY>
<!ATTLIST r
    g CDATA #IMPLIED
    y CDATA #IMPLIED
    p CDATA #IMPLIED
    t CDATA #IMPLIED
    f CDATA #IMPLIED
    fs (0 | 1) #IMPLIED
>
<!ELEMENT resource (category, ui, rsources?, concepts)>
<!ATTLIST resource
    t CDATA #REQUIRED
    id CDATA #REQUIRED
    ver CDATA #REQUIRED
    fmt CDATA #IMPLIED
    mod CDATA #IMPLIED
    sz CDATA #IMPLIED
>
<!ELEMENT resources (rsc*)>
<!ELEMENT rsc EMPTY>
<!ATTLIST rsc
    t (css | img) #REQUIRED
    id CDATA #REQUIRED
>
<!ELEMENT ui (label+, logo?)>
<!ATTLIST ui
    reqcount CDATA #IMPLIED
```

An exemplary XML document conforming to the schema shown in Table 1 is also illustrated below.

```
TABLE 2
<resource fmt=“xml” id=“flower” mod=“200204090802” sz=“7496” t=“feature” ver=“0”>
  <category>Shopping</category>
  <ui>
    <label icon=“actionflowers_1st” txt=“Flowers” view=“list”/>
    <logo id=“actionflowers_lgo” pos=“b”/>
  </ui>
  <resources>
    <rsc id=“_contact_1st” t=“img”/>
    <rsc id=“def2_bl” t=“img”/>
    <rsc id=“actionFlowers_css” t=“css”/>
    <rsc id=“actionFlowers_ico” t=img”/>
    <rsc id=“actionFlowers_lgo” t=“img”/>
    <rsc id=“actionFlowers_hdr_idx” t=“img”/>
    <rsc id=“actionFlowers_hdr_sol” t=“img”/>
    <rsc id=“actionFlowers_btn_select” t=“img”/>
    <rsc id=“actionFlowers_btn_purchase” t=“img”/>
    <rsc id=“actionFlowers_btn_view” t=“img”/>
    <rsc id=“actionFlowers_A14-BPC” t=“img”/>
    <rsc idactionFlowers_A16-AB” t=“img”/>
    <rsc idactionFlowers_A17-PMU” t=“img”/>
    <rsc idactionFlowers_A18-TAB2” t=“img”/>
    <rsc idactionFlowers_C9-2985” t=“img”/>
    <rsc idactionFlowers_D8-3062” t=“img”/>
    <rsc idactionFlowers_D9-3072” t=“img”/>
    <rsc idactionFlowers_D10-3047” t=“img”/>
    <rsc idactionFlowers_D11-3037” t=“img”/>
    <rsc idactionFlowers_A14-BPC_big” t=“img”/>
    <rsc idactionFlowers_A16-AB_big” t=“img”/>
    <rsc idactionFlowers_A17-PMU_big” t=“img”/>
    <rsc idactionFlowers_A18-TAB2_big” t=“img”/>
    <rsc idactionFlowers_C9-2985_big” t=“img”/>
    <rsc idactionFlowers_D8-3062_big” t=“img”/>
    <rsc idactionFlowers_D9-3072_big” t=“img”/>
    <rsc idactionFlowers_D10-3047_big” t=“img”/>
    <rsc idactionFlowers_D11-3037_big” t=“img”/>
  </resources>
  <concepts>
    <r>
      <ord f=“Flowers to”>
        <how g=“Arrange for” p=“How would you like to order?” y=“pk1”>
          <occ i=“def2_bl” p=“Choose a Bouquet:” t=“By Bouquet Name” y=“pk1”>
            <flw data=“D11-3037” g=“ a <a>Stunning Beauty</a> bouquet” i=“def2_bl”
t=“Stunning Beauty Bouquet”/>
            <flw data=“A14-BPC” g=“ a <a>Birthday Party</a> bouquet” i=“def_2bl”
t=“Birthday Party Bouquet”/>
            <flw data=“A16-AB” g=“an <a>Anniversary</a> bouquet” i=“def2_bl”
t=“Anniversay Bouquet”/>
            <flw data=“D10-3047” g=“ a <a>Whirlwind Romance</a> bouquet” i=“def2_bl”
t=“Whirlwind Romance Bouquet”/>
            <flw data=“A18-TAB2” g=“ a <a>Thanks A Bunch</a> bouquet” i=“def2_bl”
t=“Thanks A Bunch Bouquet”/>
            <flw data=“A17-PMU” g=“ a <a>Pick Me Up</a> bouquet” i=“def2_bl” t=“Pick
Me Up Bouquet”/>
            <flw data=“D9-3072” g=“ a <a>Basket of Cheer</a> bouquet” i=“def2_bl”
t=“Basket of Cheer Bouquet”/>
            <flw data=“D8-3062” g=“ a <a>Beloved</a> bouquet” i=“def2_bl” t=“Beloved
Bouquet”/>
            <flw data=“C9-2985” g=“ a <a>Blooming Masterpiece</a> bouquet” i=“def2_bl”
t=“Blooming Masterpiece Bouquet”/>
          </occ>
          <get g=“ flowers” i=“def2_bl” t=“By Seeing Picture”/>
        </how>
          <who p=“Send flowers to whom?” y=“pk1”>
            <adr i=“def2_bl” t“Enter Name and Adress”>
              <nam g=“ for <a>%string% </a>” p=“Recipient's Name?” y=str” f=“<a>
%string% </a>”>
                <str mxc=“50”/>
              </nam>
              <loc p=“Delivery Address?” y=“pk1”>
                <adr fav=“loc” i=“ftr_addr” t=“Enter An Adress” y=df”>
                  <df id=“loc” t=“db”>
                    <select ID=“Select1” NAME=“Select1”>
                      <col exp=“U|?” id=“region”/>
                      <col exp=“*” id=“city”/>
                    </select>
                    <elements>
                      <street1 elm=“1” fav=“st1” lbl=“Street” mxc=“40”
                        req=“2” set=“1;2;3”/>
                      <city dbc=“city” dsp=“1” elm=“2” fav=“state”
                        mxc=“40” req=“2” set=“1;3”/>
                      <stateProv dbc=“state” dsp=“2” elm=“1” fav=“state”
                        mxc=“2” req=“2” set=“1;3”/>
                      <postalCode elm=“1” fav=“post” lbl=“Zip” mxc=“5”
                        req=“2” set=“1;2”/>
                      <region dbc=“region” def=“?” fav=“region”/>
                    </elements>
                    <echo>
                      <set g=“at <a>%street1%, %city%, %stateProv%</a>” id=“1;3”/>
                      <set g=“at <a>%street1% (%postalCode%)</a>” id=“2”/>
                    </echo>
                    <fav>
                      <set g=“%firstName%” id=“1;2;3”/>
                    </fav>
                  </df>
                </adr>
                <pim i=“ftr_cont” t=“Use Address from %pim% Contact” y=“df”>
                  <df id=“cdb” t=“ct”>
                    <select ID=“Select2” NAME=“Select2”>
                      <col exp=“*” id=“show”/>
                    </select>
                    <elements>
                      <disp1 dbc=“disp1” dsp=“1”/>
                      <disp2 dbc=“disp2” dsp=“2”/>
                      <street1 dbc=“st1” fav=“st1” req=“2” set=“1;2;3”/>
                      <city dbc=“city” fav=“city” req=“2” set=“1;2”/>
                      <stateProv dbc=“state” fav=“state” req=“2” set=“1;2”/>
                      <postalCode dbc=“post” fav=“post” req=“2” set=“1;3”/>
                    </elements>
                    <echo>
                      <set g=“ at <a>%street1%</a>” id=“1;2;3”/>
                    </echo>
                    <fav>
                      <set g=“%street1%” id=“1;2;3”/>
                    </fav>
                  </df>
                </pim>
                <fadr i=“usfav” t=“%_name%” y=“ldb”>
                  <ldb id=“fw_labels” t=“fav”>
                    <select ID=“Select3” NAME=“Select3”>
                      <col exp=“addr” id=“type”/>
                    </select>
                    <sort>
                      <col desc=“0” id=“_name”/>
                    </sort>
                    <elements>
                      <name dbc=“_name” req=“2” set=“1”/>
                      <guid dbc=“guid” req=“2” set=“2”/>
                    </elements>
                    <echo>
                      <set f=“ %name%” g=“ to <a>%name%</a>” id=“1”/>
                    </echo>
                  </ldb>
                </fadr>
                <fpl i=“usfav” t=“%_name%” y=“ldb”>
                  <ldb id=“loc” t=“fav”>
                    <select ID=“Select4” NAME=“Select4”>
                      <col exp=“*” id=“region”/>
                    </select>
                    <sort>
                      <col desc=“1” id=“_usedate”/>
                    </sort>
                    <elements>
                      <_name dbc=“_name” req“2” set=“1;2;3”/>
                      <street1 elm=“1” fav=“st1” lbl=“Street” mxc=“40” req=“2”
set=“1;2;3”/>
                      <city dbc=“city” dsp=“1” elm=“2” fav=“city” mxc=“40” req=“2”
set=“1;3”/>
                      <stateProv dbc=“state” dsp=“2” elm=“1” fav=“state” mxc=“2” req=“2”
set=“1;3”/>
                      <postalCode elm=“1” fav=“post” lbl=“Zip” mxc=“5” req=“2”
set=“1;2”/>
                    </elements>
                    <echo>
                      <set g=“ to <a>%_name%</a> address” id=“1;2;3”/>
                    </echo>
                  </ldb>
                </fpl>
              </loc>
            </adr>
            <cot i=“_contact_lst” t=“Choose Contact From %pim%”>
              <pim i=“ftr_cont” y=“df”>
                <df id=“cdb” t=“ct”>
                  <select ID=“Select5” NAME=“Select5”>
                    <col exp=“*” id=“show”/>
                  </select>
                  <elements>
                    <disp1 dbc=“disp1” dsp=“1”/>
                    <disp2 dbc=“disp2” dsp=“2”/>
                    <firstName dbc=“f_name” fav=“f_name” req=“2” set=“1;2;3”/>
                    <lastName dbc=“l_name” fav=“l_name” req=“2” set=“1;2;3”/>
                    <street1 dbc=“st1” fav=“st1” req=“2” set=“1;2;3”/>
                    <city dbc=“city” fav=“city” req=“2” set=“1;2”/>
                    <stateProv dbc=“state” fav=“state” req=“2” set=“1;2”/>
                    <postalCode dbc=“post” fav=“post” req=“2” set=“1;3”/>
                  </elements>
                  <echo>
                    <set f=“%firstName% %lastName%” g=“ <a>%firstName%
%lastName% <a> at <a>%street1%</a>“id=“1;2;3”/>
                  </echo>
                  <fav>
                    <set g=“%street1%” id=“1;2;3”/>
                  </fav>
                </df>
              </pim>
            </cot>
          </who>
          <dat g=“on <a>%date%</a>” p=“Delivery date?” r=“1” y=“d”>
            <d dd=“1” mnr=“1” mxr“120”/>
          </dat>
          <asm p=“Sign it with a message?” y=“pk1”>
          <nom g=“with <a>no message</a>” i=“gen_n” t=“No —Just My Name”/>
          <msg fav=“flower_note” g=“with a <a>message</a>” i=“gen_y” p=“Message:”
t=“Yes —Include a Message” y=“str”>
            <str fav=“string” mxc=“255”/>
          </msg>
        </asm>
        <asi p=“Any special instructions?” y=“pk1”>
          <noi g=“, and <a>no special instructions</a>.” i=“gen_n” t=“No”/>
          <ins fav=“flower_request” g=“, and <a>special instructions</a>.” i=“gen_y”
p=“Special instructions:” t=“Yes —Include Instructions” y=“str”>
            <str fav=“string” mxc=“255”/>
          </ins>
        </asi>
      </ord>
    </r>
  </concepts>
</resource>
```

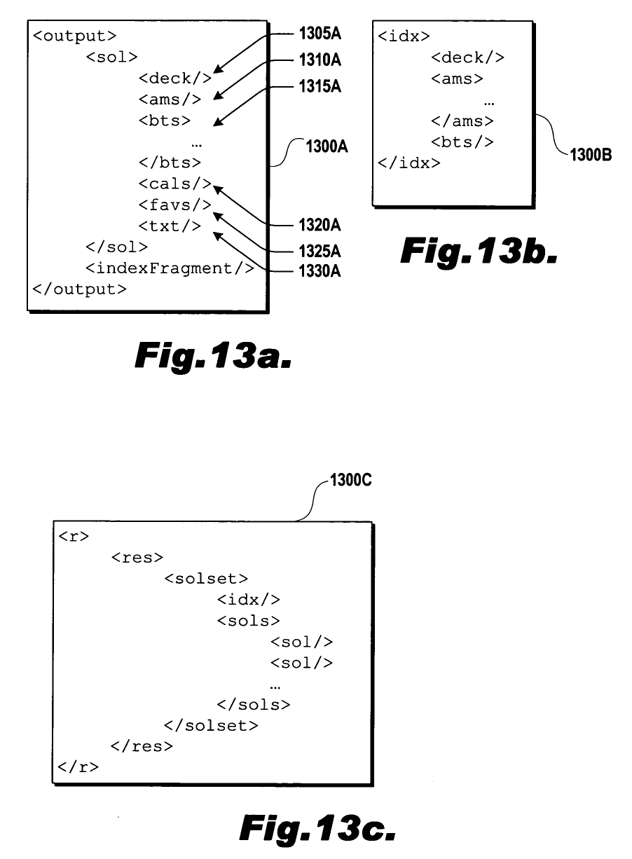

FIGS. 13a-c illustrate exemplary solution structures 1300A-C. FIG. 13a illustrates an XML embodiment of return results where a result from the service provider server 150 has been processed through a solution XSLT to form AEHTML output at the framework server 140. The various elements of the solution structure 1300A included a “deck” of html files 1305A, a custom menu 1310A, custom buttons 1315A, calendar information 1320A, favorites information 1325A and text information 1330A. These elements are then processed at the client device to automatically updating of various data structures and/or databases on the client device 200. The client device may contain various applications that support “open” update of their data structures and/or databases, such as favorites, calendars and so forth. The framework client 260 is operative to identify, and update with updated information, the various applications' data structures and/or databases on the client device 200.

FIG. 13b illustrates the resulting processing for an index fragment that has been processed through the index XSLT to form the formatted index fragment 1300B. FIG. 13c illustrates a combined XML document with one or more solutions and/or indices that are provided as a solution set back to the client device 200 from the framework server 140. Thus, as described earlier, the solution sets of embodiments of the present invention are particular scalable for a wide range of wireless mobile communication devices with a wide range of display capabilities. The exemplary API include various default classes and methods. Among them are the following classes, each having appropriate methods:

AnswersResponse—This class is a container for one or more results as well as auxiliary data.

BinaryResource—This class represents a binary resource.

BooleanResponse—This class represents a Boolean (true or false) response.

ClientInfo—This class represents information about the client making the request.

CodeResponse—This class represents a numeric code response.

Concepts—This class represents concepts.

ConceptsResponse—This class represents a concepts response.

ConceptValues—This class represents the values posted by the client as a result of submitting concepts to the server.

ConfigFile—This class represents an XML configuration file for a plugin.

DeckResponse—This class represents an HTML deck response, which is displayed as rich markup on the client.

Device—This class represents a client device.

Devices—This class represents a set of client devices.

Identity—This class represents a person's name broken out into first name, last name, etc.

ImageResource—This class represents an image (graphic) resource.

InfoRequest—This class represents the XML content returned by an IServiceInfo instance in response to GetInfoRequest.

InfoRequestResponse—This class represents an “info request” response, which is returned by GetInfoRequest.

InfoResponse—This class represents an info response (sometimes called an “action info” response).

Message—This class represents a message.

MessageResponse—This class represents a message response.

Resource—This is the base class for all types of resources.

ResourceReference—This class represents a resource reference, which is a description or “pointer” to an actual resource.

ResourcesResponse—This class represents a response of zero or more resources.

Response—This is the base class for various responses sent to the engine.

Result—This class represents a result for managing state in your plugin as well as providing input to various XSLT transformations.

User—This class represents an end user of the framework.

UserDataResponse—This class represents a user data response.

One embodiment of the present invention is directed to providing a programming interface for the service provider server (or a service provider service on another server) that will enable vendors to integrate their communications with the service provider server 150. The programming interface in one exemplary embodiment of the present invention is an API with specific data service functions for managing a multitude of data services provided within the framework system 100. One exemplary embodiment of such an API is described in the attached appendix. However, those of ordinary skill in the art and others will appreciate that the attached API description is merely one example of a programming interface suitable for servicing the data service provision in the framework system 100 and that, within the scope and spirit of the present invention, other APIs are possible.

Those of ordinary skill in the art and others will appreciate that there are many possible API function calls that may be made in a data service provisioning system such as the framework system 100. The appendix to this detailed description includes a number of exemplary API function calls. Those of ordinary skill in the art and others will appreciate that both more and fewer API function calls (and classes) may be employed in other embodiments of a framework system 100, without departing from the spirit and scope of the present invention.

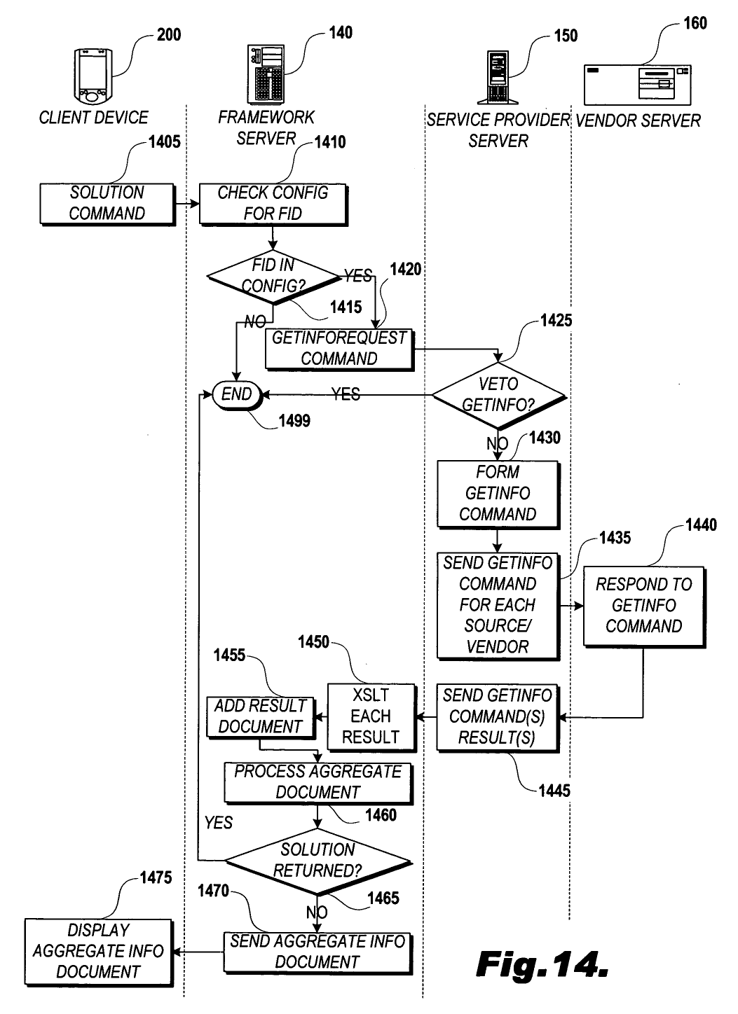

In various embodiments, the framework system 100 also allows the provision of supplementary information, e.g. by framework server 140, while the client device 200 is wait for answers to the service requests and/or solution commands. FIG. 14 illustrates the supplementary information provisioning services of the framework system 100 shown in FIG. 1. FIG. 14 includes one exemplary sequence of communication interactions between a client device 200, framework server 140, service provider server 150 and vendor server 160. It will be appreciated, by those of ordinary skill in the art, that the communications between these devices may comprise any form of suitable wireless and/or wired communications signals.

The exemplary communication interactions and processing shown in FIG. 14 begin with the client device 200 sending a solution command in block 1405 to the framework server 140. The framework server 140 then checks for the FID in a configuration file to identify the feature associated with the solution command in block 1410. Next, in decision block 1415, a determination is made whether the FID was found in the configuration file.

If, in decision block 1415, it was determined that the FID was in the configuration file and accordingly the appropriate feature has been identified then, in block 1420, a get information request command is sent to the service provider server 150. If, however, in decision block 1415, it was determined that the FID was not found in the configuration file 370, processing ends at block 1499 and no supplemental information is returned to the client device 200.

Once a service provider 150 receives a get info request command then in decision block 1425 a determination is made whether to veto the get info request. If the get info request is vetoed, processing also ends at block 1499 and no supplemental information is returned to the client device 200. If, however, in decision block 1425, it was determined not to veto the get info request, processing continues to block 1430 where the get info command is formed. Next, in block 1435, the get info command is sent for each source/vendor that will be used to get the supplemental information. The vendor server (or servers in the case of multiple get info commands) 160 responds to the get info command in block 1440. The response to the get info command is sent back to the service provider server 150. At the service provider server 150 the get info command result (or possibly multiple results if more than one result is returned from a command or more than one command was issued) is sent, in block 1445, to the framework server 140.

In block 1450, the framework server applies an XSL transformation to each result. These transformed results are then passed to block 1455, which adds the results to an aggregate document. In block 1460, the aggregate document is processed to form the supplemental information to be provided to a client device 200.

Next in decision block 1465, a determination is made whether a solution was already returned to the client device from their initial request for information (non-supplemental information). If so, processing ends at block 1499 and no supplemental information is returned to the client device 200. If, however, in decision block 1465 it was determined that no solution has yet been returned to the client device 200, processing proceeds to block 1470 where the aggregated supplemental information is sent to the client device 200. In block 1475 the client device displays the aggregated supplemental information document.

In addition to requesting and providing data services, embodiments of the present invention provide further customization and localization of both concept-gathering interfaces as well as solutions provided in response to data service requests. Accordingly, in some embodiments of the present invention, “packs” are provided to serve as containers for a collection of one or more applications. Packs are located on the highest level of the hierarchical tree and therefore require minimal immediate resources. Packs provide the ability for branding and generic control over the look and feel of the data services that are requested by and provided to the client device 200. In one exemplary embodiment, a pack directory contains XML files that describe an interface with particular branding, static documents, and resources (style sheets, applications, etc.) that will be used in a pack. By using XML and the hierarchical resource structures of the present invention it is possible to provide both data services and a user interface that conforms to the requirements of the service providers and/or local requirements of a client device (e.g., screen size, language, color depth, screen resolution, sound capabilities, network connection, user specified preferences, marketing initiatives, and the like).

For example, a pack branding a number of applications may be created as follows in Table 3.

```
TABLE 3
<resource t=“pack” id=“rumpus” ver=“0”>
    <ui>
        <packName>My ActionEngine</packName>
        <!-- desktop icon -->
        <label icon=“default_01” txt=“My ActionEngine” view=
        “icon”/>
        <!-- logo/branding -->
        <logo id=“br_ae_logo” pos=“b”/>
    </ui>
    <!--
        Documents.
    -->
    <docs>
        <doc id=“eula” val=“ae_eula”/>
        <doc id=“about” val=“ae_about”>
        <doc id=“send” val=“ae_send”/>;
        <doc id=“sending” val=“ae_sending”/>
        <doc id=“sign-up” val=“ae_sign-up”/>
    </docs>
    <tags>
        <tag id=“client” val=“My Action Engine”/>
        <tag id=“client_pos” val=“My Action Engine's”/>
        <tag id=“sup_phone” val=“1-866-SUPPORT”/>
        <tag id=“sup_mail” val=“support@actionengine.com”/>
        <tag id=“sup_url” val=
        “http://www.actionengine.com/support”/>
    </tags>
    <!--
        External resources.
    -->
    <resources>
        <rsc t=“catalog” id=“rumpus”/>
        <rsc t=“fav” id=“fw_labels”/>
        <rsc t=“css” id=“mycasio_css”/>
        <rsc t=“css” id=“actioninfo_css”/>
        <rsc t=“css” id=“signup_css”/>;
        <rsc t=“img” id=“actioninfo_hdr”/>
        <rsc t=“img” id=“ae_driven_tagline”/>
        <rsc t=“img” id=“ae_msg_send”/>
        <rsc t=“img” id=“ae_msg_sign-up”/>
        <rsc t=“img” id=“ae_msg_results”/>
        <rsc t=“img” id=“ae_send_hdr”/>
        <rsc t=“img” id=“ae_sending”/>
        <rsc t=“img” id=“ae_home_hdr”/>
        <rsc t=“img” id=“ae_about_hdr”/>
    ...
    </resources>
    ...
</resource>
```

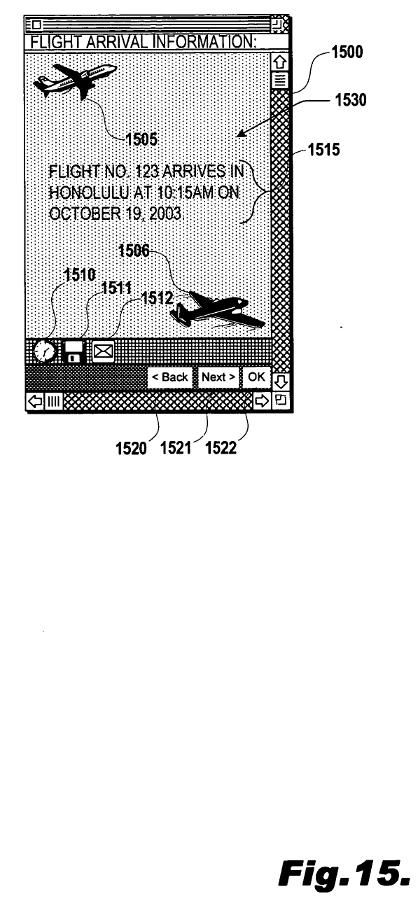

FIG. 15 illustrates an exemplary screen shot 1500 having branded elements that could be modified in accordance with embodiments of the present invention. The screen shot 1500 includes images 1505, 1506, customizable icons 1510-1512; custom text 1515; custom background 1530; and interface specified buttons 1520-1522. Image 1505 may e.g. be the image of an airline or an alliance of airlines providing the reservation services. Those of ordinary skill in the art and others will appreciate that the screen shot 1500 is merely one exemplary screen shot having features that may be customizable to present a consistent branding experience to a consumer of data services in accordance with embodiments of the present invention. Those of ordinary skill in the art and others will appreciate that other brand invoking information may be included, such as cascading style sheets, themes and the like.

Although various embodiments of the present invention have been illustrated and described, it will be appreciated that changes could be made without departing from the spirit and scope of the invention as defined by the appended claims. In particular, it will be appreciated that while the processes and communication interactions of the present invention have been described in a particular order, those of ordinary skill in the art and others will appreciate that other orders of processes and/or communication interactions will also fall within the spirit and scope of the present invention.

APPENDIX
API Class Library

ActionEngine.Api Namespace
Namespace hierarchy

Classes

| Class | Description |
|---|---|
| Address | This class represents a street address. |
| Addresses | This class represents a collection of Address |
| | objects. |
| AnswersResponse | This class is a container for one or more results as |
| | well as auxilary data. |
| BinaryResource | This class represents a binary resource. |
| BooleanResponse | This class represents a Boolean (true or false) |
| | response. |
| ClientInfo | This class represents information about the client |
| | making the request. |
| CodeResponse | This class represents a numeric code response. |
| Concepts | This class represents concepts. |
| ConceptsResponse | This class represents a concepts response. |
| ConceptValues | This class represents the values posted by the |
| | client as a result of submitting concepts to the |
| | server. |
| ConfigFile | This class represents an XML configuration file for a |
| | plugin. |
| CreditCard | This class represents a credit card. |
| CreditCards | This class represents a collection of CreditCard |
| | objects. |
| DeckResponse | This class represents an HTML deck response, |
| | which is displayed as rich markup on the client. |
| Device | This class represents a client device. |
| Devices | This class represents a set of client devices. |
| Email | This class represents an e-mail address. |
| Emails | This class represents a collection of Email objects. |
| FriendlyData | This is the base class for various user data classes |
| | that have friendly names. |
| FriendlyDataSet | This is the base class for various collections of user |
| | data that have friendly names. |
| FriendlyPair | This class represents a pairing of a friendly name |
| | with a FriendlyData object. |
| HealthResponse | This class represents a response to report on the |
| | health of a module. |
| Identity | This class represents a person's name broken out |
| | into first name, last name, etc. |
| ImageResource | This class represents an image (graphic) resource. |
| InfoRequest | This class represents the XML content returned by |
| | an IServiceInfo instance in response to |
| | GetInfoRequest. |
| InfoRequestResponse | This class represents an “info request” response, |
| | which is returned by GetInfoRequest. |
| InfoResponse | This class represents an info response (sometimes |
| | called an “action info” response). |
| Message | This class represents a message. |
| MessageResponse | This class represents a message response. |
| Phone | This class represents a phone number. |
| Phones | This class represents a collection of Phone objects. |
| PluginEnvironment | This class represents various aspects of a plugin's |
| | environment. |
| RequestProcessor | This class is for internal use only. |
| Resource | This is the base class for all types of resources. |
| ResourceReference | This class represents a resource reference, which |
| | is a description or “pointer” to an actual resource. |
| ResourcesResponse | This class represents a response of zero or more |
| | resources. |
| Response | This is the base class for various responses sent to |
| | the engine. |
| Result | This class represents a result for managing state in |
| | your plugin as well as providing input to various |
| | XSLT transformations. |
| SupportedAuthDataResponse | This class represents the categories of data |
| | supported by the authentication plugin. |
| ThreadStorage | This class manages framework-related storage for |
| | the current thread, and provides a way to spawn |
| | new threads while passing along the parent's thread |
| | storage. |
| Tracer | This class is used to add trace information to the |
| | response sent to the engine. |
| User | This class represents an end user of the framework. |
| UserDataResponse | This class represents a user data response. |
| UserDocument | This class provides functionality for processing user |
| | documents. |
| UserDocumentException | This exception class relates to the processing of |
| | user documents. |
| UserName | This class represents a user name. |

Interfaces

| Interface | Description |
|---|---|
| lAuthHandler | This interface represents a user authentication |
| | handler, which can do custom authorization |
| | handling as well as taking ownership of various |
| | categories of user data. |
| IHealth | !@# |
| IModule | This interface represents a module, which is the |
| | base interface for IAuthHandler and IService but |
| | can also represent a module on its own. |
| IService | This interface represents a service plugin, which |
| | processes requests and generally returns solutions |
| | to a client for viewing by the end user. |
| IServiceInfo | This interface represents “info” related functionality |
| | (sometimes called “action info”) for a service. |

Delegates

| Delegate | Description |
|---|---|
| DieHandler | This delegate is used for sending “die” events. |

Enumerations

| Enumeration | Description |
|---|---|
| CodeResponse.Code | The enumeration of valid codes. |
| CreditCard.Type | The enumeration of valid credit card types. |
| HealthResponse.Status | The enumeration of health statuses. |
| InfoRequest.Command | The enumeration of valid primary commands |
| | associated with GetInfoRequest. |
| Message.Severity | The enumeration of message severities. |
| Phone.Type | The enumeration of valid phone types. |
| Resource.Type | The enumeration of valid resource types. |
| ResourceReference.Priority | The enumeration of resource fetching priorities. |
| ResourceReference.Protocol | The enumeration of resource fetching protocols. |
| SupportedAuthDataResponse.Data | The enumeration of valid data categories. |
| Tracer.Level | The enumeration of valid trace levels. |
| UserDocumentException.Code | The enumeration of error codes related to this |
| | exception. |

API Class Library

Address Class

This class represents a street address.

For a list of all members of this type, see Address Members.

System.Object

FriendlyData

Address

public class Address: FriendlyData

Requirements

Namespace: ActionEngine.Api

Assembly: aefwapi (in aefwapi.dll)

See Also

Address Members|ActionEngine.Api Namespace|Addresses

API Class Library

Address Members

Address overview

| | |
|---|---|
| Public Instance Constructors | |
| Address Constructor | This constructs an empty Address. |
| Public Instance Properties | |
| City | The city. |
| Company | The company. |
| Country | The country. |
| CountyDistReg | The county, district, or region. |
| FriendlyName | The friendly name of the user data. |
| (inherited from FriendlyData) | |
| Lat | The latitude. |
| Lon | The longitude. |
| PoBox | The post office box. |
| PostalCode | The postal code (or “zip code” in the |
| | United States). |
| StateProv | The state or province. |
| Street1 | The first line of the street address. |
| Street2 | The second line of the street address. |
| Street3 | The third line of the street address. |
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use in |
| | hashing algorithms and data |
| | structures like a hash table. |
| GetType (inherited from Object) | Gets the Type of the current instance. |
| ToString | This returns an XML representation of |
| | the address. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

Address Class|ActionEngine.Api Namespace|Addresses

API Class Library

Address Constructor

This constructs an empty Address.

public Address(

string friendlyName

);

Parameters

friendlyName

The friendly name of the address.

Remarks

This constructs an empty address. All address members are initialized to the empty string, and the latitude and longitude are assigned the minimum float values.

See Also

Address Class|ActionEngine.Api Namespace

API Class Library

Address Properties

The properties of the Address class are listed below. For a complete list of Address class members, see the Address Members topic.

Public Instance Properties

| | |
|---|---|
| City | The city. |
| Company | The company. |
| Country | The country. |
| CountyDistReg | The county, district, or region. |
| FriendlyName | The friendly name of the user data. |
| (inherited from FriendlyData) | |
| Lat | The latitude. |
| Lon | The longitude. |
| PoBox | The post office box. |
| PostalCode | The postal code (or “zip code” in the |
| | United States). |
| StateProv | The state or province. |
| Street1 | The first line of the street address. |
| Street2 | The second line of the street address. |
| Street3 | The third line of the street address. |

See Also

Address Class|ActionEngine.Api Namespace|Addresses

API Class Library

Address.City Property

The city.

public string City {get; set;}

See Also

Address Class|ActionEngine.Api Namespace

API Class Library

Address.Company Property

The company.

public string Company {get; set;}

See Also

Address Class|ActionEngine.Api Namespace

API Class Library

Address.Country Property

The country.

public string Country {get; set;}

See Also

Address Class|ActionEngine.Api Namespace

API Class Library

Address.CountyDistReg Property

The county, district, or region.

public string CountyDistReg {get; set;}

See Also

Address Class|ActionEngine.Api Namespace

API Class Library

Address.Lat Property

The latitude.

public float Lat {get; set;}

Remarks

The latitude. Valid values are −90<=x<=90.

Exceptions

| Exception Type | Condition |
|---|---|
| ArgumentException | This is thrown when setting the latitude to an invalid |
| | value. |

See Also

Address Class|ActionEngine.Api Namespace

API Class Library

Address.Lon Property

The longitude.

public float Lon {get; set;}

Remarks

The longitude. Valid values are −180<=x<=180.

Exceptions

| Exception Type | Condition |
|---|---|
| ArgumentException | This is thrown when setting the longitude to an |
| | invalid value. |

See Also

Address Class|ActionEngine.Api Namespace

API Class Library

Address.PoBox Property

The post office box.

public string PoBox {get; set;}

See Also

Address Class|ActionEngine.Api Namespace

API Class Library

Address.PostalCode Property

The postal code (or “zip code” in the United States).

public string PostalCode {get; set;}

See Also

Address Class|ActionEngine.Api Namespace

API Class Library

Address.StateProv Property

The state or province.

public string StateProv {get; set;}

See Also

Address Class|ActionEngine.Api Namespace

API Class Library

Address.Street1 Property

The first line of the street address.

public string Street1 {get; set;}

See Also

Address Class|ActionEngine.Api Namespace

API Class Library

Address.Street2 Property

The second line of the street address.

public string Street2 {get; set;}

See Also

Address Class|ActionEngine.Api Namespace

API Class Library

Address.Street3 Property

The third line of the street address.

public string Street3 {get; set;}

See Also

Address Class|ActionEngine.Api Namespace

API Class Library

Address Methods

The methods of the Address class are listed below. For a complete list of Address class members, see the Address Members topic.

| | |
|---|---|
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use in |
| | hashing algorithms and data |
| | structures like a hash table. |
| GetType (inherited from Object) | Gets the Type of the current instance. |
| ToString | This returns an XML representation of |
| | the address. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

Address Class|ActionEngine.Api Namespace|Addresses

API Class Library

Address.ToString Method

This returns an XML representation of the address.

public override string ToString( );

Return Value

An XML representation of the address.

See Also

Address Class|ActionEngine.Api Namespace

API Class Library

Addresses Class

This class represents a collection of Address objects.

For a list of all members of this type, see Addresses Members.

System.Object

FriendlyDataSet

Addresses

public class Addresses: FriendlyDataSet

Requirements

Namespace: ActionEngine.Api

Assembly: aefwapi (in aefwapi.dll)

See Also

Addresses Members|ActionEngine.Api Namespace|Address

API Class Library

Addresses Members

Addresses overview

| | |
|---|---|
| Public Instance Constructors | |
| Addresses Constructor | This constructs an empty collection |
| | of addresses. |
| Public Instance Properties | |
| GetPrimary | This retrieves the primary address of |
| | the collection. |
| Item | This retrieves an address by the given |
| | friendly name. |
| Public Instance Methods | |
| Add | This adds an address to the collection. |
| Equals (inherited from Object) | Determines whether the specified |
| | Object is equal to the current Object. |
| GetEnumerator | This returns an IEnumerator for |
| (inherited from FriendlyDataSet) | enumerating the collection of |
| | friendly data. |
| GetHashCode | Serves as a hash function for a |
| (inherited from Object) | particular type, suitable for use |
| | in hashing algorithms and data |
| | structures like a hash table. |
| GetType (inherited from Object) | Gets the Type of the current instance. |
| Remove | This removes the address with the given |
| | friendly name. |
| SetPrimary | This sets the primary friendly data for |
| (inherited from FriendlyDataSet) | the collection. |
| ToString | This returns an XML representation of |
| (inherited from FriendlyDataSet) | the friendly data set. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

Addresses Class|ActionEngine.Api Namespace|Address

API Class Library

Addresses Constructor

This constructs an empty collection of addresses.

public Addresses( );

See Also

Addresses Class|ActionEngine.Api Namespace

API Class Library

Addresses Properties

The properties of the Addresses class are listed below. For a complete list of Addresses class members, see the Addresses Members topic.

Public Instance Properties

| | |
|---|---|
| GetPrimary | This retrieves the primary address of the |
| | collection. |
| Item | This retrieves an address by the given friendly |
| | name. |

See Also

Addresses Class|ActionEngine.Api Namespace|Address

API Class Library

Addresses.GetPrimary Property

This retrieves the primary address of the collection.

public Address GetPrimary {get;}

Remarks

This retrieves the primary address of the collection. If the collection is empty, null is returned.

See Also

Addresses Class|ActionEngine.Api Namespace

API Class Library

Addresses.Item Property

This retrieves an address by the given friendly name.

public Address this[

string friendlyName

] {get;}

Remarks

This retrieves an address by the given friendly name. If none is found, null is returned.

See Also

Addresses Class|ActionEngine.Api Namespace

API Class Library

Addresses Methods

The methods of the Addresses class are listed below. For a complete list of Addresses class members, see the Addresses Members topic.

| | |
|---|---|
| Public Instance Methods | |
| Add | This adds an address to the collection. |
| Equals (inherited from Object) | Determines whether the specified |
| | Object is equal to the current Object. |
| GetEnumerator | This returns an IEnumerator for |
| (inherited from FriendlyDataSet) | enumerating the collection of |
| | friendly data. |
| GetHashCode | Serves as a hash function for a |
| (inherited from Object) | particular type, suitable for use in |
| | hashing algorithms and data |
| | structures like a hash table. |
| GetType | Gets the Type of the current instance. |
| (inherited from Object) | |
| Remove | This removes the address with the |
| | given friendly name. |
| SetPrimary | This sets the primary friendly data for |
| (inherited from FriendlyDataSet) | the collection. |
| ToString | This returns an XML representation of |
| (inherited from FriendlyDataSet) | the friendly data set. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

Addresses Class|ActionEngine.Api Namespace|Address

API Class Library

Addresses.Add Method

This adds an address to the collection.

public void Add(

Address address

);

Parameters

address

The address to add to the collection.

See Also

Addresses Class|ActionEngine.Api Namespace

API Class Library

Addresses.Remove Method

This removes the address with the given friendly name.

public Address Remove(

string friendlyName

);

Parameters

friendlyName

The friendly name of the address to remove.

Return Value

The address removed is returned, or null if not found.

Remarks

This removes the address with the given friendly name. If the address is not found, no action is taken. If the address removed was primary, a new one is selected.

See Also

Addresses Class|ActionEngine.Api Namespace

API Class Library

AnswersResponse Class

This class is a container for one or more results as well as auxilary data.

For a list of all members of this type, see AnswersResponse Members.

System.Object

Response

Answers Response

public class AnswersResponse: Response

Remarks

This class is a container for one or more results as well as auxilary data. In the future, other items besides a result may be added to an “answer.”

Requirements

Namespace: ActionEngine.Api

Assembly: aefwapi (in aefwapi.dll)

See Also

AnswersResponse Members|ActionEngine.Api Namespace|Result

API Class Library

AnswersResponse Members

AnswersResponse overview

| | |
|---|---|
| Public Instance Constructors | |
| AnswersResponse | Overloaded. Initializes a new |
| | instance of the AnswersResponse class. |
| Public Instance Methods | |
| AddLogOnAs | This adds a user name and password |
| | to the response. When the client |
| | encounters this information, it will |
| | behave as if the user signed on |
| | himself. |
| AddMessage | This adds a message to the response. |
| | Messages are generally displayed on the |
| | client as a pop-up dialog. |
| AppendResult | This appends a result to the collection. |
| Equals (inherited from Object) | Determines whether the specified |
| | Object is equal to the current Object. |
| GetHashCode | Serves as a hash function for a |
| (inherited from Object) | particular type, suitable for use in |
| | hashing algorithms and data |
| | structures like a hash table. |
| GetType (inherited from Object) | Gets the Type of the current instance. |
| ToString | This returns an XML representation |
| (inherited from Response) | of the response. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

AnswersResponse Class|ActionEngine.Api Namespace|Result

API Class Library

AnswersResponse Constructor

This constructs a response with a single result.

Overload List

This constructs a response with a single result.

public AnswersResponse(Result);

This constructs a response with one or more results.

public AnswersResponse(Result [symbol] );

See Also

AnswersResponse Class|ActionEngine.Api Namespace

API Class Library

AnswersResponse Constructor (Result)

This constructs a response with a single result.

public AnswersResponse(

Result result

);

Parameters

result

The result, which cannot be null.

See Also

AnswersResponse Class|ActionEngine.Api Namespace|AnswersResponse Constructor

Overload List

API Class Library

AnswersResponse Constructor (Result [symbol] )

This constructs a response with one or more results.

public AnswersResponse(

Result [symbol] results

);

Parameters

results

The results, which cannot be null or zero in length.

See Also

AnswersResponse Class|ActionEngine.Api Namespace|AnswersResponse Constructor Overload List

API Class Library

AnswersResponse Methods

The methods of the AnswersResponse class are listed below. For a complete list of AnswersResponse class members, see the AnswersResponse Members topic.

| | |
|---|---|
| Public Instance | |
| Methods | |
| AddLogOnAs | This adds a user name and password to the |
| | response. When the client encounters this |
| | information, it will behave as if the user signed on |
| | himself. |
| AddMessage | This adds a message to the response. Messages |
| | are generally displayed on the client as a pop-up |
| | dialog. |
| AppendResult | This appends a result to the collection. |
| Equals (inherited from | Determines whether the specified Object is equal |
| Object) | to the current Object. |
| GetHashCode | Serves as a hash function for a particular type, |
| (inherited from Object) | suitable for use in hashing algorithms and data |
| | structures like a hash table. |
| GetType (inherited | Gets the Type of the current instance. |
| from Object) | |
| ToString (inherited | This returns an XML representation of the |
| from Response) | response. |
| Protected Instance | |
| Methods | |
| Finalize (inherited | Allows an Object to attempt to free resources and |
| from Object) | perform other cleanup operations before the |
| | Object is reclaimed by garbage collection. |
| MemberwiseClone | Creates a shallow copy of the current Object. |
| (inherited from Object) | |

See Also

AnswersResponse Class|ActionEngine.Api Namespace|Result

API Class Library

AnswersResponse.AddLogOnAs Method

This adds a user name and password to the response. When the client encounters this information, it will behave as if the user signed on himself.

public void AddLogOnAs(

UserName userName,

string password

);

Parameters

userName

The user name to log on as.

password

The user's password.

See Also

AnswersResponse Class|ActionEngine.Api Namespace

API Class Library

AnswersResponse.AddMessage Method

This adds a message to the response. Messages are generally displayed on the client as a pop-up dialog.

public void AddMessage(

Message message

);

Parameters

message

The message to add.

See Also

AnswersResponse Class|ActionEngine.Api Namespace

API Class Library

AnswersResponse.AppendResult Method

This appends a result to the collection.

public void AppendResult(

Result result

);

Parameters

result

The result to append.

See Also

AnswersResponse Class|ActionEngine.Api Namespace

API Class Library

BinaryResource Class

This class represents a binary resource.

For a list of all members of this type, see BinaryResource Members.

System.Object

Resource

BinaryResource

public class BinaryResource: Resource

Requirements

Namespace: ActionEngine.Api

Assembly: aefwapi (in aefwapi.dll)

See Also

BinaryResource Members|ActionEngine.Api Namespace

API Class Library

BinaryResource Members

BinaryResource overview

| | |
|---|---|
| Public Instance | |
| Constructors | |
| BinaryResource | This constructs a binary resource. |
| Constructor | |
| Public Instance | |
| Methods | |
| Equals (inherited | Determines whether the specified Object is equal to |
| from Object) | the current Object. |
| GetHashCode | Serves as a hash function for a particular type, |
| (inherited from | suitable for use in hashing algorithms and data |
| Object) | structures like a hash table. |
| GetType | Gets the Type of the current instance. |
| (inherited from | |
| Object) | |
| ToString | This returns an XML representation of the resource. |
| (inherited | |
| from Resource) | |
| Protected Instance | |
| Methods | |
| Finalize (inherited | Allows an Object to attempt to free resources and |
| from Object) | perform other cleanup operations before the Object |
| | is reclaimed by garbage collection. |
| MemberwiseClone | Creates a shallow copy of the current Object. |
| (inherited from | |
| Object) | |

See Also

BinaryResource Class|ActionEngine.Api Namespace

API Class Library

BinaryResource Constructor

This constructs a binary resource.

public BinaryResource(

ResourceReference resourceReference,

byte [symbol] bytes

);

Parameters

resourceReference

The original reference to the binary data.

bytes

The binary data.

See Also

BinaryResource Class|ActionEngine.Api Namespace

API Class Library

BooleanResponse Class

This class represents a Boolean (true or false) response.

For a list of all members of this type, see BooleanResponse Members.

System.Object

Response

Boolean Response

public class BooleanResponse: Response

Requirements

Namespace: ActionEngine.Api

Assembly: aefwapi (in aefwapi.dll)

See Also

BooleanResponse Members|ActionEngine.Api Namespace

API Class Library

BooleanResponse Members

BooleanResponse overview

| | |
|---|---|
| Public Instance | |
| Constructors | |
| BooleanResponse | This constructs a Boolean response. |
| Constructor | |
| Public Instance | |
| Methods | |
| Equals (inherited | Determines whether the specified Object is equal to |
| from Object) | the current Object. |
| GetHashCode | Serves as a hash function for a particular type, |
| (inherited from | suitable for use in hashing algorithms and data |
| Object) | structures like a hash table. |
| GetType (inherited | Gets the Type of the current instance. |
| from Object) | |
| ToString (inherited | This returns an XML representation of the |
| from Response) | response. |
| Protected Instance | |
| Methods | |
| Finalize (inherited | Allows an Object to attempt to free resources and |
| from Object) | perform other cleanup operations before the Object |
| | is reclaimed by garbage collection. |
| MemberwiseClone | Creates a shallow copy of the current Object. |
| (inherited from | |
| Object) | |

See Also

BooleanResponse Class|ActionEngine.Api Namespace

API Class Library

BooleanResponse Constructor

This constructs a Boolean response.

public BooleanResponse(

bool boolean

);

Parameters

boolean

The Boolean value.

See Also

BooleanResponse Class|ActionEngine.Api Namespace

API Class Library

ClientInfo Class

This class represents information about the client making the request.

For a list of all members of this type, see ClientInfo Members.

System.Object

ClientInfo

public class ClientInfo

Requirements

Namespace: ActionEngine.Api

Assembly: aefwapi (in aefwapi.dll)

See Also

ClientInfo Members|ActionEngine.Api Namespace

API Class Library

ClientInfo Members

ClientInfo overview

| | |
|---|---|
| Public Instance | |
| Properties | |
| CultureInfo | The culture info associated with the client request. |
| Pack | The pack ID associated with the client request. |
| Public Instance | |
| Methods | |
| Equals (inherited | Determines whether the specified Object is equal to |
| from Object) | the current Object. |
| GetHashCode | Serves as a hash function for a particular type, |
| (inherited from | suitable for use in hashing algorithms and data |
| Object) | structures like a hash table. |
| GetType (inherited | Gets the Type of the current instance. |
| from Object) | |
| ToString (inherited | Returns a String that represents the current Object. |
| from Object) | |
| Protected Instance | |
| Methods | |
| Finalize (inherited | Allows an Object to attempt to free resources and |
| from Object) | perform other cleanup operations before the Object |
| | is reclaimed by garbage collection. |
| MemberwiseClone | Creates a shallow copy of the current Object. |
| (inherited from | |
| Object) | |

See Also

ClientInfo Class|ActionEngine.Api Namespace

API Class Library

ClientInfo Properties

The properties of the ClientInfo class are listed below. For a complete list of ClientInfo class members, see the ClientInfo Members topic.

Public Instance Properties

| | |
|---|---|
| CultureInfo | The culture info associated with the client request. |
| Pack | The pack ID associated with the client request. |

See Also

ClientInfo Class|ActionEngine.Api Namespace

API Class Library

ClientInfo.CultureInfo Property

The culture info associated with the client request.

public System.Globalization.CultureInfo CultureInfo {get;}

See Also

ClientInfo Class|ActionEngine.Api Namespace

API Class Library

ClientInfo.Pack Property

The pack ID associated with the client request.

public string Pack {get;}

Remarks

A pack is a group of related applications and primarily serves as a way to visually organize the client's user interface.

See Also

ClientInfo Class|ActionEngine.Api Namespace

API Class Library

CodeResponse Class

This class represents a numeric code response.

For a list of all members of this type, see CodeResponse Members.

System.Object

Response

CodeResponse

public class CodeResponse: Response

Requirements

Namespace: ActionEngine.Api

Assembly: aefwapi (in aefwapi.dll)

See Also

CodeResponse Members|ActionEngine.Api Namespace

API Class Library

CodeResponse Members

CodeResponse overview

| | |
|---|---|
| Public Instance | |
| Constructors | |
| CodeResponse | Overloaded. Initializes a new instance of the |
| | CodeResponse class. |
| Public Instance | |
| Methods | |
| AddData | This adds data, such as a message argument, to |
| | the response. |
| Equals (inherited | Determines whether the specified Object is equal to |
| from Object) | the current Object. |
| GetHashCode | Serves as a hash function for a particular type, |
| (inherited from | suitable for use in hashing algorithms and data |
| Object) | structures like a hash table. |
| GetType | Gets the Type of the current instance. |
| (inherited from | |
| Object) | |
| ToString (inherited | This returns an XML representation of the |
| from Response) | response. |
| Protected Instance | |
| Methods | |
| Finalize (inherited | Allows an Object to attempt to free resources and |
| from Object) | perform other cleanup operations before the Object |
| | is reclaimed by garbage collection. |
| MemberwiseClone | Creates a shallow copy of the current Object. |
| (inherited | |
| from Object) | |

See Also

CodeResponse Class|ActionEngine.Api Namespace

API Class Library

CodeResponse Constructor

This constructs a new code response.

Overload List

This constructs a new code response.

public CodeResponse(Code);

This constructs a new code response and allows the default message text associated with the code to be overridden.

public CodeResponse(Code,string);

See Also

CodeResponse Class|ActionEngine.Api Namespace

API Class Library

CodeResponse Constructor (Code)

This constructs a new code response.

public CodeResponse(

Code code

);

Parameters

code

The code.

See Also

CodeResponse Class|ActionEngine.Api Namespace|CodeResponse Constructor

Overload List

API Class Library

CodeResponse Constructor (Code, String)

This constructs a new code response and allows the default message text associated with the code to be overridden.

public CodeResponse(

Code code,

string text

);

Parameters

code

The code.

text

The overridden message text. If no override is desired, pass null.

See Also

CodeResponse Class|ActionEngine.Api Namespace|CodeResponse Constructor

Overload List

API Class Library

CodeResponse Methods

The methods of the CodeResponse class are listed below. For a complete list of CodeResponse class members, see the CodeResponse Members topic.

| | |
|---|---|
| Public Instance | |
| Methods | |
| AddData | This adds data, such as a message argument, to |
| | the response. |
| Equals (inherited | Determines whether the specified Object is equal to |
| from Object) | the current Object. |
| GetHashCode | Serves as a hash function for a particular type, |
| (inherited from | suitable for use in hashing algorithms and data |
| Object) | structures like a hash table. |
| GetType (inherited | Gets the Type of the current instance. |
| from Object) | |
| ToString (inherited | This returns an XML representation of the |
| from Response) | response. |
| Protected Instance | |
| Methods | |
| Finalize (inherited | Allows an Object to attempt to free resources and |
| from Object) | perform other cleanup operations before the Object |
| | is reclaimed by garbage collection. |
| MemberwiseClone | Creates a shallow copy of the current Object. |
| (inherited from | |
| Object) | |

See Also

CodeResponse Class|ActionEngine.Api Namespace

API Class Library

CodeResponse.AddData Method

This adds data, such as a message argument, to the response.

public void AddData(

string data

);

Parameters

data

The data to add, which cannot be null.

Remarks

This adds data, such as a message argument, to the response. Some codes require one or more arguments to be provided. For example, if the message text associated with a code is “My name is {0} {1}”, calling AddData(“Joe”) followed by AddData(“Blo”) will cause the message to appear as “My name is Joe Blo” when expanded by the framework.

See Also

CodeResponse Class|ActionEngine.Api Namespace

API Class Library

CodeResponse.Code Enumeration

The enumeration of valid codes.

public enum CodeResponse.Code

Remarks

The enumeration of valid codes.

Most address-related values have “1” and “2” varieties. These are broken down so that, during sign-up validation, if the user enters two addresses, the plugin can indicate to the engine in the reply which of the two addresses had the problem. The engine then directs the user to the right address to correct.

Members

| Member Name | Description |
|---|---|
| S_OK | The action taken was successful. |
| E_FAIL | An error occurred. |
| E_LOGON_FAILED | The user name or password is incorrect. |
| E_NOT_IMPL | The functionality is not implemented. |
| E_USER_DOESNT_EXIST | The user does not exist. |
| E_ADDR1_CITY_MISSING | In address 1 the city is missing. |
| E_ADDR2_CITY_MISSING | In address 2 the city is missing. |
| E_ADDR1_CITY_TOO_LONG | In address 1 the city is too long. |
| E_ADDR2_CITY_TOO_LONG | In address 2 the city is too long. |
| E_ADDR1_COUNTRY_BAD | In address 1 the country is invalid. |
| E_ADDR2_COUNTRY_BAD | In address 2 the country is invalid. |
| E_ADDR1_COUNTRY_MISSING | In address 1 the country is missing. |
| E_ADDR2_COUNTRY_MISSING | In address 2 the country is missing. |
| E_ADDR1_COUNTRY_TOO_LONG | In address 1 the country is too long. |
| E_ADDR2_COUNTRY_TOO_LONG | In address 2 the country is too long. |
| E_ADDR1_FRIENDLY_MISSING | In address 1 the friendly name is missing. |
| E_ADDR2_FRIENDLY_MISSING | In address 2 the friendly name is missing. |
| E_ADDR1_FRIENDLY_TOO_LONG | In address 1 the friendly name is too long. |
| E_ADDR2_FRIENDLY_TOO_LONG | In address 2 the friendly name is too long. |
| E_ADDR1_PO_BOX_TOO_LONG | In address 1 the post office box is too long. |
| E_ADDR2_PO_BOX_TOO_LONG | In address 2 the post office box is too long. |
| E_ADDR1_POSTAL_BAD_LEN_USA | In address 1 the postal code has an invalid length |
| | for a United States address. |
| E_ADDR2_POSTAL_BAD_LEN_USA | In address 2 the postal code has an invalid length |
| | for a United States address. |
| E_ADDR1_POSTAL_MISSING | In address 1 the postal code is missing. |
| E_ADDR2_POSTAL_MISSING | In address 2 the postal code is missing. |
| E_ADDR1_POSTAL_TOO_LONG | In address 1 the postal code is too long. |
| E_ADDR2_POSTAL_TOO_LONG | In address 2 the postal code is too long. |
| E_ADDR1_REGION_TOO_LONG | In address 1 the county/district/region is too long. |
| E_ADDR2_REGION_TOO_LONG | In address 2 the county/district/region is too long. |
| E_ADDR1_STATE_PROV_BAD | In address 1 the state/province is invalid. |
| E_ADDR2_STATE_PROV_BAD | In address 2 the state/province is invalid. |
| E_ADDR1_STATE_PROV_MISSING | In address 1 the state/province is missing. |
| E_ADDR2_STATE_PROV_MISSING | In address 2 the state/province is missing. |
| E_ADDR1_STATE_PROV_TOO_LONG | In address 1 the state/province is too long. |
| E_ADDR2_STATE_PROV_TOO_LONG | In address 2 the state/province is too long. |
| E_ADDR1_STREET_MISSING | In address 1 the street is missing. |
| E_ADDR2_STREET_MISSING | In address 2 the street is missing. |
| E_ADDR1_STREET_TOO_LONG | In address 1 the street is too long. |
| E_ADDR2_STREET_TOO_LONG | In address 2 the street is too long. |
| E_ADDR_DOESNT_EXIST | The address does not exist. |
| E_ADDR_TAKEN | The address already exists. |
| E_ADDR_USED_BY_CARD | The address is referenced by a credit card and, |
| | therefore, cannot be deleted. |
| E_CARD_ADDRESS_MISSING | The credit card's address is missing. |
| E_CARD_DOESNT_EXIST | The credit card does not exist. |
| E_CARD_EXPIRED | The credit card's expiration date has passed. |
| E_CARD_FRIENDLY_MISSING | The credit card's friendly name is missing. |
| E_CARD_FRIENDLY_TOO_LONG | The credit card's friendly name is too long. |
| E_CARD_MONTH_BAD | The credit card's expiration month is invalid. |
| E_CARD_MONTH_MISSING | The credit card's expiration month is missing. |
| E_CARD_NUMBER_BAD | The credit card number is invalid. |
| E_CARD_NUMBER_MISSING | The credit card number is missing. |
| E_CARD_PERSONS_NAME_MISSING | The person's name on the credit card is missing. |
| E_CARD_PERSONS_NAME_TOO_LONG | The person's name on the credit card is too long. |
| E_CARD_TAKEN | The credit card already exists. |
| E_CARD_TYPE_UNKNOWN | The credit card type is not recognized. |
| E_CARD_YEAR_BAD | The credit card's expiration year is invalid. |
| E_CARD_YEAR_MISSING | The credit card's expiration year is missing. |
| E_EMAIL_ADDR_BAD | The e-mail address is invalid. |
| E_EMAIL_ADDR_MISSING | The e-mail address is missing. |
| E_EMAIL_ADDR_TOO_LONG | The e-mail address is too long. |
| E_EMAIL_DOESNT_EXIST | The e-mail address by the given friendly name does |
| | not exist. |
| E_EMAIL_FRIENDLY_MISSING | The e-mail address's friendly name is missing. |
| E_EMAIL_FRIENDLY_TOO_LONG | The e-mail address's friendly name is too long. |
| E_EMAIL_TAKEN | The e-mail address by the given friendly name |
| | already exists. |
| E_IDENTITY_FIRST_MISSING | The first name is missing. |
| E_IDENTITY_FIRST_TOO_LONG | The first name is too long. |
| E_IDENTITY_LAST_MISSING | The last name is missing. |
| E_IDENTITY_LAST_TOO_LONG | The last name is too long. |
| E_IDENTITY_MIDDLE_MISSING | The middle name is missing. |
| E_IDENTITY_MIDDLE_TOO_LONG | The middle name is too long. |
| E_IDENTITY_SUFFIX_TOO_LONG | The person's suffix is too long. |
| E_IDENTITY_TITLE_TOO_LONG | The person's title is too long. |
| E_PASSWORD_BAD_CHARS | The password contains one or more invalid |
| | characters. |
| E_PASSWORD_CANT_CHANGE | The password cannot be changed. |
| E_PASSWORD_MISSING | The password is missing. |
| E_PASSWORD_TOO_LONG | The password is too long. |
| E_PASSWORD_TOO_SHORT | The password is too short. |
| E_PASSWORD_WRONG | The password is incorrect. |
| E_PHONE_DOESNT_EXIST | The phone entry does not exist. |
| E_PHONE_FRIENDLY_MISSING | The phone number's friendly name is missing. |
| E_PHONE_FRIENDLY_TOO_LONG | The phone number's friendly name is too long. |
| E_PHONE_NUMBER_MISSING | The phone entry's number is missing. |
| E_PHONE_NUMBER_TOO_LONG | The phone number is too long. |
| E_PHONE_TAKEN | The phone number by the given friendly name |
| | already exists. |
| E_USER_NAME_BAD_CHARS | The user name contains one or more invalid |
| | characters. |
| E_USER_NAME_DOESNT_EXIST | The user name doesn't exist. |
| E_USER_NAME_FORBIDDEN | The user name is forbidden. |
| E_USER_NAME_MISSING | The user name is missing. |
| E_USER_NAME_TAKEN | The user name already exists. |
| E_USER_NAME_TOO_LONG | The user name is too long. |
| E_USER_NAME_TOO_SHORT | The user name is too short. |

Requirements

Namespace: ActionEngine.Api

Assembly: aefwapi (in aefwapi.dll)

See Also

ActionEngine.Api Namespace

API Class Library

Concepts Class

This class represents concepts.

For a list of all members of this type, see Concepts Members.

System.Object

Concepts

public class Concepts

Remarks

This class represents concepts. Concepts are processed by the client to collect data from the user and to post back to the server.

Requirements

Namespace: ActionEngine.Api

Assembly: aefwapi (in aefwapi.dll)

See Also

Concepts Members|ActionEngine.Api Namespace

API Class Library

Concepts Members

Concepts overview

| | |
|---|---|
| Public Static | |
| Fields | |
| ROOT_NAME | The name of the root element for any concepts |
| | XML. |
| Public Instance | |
| Constructors | |
| Concepts | Overloaded. Initializes a new instance of the |
| | Concepts class. |
| Public Instance | |
| Methods | |
| Equals (inherited | Determines whether the specified Object is equal to |
| from Object) | the current Object. |
| GetHashCode | Serves as a hash function for a particular type, |
| (inherited from | suitable for use in hashing algorithms and data |
| Object) | structures like a hash table. |
| GetType | Gets the Type of the current instance. |
| (inherited from | |
| Object) | |
| ToString | This returns a string representation of the concepts |
| | XML. |
| Protected Instance | |
| Methods | |
| Finalize (inherited | Allows an Object to attempt to free resources and |
| from Object) | perform other cleanup operations before the Object |
| | is reclaimed by garbage collection. |
| MemberwiseClone | Creates a shallow copy of the current Object. |
| (inherited from | |
| Object) | |

See Also

Concepts Class|ActionEngine.Api Namespace

API Class Library

Concepts Constructor

This constructs concepts from the given XML.

Overload List

This constructs concepts from the given XML.

public Concepts(string);

This constructs concepts from the given XML element.

public Concepts(XmlElement);

See Also

Concepts Class|ActionEngine.Api Namespace

API Class Library

Concepts Constructor (String)

This constructs concepts from the given XML.

public Concepts(

string conceptsXml

);

Parameters

conceptsXml

The concepts XML.

Exceptions

| Exception Type | Condition |
|---|---|
| ApplicationException | This is thrown when the root element name |
| | doesn't match ROOT_NAME. |

See Also

Concepts Class|ActionEngine.Api Namespace|Concepts Constructor Overload List

API Class Library

Concepts Constructor (XmlElement)

This constructs concepts from the given XML element.

public Concepts(

XmlElement conceptsRoot

);

Parameters

conceptsRoot

The root concepts element.

Remarks

This constructs concepts from the given XML element. The element must be named ROOT_NAME.

Exceptions

| Exception Type | Condition |
|---|---|
| ApplicationException | This is thrown when the root element name |
| | doesn't match ROOT_NAME. |

See Also

Concepts Class|ActionEngine.Api Namespace|Concepts Constructor Overload List

API Class Library

Concepts Fields

The fields of the Concepts class are listed below. For a complete list of Concepts class members, see the Concepts Members topic.

Public Static Fields

| | |
|---|---|
| ROOT_NAME | The name of the root element for any concepts |
| | XML. |

See Also

Concepts Class|ActionEngine.Api Namespace

API Class Library

Concepts.ROOT_NAME Field

The name of the root element for any concepts XML.

public const string ROOT_NAME;

See Also

Concepts Class|ActionEngine.Api Namespace

API Class Library

Concepts Methods

The methods of the Concepts class are listed below. For a complete list of Concepts class members, see the Concepts Members topic.

| | |
|---|---|
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString | This returns a string representation of the concepts |
| | XML. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Concepts Class|ActionEngine.Api Namespace

API Class Library

Concepts.ToString Method

This returns a string representation of the concepts XML.

public override string ToString( );

Return Value

A string representation of the concepts XML.

See Also

Concepts Class|ActionEngine.Api Namespace

API Class Library

ConceptsResponse Class

This class represents a concepts response.

For a list of all members of this type, see ConceptsResponse Members.

System.Object

Response

ConceptsResponse

public class ConceptsResponse: Response

Remarks

This class represents a concepts response. Concepts are processed by the client to collect data from the user and to post back to the server.

Requirements

Namespace: ActionEngine.Api

Assembly: aefwapi (in aefwapi.dll)

See Also

ConceptsResponse Members|ActionEngine.Api Namespace|Concepts

API Class Library

ConceptsResponse Members

ConceptsResponse overview

| | |
|---|---|
| Public Instance Constructors | |
| ConceptsResponse | Overloaded. Initializes a new instance of the |
| | ConceptsResponse class. |
| Public Instance Methods | |
| AddMessage | This adds a message to the response. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Response) | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ConceptsResponse Class|ActionEngine.Api Namespace|Concepts

API Class Library

ConceptsResponse Constructor

This constructs a concepts reseponse using the given concepts.

Overload List

This constructs a concepts reseponse using the given concepts.

public ConceptsResponse(Concepts);

This constructs a concepts reseponse using the given concepts and result.

public ConceptsResponse(Concepts,Result);

See Also

ConceptsResponse Class|ActionEngine.Api Namespace

API Class Library

ConceptsResponse Constructor (Concepts)

This constructs a concepts reseponse using the given concepts.

public ConceptsResponse(

Concepts concepts

);

Parameters

concepts

The concepts, which cannot be null.

See Also

ConceptsResponse Class|ActionEngine.Api Namespace|ConceptsResponse Constructor

Overload List

API Class Library

ConceptsResponse Constructor (Concepts, Result)

This constructs a concepts reseponse using the given concepts and result.

public ConceptsResponse(

Concepts concepts,

Result result

);

Parameters

concepts

The concepts, which cannot be null.

result

The result to associated with the response. If null, an empty result is created.

Remarks

This constructs a concepts reseponse using the given concepts and result. The result is passed back to the plugin when the client posts the concepts. It can be used to manage state.

See Also

ConceptsResponse Class|ActionEngine.Api Namespace|ConceptsResponse Constructor

Overload List

API Class Library

ConceptsResponse Methods

The methods of the ConceptsResponse class are listed below. For a complete list of ConceptsResponse class members, see the ConceptsResponse Members topic.

| | |
|---|---|
| Public Instance Methods | |
| AddMessage | This adds a message to the response. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Response) | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ConceptsResponse Class|ActionEngine.Api Namespace|Concepts

API Class Library

ConceptsResponse.AddMessage Method

This adds a message to the response.

public void AddMessage(

Message message

);

Parameters

message

The message to add.

Remarks

This adds a message to the response. Messages are generally displayed on the client as a pop-up dialog.

See Also

ConceptsResponse Class|ActionEngine.Api Namespace

API Class Library

ConceptValues Class

This class represents the values posted by the client as a result of submitting concepts to the server.

For a list of all members of this type, see ConceptValues Members.

System.Object

ConceptValues

public class ConceptValues

Requirements

Namespace: ActionEngine.Api

Assembly: aefwapi (in aefwapi.dll)

See Also

ConceptValues Members|ActionEngine.Api Namespace

API Class Library

ConceptValues Members

ConceptValues overview

| | |
|---|---|
| Public Instance Properties | |
| RootElement | The root element of the concept values. |
| Version | The version of the concepts. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ConceptValues Class|ActionEngine.Api Namespace

API Class Library

ConceptValues Properties

The properties of the ConceptValues class are listed below. For a complete list of ConceptValues class members, see the ConceptValues Members topic.

Public Instance Properties

| | |
|---|---|
| RootElement | The root element of the concept values. |
| Version | The version of the concepts. |

See Also

ConceptValues Class|ActionEngine.Api Namespace

API Class Library

ConceptValues.RootElement Property

The root element of the concept values.

public System.Xml.XmlElement RootElement {get;}

See Also

ConceptValues Class|ActionEngine.Api Namespace

API Class Library

ConceptValues.Version Property

The version of the concepts.

public string Version {get;}

See Also

ConceptValues Class|ActionEngine.Api Namespace

API Class Library

ConfigFile Class

This class represents an XML configuration file for a plugin.

For a list of all members of this type, see ConfigFile Members.

System.Object

ConfigFile

public class ConfigFile

Remarks

This class represents an XML configuration file for a plugin. It offers a convenient way of storing plugin-specific configuration values, provides a mechanism for managing machine-specific values, and ties into the framework's cache flushing system.

The name of the configuration file is config.xml and is stored in a plugin's cfg directory.

There are no restrictions on the contents of the file, other than it be well-formed XML, and one small exception regarding the m attribute (see below).

The framework caches configuration files in memory until a flush command is issued. This is to optimize runtime performance.

Often when developing a plugin it is convenient to provide different configuration values depending on the machine (host) where the plugin is hosted. You can do this by attaching an m=“ . . . some machine . . . ” attribute to any element. The machine name must be typed in lower-case. For example, a config.xml file may look like this:

<stuff> <url>http://stuff/</url> <url m=“server2”>http://stuff/svr2/</url> <url m=“server5”>http://stuff/svr5/</url></stuff>

In this example, if your plugin called GetString(“url”) while running on server2, the value returned would be http://stuff/svr2/. If running on server99, the value returned would be http://stuff/ because no machine-specific override of the default is present.

Requirements

Namespace: ActionEngine.Api

Assembly: aefwapi (in aefwapi.dll)

See Also

ConfigFile Members|ActionEngine.Api Namespace|PluginEnvironment

API Class Library

ConfigFile Members

ConfigFile overview

| | |
|---|---|
| Public Instance Properties | |
| Exists | This returns whether or not a config.xml file exists |
| | for this plugin. |
| RootElement | This returns the root element of the configuration |
| | file. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetString | Overloaded. This returns a string from the |
| | configuration file. |
| GetType (inherited from Object) | Gets the Type of the current instance. |
| SelectSingleNode | This returns an XmlNode from the configuration file. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ConfigFile Class|ActionEngine.Api Namespace|PluginEnvironment

API Class Library

ConfigFile Properties

The properties of the ConfigFile class are listed below. For a complete list of ConfigFile class members, see the ConfigFile Members topic. +

Public Instance Properties

| | |
|---|---|
| Exists | This returns whether or not a config.xml file exists |
| | for this plugin. |
| RootElement | This returns the root element of the configuration |
| | file. |

See Also

ConfigFile Class|ActionEngine.Api Namespace|PluginEnvironment

API Class Library

ConfigFile.Exists Property

This returns whether or not a config.xml file exists for this plugin.

public bool Exists {get;}

See Also

ConfigFile Class|ActionEngine.Api Namespace

API Class Library

ConfigFile.RootElement Property

This returns the root element of the configuration file.

public System.Xml.XmlElement RootElement {get;}

Remarks

This returns the root element of the configuration file. Generally direct access to this element is not needed since GetString is more useful in that it takes into account machine-specific logic.

See Also

ConfigFile Class|ActionEngine.Api Namespace

API Class Library

ConfigFile Methods

The methods of the ConfigFile class are listed below. For a complete list of ConfigFile class members, see the ConfigFile Members topic.

| | |
|---|---|
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetString | Overloaded. This returns a string from the |
| | configuration file. |
| GetType (inherited from Object) | Gets the Type of the current instance. |
| SelectSingleNode | This returns an XmlNode from the configuration file. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ConfigFile Class|ActionEngine.Api Namespace|PluginEnvironment

API Class Library

ConfigFile.GetString Method

This returns a string from the configuration file.

Overload List

This returns a string from the configuration file.

public string GetString(string);

This returns a string from the configuration file.

public string GetString(string,string);

See Also

ConfigFile Class|ActionEngine.Api Namespace

API Class Library

ConfigFile.GetString Method (String)

This returns a string from the configuration file.

public string GetString(

string xpath

);

Parameters

xpath

The XPath relative to the root element.

Return Value

The string value, or null if not found, or null if the configuration file does not exist.

Remarks

This returns a string from the configuration file. This is equivalent to calling GetString(xpath, null).

Machine-specific logic is taken into account when evaluating the XPath. See the class overview for more information.

Exceptions

| Exception Type | Condition |
|---|---|
| XmlException | This is thrown when a load or parse error occurs. |
| XPathException | This is thrown when an error occurs processing the |
| | XPath. |

See Also

ConfigFile Class|ActionEngine.Api Namespace|ConfigFile.GetString Overload List

API Class Library

ConfigFile.GetString Method (String, String)

This returns a string from the configuration file.

public string GetString(

string xpath,

string defaultValue

);

Parameters

xpath

The XPath relative to the root element.

defaultValue

The default value to return if the XPath is not found or if the configuration file does not exist.

Can be null.

Return Value

The string vaule, or defaultValue if not found, or defaultValue if the configuration file does not exist.

Remarks

This returns a string from the configuration file.

Machine-specific logic is taken into account when evaluating the XPath. See the class overview for more information.

Exceptions

| Exception Type | Condition |
|---|---|
| XmlException | This is thrown when a load or parse error occurs. |
| XPathException | This is thrown when an error occurs processing the |
| | XPath. |

See Also

ConfigFile Class|ActionEngine.Api Namespace|ConfigFile.GetString Overload List

API Class Library

ConfigFile.SelectSingleNode Method

This returns an XmlNode from the configuration file.

public XmlNode SelectSingleNode(

string xpath

);

Parameters

xpath

The XPath relative to the root element.

Return Value

The XmlNode, or null if the file does not exist or the XPath does not exist.

Remarks

This returns an XmlNode from the configuration file. If the file does not exist, or if the XPath does not exist, null is returned.

Machine-specific logic is taken into account when evaluating the XPath. See the class overview for more information.

Exceptions

| Exception Type | Condition |
|---|---|
| XmlException | This is thrown when a load or parse error occurs. |
| XPathException | This is thrown when an error occurs processing the |
| | XPath. |

See Also

ConfigFile Class|ActionEngine.Api Namespace

API Class Library

CreditCard Class

This class represents a credit card.

For a list of all members of this type, see CreditCard Members.

System.Object

FriendlyData

CreditCard

public class CreditCard: FriendlyData

Requirements

Namespace: ActionEngine.Api

Assembly: aefwapi (in aefwapi.dll)

See Also

CreditCard Members|ActionEngine.Api Namespace|CreditCards

API Class Library

CreditCard Members

CreditCard overview

| | |
|---|---|
| Public Instance Constructors | |
| CreditCard Constructor | This constructs a credit card. |
| Public Instance Properties | |
| Address | The billing address. |
| CardType | The credit card's type, which is derived from the |
| | number. |
| ExpMonth | The expiration month (1-12). |
| ExpYear | The four-digit expiration year. |
| FriendlyName (inherited from FriendlyData) | The friendly name of the user data. |
| Number | The credit card number. |
| PersonsName | The name of the card holder. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString | This returns an XML representation of the credit |
| | card. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

CreditCard Class|ActionEngine.Api Namespace|CreditCards

API Class Library

CreditCard Constructor

This constructs a credit card.

public CreditCard(

string friendlyName,

string number,

string personsName,

Address address,

int expMonth,

int expYear

);

Parameters

friendlyName

The friendly name of the credit card.

number

The credit card number. The credit card's type is derived automatically from the number.

personsName

The name of the card holder.

address

The billing address.

expMonth

The expiration month.

expYear

The four-digit expiration year.

See Also

CreditCard Class|ActionEngine.Api Namespace

API Class Library

CreditCard Properties

The properties of the CreditCard class are listed below. For a complete list of CreditCard class members, see the CreditCard Members topic.

Public Instance Properties

| | |
|---|---|
| Address | The billing address. |
| CardType | The credit card's type, which is |
| | derived from the number. |
| ExpMonth | The expiration month (1-12). |
| ExpYear | The four-digit expiration year. |
| FriendlyName (inherited from | The friendly name of the user data. |
| FriendlyData) | |
| Number | The credit card number. |
| PersonsName | The name of the card holder. |

See Also

CreditCard Class|ActionEngine.Api Namespace|CreditCards

API Class Library

CreditCard.Address Property

The billing address.

public Address Address {get; set;}

Remarks

The billing address. This cannot be set to null.

See Also

CreditCard Class|ActionEngine.Api Namespace

API Class Library

CreditCard.CardType Property

The credit card's type, which is derived from the number.

public CreditCard.Type CardType {get;}

Remarks

The credit card's type, which is derived from the number. If the type is unknown, Unknown is returned.

See Also

CreditCard Class|ActionEngine.Api Namespace

API Class Library

CreditCard.ExpMonth Property

The expiration month (1-12).

public int ExpMonth {get; set;}

Exceptions

| Exception Type | Condition |
|---|---|
| ArgumentOutOfRangeException | This is thrown when setting |
| | the month to an invalid value. |

See Also

CreditCard Class|ActionEngine.Api Namespace

API Class Library

CreditCard.ExpYear Property

The four-digit expiration year.

public int ExpYear {get; set;}

Exceptions

| Exception Type | Condition |
|---|---|
| ArgumentOutOfRangeException | This is thrown when setting |
| | the year to an invalid value. |

See Also

CreditCard Class|ActionEngine.Api Namespace

API Class Library

CreditCard.Number Property

The credit card number.

public string Number {get; set;}

Remarks

The credit card number. This cannot be set to null.

See Also

CreditCard Class|ActionEngine.Api Namespace

API Class Library

CreditCard.PersonsName Property

The name of the card holder.

public string PersonsName {get; set;}

Remarks

The name of the card holder. This cannot be set to null.

See Also

CreditCard Class|ActionEngine.Api Namespace

API Class Library

CreditCard Methods

The methods of the CreditCard class are listed below. For a complete list of CreditCard class members, see the CreditCard Members topic.

| | |
|---|---|
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString | This returns an XML representation of the credit |
| | card. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

CreditCard Class|ActionEngine.Api Namespace|CreditCards

API Class Library

CreditCard.ToString Method

This returns an XML representation of the credit card.

public override string ToString( );

Return Value

An XML representation of the credit card.

See Also

CreditCard Class|ActionEngine.Api Namespace

API Class Library

CreditCard.Type Enumeration

The enumeration of valid credit card types.

public enum CreditCard.Type

Members

| Member Name | Description |
|---|---|
| AmericanExpress | American Express |
| DinersClub | Diner's Club |
| Discover | Discover |
| Jcb | JCB |
| MasterCard | MasterCard |
| Unknown | Unknown |
| Visa | Visa |

Requirements

Namespace: ActionEngine.Api

Assembly: aefwapi (in aefwapi.dll)

See Also

ActionEngine.Api Namespace

API Class Library

CreditCards Class

This class represents a collection of CreditCard objects.

For a list of all members of this type, see CreditCards Members.

System.Object

FriendlyDataSet

CreditCards

public class CreditCards: FriendlyDataSet

Requirements

Namespace: ActionEngine.Api

Assembly: aefwapi (in aefwapi.dll)

See Also

CreditCards Members|ActionEngine.Api Namespace|CreditCard

API Class Library

CreditCards Members

CreditCards overview

| | |
|---|---|
| Public Instance Constructors | |
| CreditCards Constructor | This constructs an empty collection of credit cards. |
| Public Instance Properties | |
| GetPrimary | This retrieves the primary credit card of the |
| | collection. |
| Item | This retrieves a credit card by the given friendly |
| | name. |
| Public Instance Methods | |
| Add | This adds a credit card to the collection. |
| Equals (inherited from Object) | Determines whether the specified Object is equal to |
| | the current Object. |
| GetEnumerator (inherited from FriendlyDataSet) | This returns an IEnumerator for enumerating the |
| | collection of friendly data. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| Remove | This removes the credit card with the given friendly |
| | name. |
| SetPrimary (inherited from FriendlyDataSet) | This sets the primary friendly data for the collection. |
| ToString (inherited from FriendlyDataSet) | This returns an XML representation of the friendly |
| | data set. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

CreditCards Class|ActionEngine.Api Namespace|CreditCard

API Class Library

CreditCards Constructor

This constructs an empty collection of credit cards.

public CreditCards( );

See Also

CreditCards Class|ActionEngine.Api Namespace

API Class Library

CreditCards Properties

The properties of the CreditCards class are listed below. For a complete list of CreditCards class members, see the CreditCards Members topic.

Public Instance Properties

| | |
|---|---|
| GetPrimary | This retrieves the primary credit card of the |
| | collection. |
| Item | This retrieves a credit card by the given friendly |
| | name. |

See Also

CreditCards Class|ActionEngine.Api Namespace|CreditCard

API Class Library

CreditCards.GetPrimary Property

This retrieves the primary credit card of the collection.

public CreditCard GetPrimary {get;}

Remarks

This retrieves the primary credit card of the collection. If the collection is empty, null is returned.

See Also

CreditCards Class|ActionEngine.Api Namespace

API Class Library

CreditCards.Item Property

This retrieves a credit card by the given friendly name.

public CreditCard this[

string friendlyName

] {get;}

Remarks

This retrieves a credit card by the given friendly name. If none is found, null is returned.

See Also

CreditCards Class|ActionEngine.Api Namespace

API Class Library

CreditCards Methods

The methods of the CreditCards class are listed below. For a complete list of CreditCards class members, see the CreditCards Members topic.

| | |
|---|---|
| Public Instance Methods | |
| Add | This adds a credit card to the collection. |
| Equals (inherited from Object) | Determines whether the specified Object is equal to |
| | the current Object. |
| GetEnumerator (inherited from FriendlyDataSet) | This returns an IEnumerator for enumerating the |
| | collection of friendly data. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| Remove | This removes the credit card with the given friendly |
| | name. |
| SetPrimary (inherited from FriendlyDataSet) | This sets the primary friendly data for the collection. |
| ToString (inherited from FriendlyDataSet) | This returns an XML representation of the friendly |
| | data set. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

CreditCards Class|ActionEngine.Api Namespace|CreditCard

API Class Library

CreditCards.Add Method

This adds a credit card to the collection.

public void Add(

CreditCard creditCard

);

Parameters

creditCard

The credit card to add to the collection.

See Also

CreditCards Class|ActionEngine.Api Namespace

API Class Library

CreditCards.Remove Method

This removes the credit card with the given friendly name.

public CreditCard Remove(

string friendlyName

);

Parameters

friendlyName

The friendly name of the credit card to remove.

Return Value

The credit card removed is returned, or null if not found.

Remarks

This removes the credit card with the given friendly name. If the credit card is not found, no action is taken. If the credit card removed was primary, a new one is selected.

See Also

CreditCards Class|ActionEngine.Api Namespace

API Class Library

DeckResponse Class

This class represents an HTML deck response, which is displayed as rich markup on the client.

For a list of all members of this type, see DeckResponse Members.

System.Object

Response

DeckResponse

public class DeckResponse: Response

Remarks

This class represents an HTML deck response, which is displayed as rich markup on the client. It is simply a container for a result and some auxilary data. The result is input to an XSLT transformation on the engine that produces the rich markup. The name of the XSLT file is the feature ID plus .info.xsl For example, if the feature ID is myfeature, the name of the XSLT file needs to be myfeature.info.xsl.

Requirements

Namespace: ActionEngine.Api

Assembly: aefwapi (in aefwapi.dll)

See Also

DeckResponse Members|ActionEngine.Api Namespace|Result

API Class Library

DeckResponse Members

DeckResponse overview

| | |
|---|---|
| Public Instance Constructors | |
| DeckResponse Constructor | This constructs an HTML deck response. |
| Public Instance Methods | |
| AddMessage | This adds a message to the response. Messages |
| | are generally displayed on the client as a pop-up |
| | dialog. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Response) | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

DeckResponse Class|ActionEngine.Api Namespace|Result

API Class Library

DeckResponse Constructor

This constructs an HTML deck response.

public DeckResponse(

Result result

);

Parameters

result

The result, which cannot be null.

See Also

DeckResponse Class|ActionEngine.Api Namespace

API Class Library

DeckResponse Methods

The methods of the DeckResponse class are listed below. For a complete list of DeckResponse class members, see the DeckResponse Members topic.

| | |
|---|---|
| Public Instance Methods | |
| AddMessage | This adds a message to the response. Messages |
| | are generally displayed on the client as a pop-up |
| | dialog. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Response) | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

DeckResponse Class|ActionEngine.Api Namespace|Result

API Class Library

DeckResponse.AddMessage Method

This adds a message to the response. Messages are generally displayed on the client as a pop-up dialog.

public void AddMessage(

Message message

);

Parameters

message

The message to add.

See Also

DeckResponse Class|ActionEngine.Api Namespace

API Class Library

Device Class

This class represents a client device.

For a list of all members of this type, see Device Members.

System.Object

Device

public class Device

Requirements

Namespace: ActionEngine.Api

Assembly: aefwapi (in aefwapi.dll)

See Also

Device Members|ActionEngine.Api Namespace|Devices

API Class Library

Device Members

Device overview

| | |
|---|---|
| Public Instance Properties | |
| IsPushable | This returns whether or not the device can accept |
| | “pushed” content from the server. |
| PhoneNumber | This returns the phone number associated with the |
| | device, if one exists. |
| UtcOffset | This returns the difference between Coordinated |
| | Universal Time (UTC) and the device's local |
| | date/time. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Device Class|ActionEngine.Api Namespace|Devices

API Class Library

Device Properties

The properties of the Device class are listed below. For a complete list of Device class members, see the Device Members topic.

Public Instance Properties

| | |
|---|---|
| IsPushable | This returns whether or not the device can accept |
| | “pushed” content from the server. |
| PhoneNumber | This returns the phone number associated with the |
| | device, if one exists. |
| UtcOffset | This returns the difference between Coordinated |
| | Universal Time (UTC) and the device's local |
| | date/time. |

See Also

Device Class|ActionEngine.Api Namespace|Devices

API Class Library

Device.IsPushable Property

This returns whether or not the device can accept “pushed” content from the server.

public boot IsPushable {get;}

Remarks

Before calling AddFeatureSchedule, check this value.

See Also

Device Class|ActionEngine.Api Namespace

API Class Library

Device.PhoneNumber Property

This returns the phone number associated with the device, if one exists.

public string PhoneNumber {get;}

Remarks

This returns the phone number associated with the device, if one exists. Not all devices have phone numbers, and those that do may not be registered with the framework, in which case null is returned.

See Also

Device Class|ActionEngine.Api Namespace

API Class Library

Device.UtcOffset Property

This returns the difference between Coordinated Universal Time (UTC) and the device's local date/time.

public System.TimeSpan UtcOffset {get;}

Remarks

This returns the difference between Coordinated Universal Time (UTC) and the device's local date/time. For devices in North America, this is a negative value.

See Also

Device Class|ActionEngine.Api Namespace

API Class Library

Devices Class

This class represents a set of client devices.

For a list of all members of this type, see Devices Members.

System.Object

Devices

public class Devices

Requirements

Namespace: ActionEngine.Api

Assembly: aefwapi (in aefwapi.dll)

See Also

Devices Members|ActionEngine.Api Namespace Device

API Class Library

Devices Members

Devices overview

| | |
|---|---|
| Public Instance Properties | |
| Current | This returns the device involved in the current |
| | request. |
| Public Instance Methods | |
| Equals (inherited from Object) | Determines whether the specified Object is equal to |
| | the current Object. |
| GetEnumerator | This returns an IEnumerator for enumerating the |
| | collection of devices, where each item is a Device |
| | object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Devices Class|ActionEngine.Api Namespace|Device

API Class Library

Devices Properties

The properties of the Devices class are listed below. For a complete list of Devices class members, see the Devices Members topic.

Public Instance Properties

| | |
|---|---|
| Current | This returns the device involved in the current |
| | request. |

See Also

Devices Class|ActionEngine.Api Namespace|Device

API Class Library

Devices.Current Property

This returns the device involved in the current request.

public Device Current {get;}

See Also

Devices Class|ActionEngine.Api Namespace

API Class Library

Devices Methods

The methods of the Devices class are listed below. For a complete list of Devices class members, see the Devices Members topic.

| | |
|---|---|
| Public Instance Methods | |
| Equals (inherited from Object) | Determines whether the specified Object is equal to |
| | the current Object. |
| GetEnumerator | This returns an IEnumerator for enumerating the |
| | collection of devices, where each item is a Device |
| | object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Devices Class|ActionEngine.Api Namespace|Device

API Class Library

Devices.GetEnumerator Method

This returns an IEnumerator for enumerating the collection of devices, where each item is a Device object.

public IEnumerator GetEnumerator( );

Return Value

The IEnumerator.

See Also

Devices Class|ActionEngine.Api Namespace

API Class Library

DieHandler Delegate

This delegate is used for sending “die” events.

public delegate void DieHandler( );

Requirements

Namespace: ActionEngine.Api

Assembly: aefwapi (in aefwapi.dll)

See Also

ActionEngine.Api Namespace|DieEvents

API Class Library

Email Class

This class represents an e-mail address.

For a list of all members of this type, see Email Members.

System.Object

FriendlyData

Email

public class Email: FriendlyData

Requirements

Namespace: ActionEngine.Api

Assembly: aefwapi (in aefwapi.dll)

See Also

Email Members|ActionEngine.Api Namespace Emails

API Class Library

Email Members

Email overview

| | |
|---|---|
| Public Instance Constructors | |
| Email Constructor | This constructs an e-mail address. |
| Public Instance Properties | |
| Address | The e-mail address itself, which cannot be null. |
| FriendlyName (inherited from FriendlyData) | The friendly name of the user data. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString | This returns an XML representation of the e-mail |
| | address. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Email Class|ActionEngine.Api Namespace|Emails

API Class Library

Email Constructor

This constructs an e-mail address.

public Email(

string friendlyName,

string address

);

Parameters

friendlyName

The friendly name of the e-mail address.

address

The e-mail address.

See Also

Email Class|ActionEngine.Api Namespace

API Class Library

Email Properties

The properties of the Email class are listed below. For a complete list of Email class members, see the Email Members topic.

Public Instance Properties

| | |
|---|---|
| Address | The e-mail address itself, which |
| | cannot be null. |
| FriendlyName | The friendly name of the user data. |
| (inherited from FriendlyData) | |

See Also

Email Class|ActionEngine.Api Namespace|Emails

API Class Library

Email.Address Property

The e-mail address itself, which cannot be null.

public string Address {get; set;}

See Also

Email Class|ActionEngine.Api Namespace

API Class Library

Email Methods

The methods of the Email class are listed below. For a complete list of Email class members, see the Email Members topic.

| | |
|---|---|
| Public Instance Methods | |
| Equals (inherited from Object) | Determines whether the specified |
| | Object is equal to |
| | the current Object. |
| GetHashCode | Serves as a hash function for a |
| (inherited from Object) | particular type, suitable for use |
| | in hashing algorithms and data |
| | structures like a hash table. |
| GetType (inherited from Object) | Gets the Type of the current |
| | instance. |
| ToString | This returns an XML representation |
| | of the e-mail address. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the |
| (inherited from Object) | current Object. |

See Also

Email Class|ActionEngine.Api Namespace|Emails

API Class Library

Email.ToString Method

This returns an XML representation of the e-mail address.

public override string ToString( );

Return Value

An XML representation of the e-mail address.

See Also

Email Class|ActionEngine.Api Namespace

API Class Library

Emails Class

This class represents a collection of Email objects.

For a list of all members of this type, see Emails Members.

System.Object

FriendlyDataSet

Emails

public class Emails: FriendlyDataSet

Requirements

Namespace: ActionEngine.Api

Assembly: aefwapi (in aefwapi.dll)

See Also

Emails Members|ActionEngine.Api Namespace Email

API Class Library

Emails Members

Emails overview

| | |
|---|---|
| Public Instance Constructors | |
| Emails Constructor | This constructs an empty collection of e-mail |
| | addresses. |
| Public Instance Properties | |
| GetPrimary | This retrieves the primary e-mail address of the |
| | collection. |
| Item | This retrieves an e-mail address by the given |
| | friendly name. |
| Public Instance Methods | |
| Add | This adds an e-mail address to the collection. |
| Equals (inherited from Object) | Determines whether the specified Object is equal to |
| | the current Object. |
| GetEnumerator (inherited from FriendlyDataSet) | This returns an IEnumerator for enumerating the |
| | collection of friendly data. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| Remove | This removes the e-mail address with the given |
| | friendly name. |
| SetPrimary (inherited from FriendlyDataSet) | This sets the primary friendly data for the collection. |
| ToString (inherited from FriendlyDataSet) | This returns an XML representation of the friendly |
| | data set. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Emails Class|ActionEngine.Api Namespace|Email

API Class Library

Emails Constructor

This constructs an empty collection of e-mail addresses.

public Emails( );

See Also

Emails Class|ActionEngine.Api Namespace

API Class Library

Emails Properties

The properties of the Emails class are listed below. For a complete list of Emails class members, see the Emails Members topic.

Public Instance Properties

| | |
|---|---|
| GetPrimary | This retrieves the primary e-mail address of the |
| | collection. |
| Item | This retrieves an e-mail address by the given |
| | friendly name. |

See Also

Emails Class|ActionEngine.Api Namespace|Email

API Class Library

Emails.GetPrimary Property

This retrieves the primary e-mail address of the collection.

public Email GetPrimary {get;}

Remarks

This retrieves the primary e-mail address of the collection. If the collection is empty, null is returned.

See Also

Emails Class|ActionEngine.Api Namespace

API Class Library

Emails.Item Property

This retrieves an e-mail address by the given friendly name.

public Email this[

string friendlyName

] {get;}

Remarks

This retrieves an e-mail address by the given friendly name. If none is found, null is returned.

See Also

Emails Class|ActionEngine.Api Namespace

API Class Library

Emails Methods

The methods of the Emails class are listed below. For a complete list of Emails class members, see the Emails Members topic.

| | |
|---|---|
| Public Instance Methods | |
| Add | This adds an e-mail address to the collection. |
| Equals (inherited from Object) | Determines whether the specified Object is equal to |
| | the current Object. |
| GetEnumerator (inherited from FriendlyDataSet) | This returns an IEnumerator for enumerating the |
| | collection of friendly data. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| Remove | This removes the e-mail address with the given |
| | friendly name. |
| SetPrimary (inherited from FriendlyDataSet) | This sets the primary friendly data for the collection. |
| ToString (inherited from FriendlyDataSet) | This returns an XML representation of the friendly |
| | data set. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Emails Class|ActionEngine.Api Namespace|Email

API Class Library

Emails.Add Method

This adds an e-mail address to the collection.

public void Add(

Email email

);

Parameters

email

The e-mail address to add to the collection.

See Also

Emails Class|ActionEngine.Api Namespace

API Class Library

Emails.Remove Method

This removes the e-mail address with the given friendly name.

public Email Remove(

string friendlyName

);

Parameters

friendlyName

The friendly name of the e-mail address to remove.

Return Value

The e-mail address removed is returned, or null if not found.

Remarks

This removes the e-mail address with the given friendly name. If the e-mail address is not found, no action is taken. If the e-mail address removed was primary, a new one is selected.

See Also

Emails Class|ActionEngine.Api Namespace

API Class Library

FriendlyData Class

This is the base class for various user data classes that have friendly names.

For a list of all members of this type, see FriendlyData Members.

System.Object

FriendlyData

public abstract class FriendlyData

Requirements

Namespace: ActionEngine.Api

Assembly: aefwapi (in aefwapi.dll)

See Also

FriendlyData Members|ActionEngine.Api Namespace

API Class Library

FriendlyData Members

FriendlyData overview

| | |
|---|---|
| Public Instance Properties | |
| FriendlyName | The friendly name of the user data. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Constructors | |
| FriendlyData Constructor | |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

FriendlyData Class|ActionEngine.Api Namespace

API Class Library

FriendlyData Constructor

protected FriendlyData( );

See Also

FriendlyData Class|ActionEngine.Api Namespace

API Class Library

FriendlyData Properties

The properties of the FriendlyData class are listed below. For a complete list of FriendlyData class members, see the FriendlyData Members topic.

Public Instance Properties

| | |
|---|---|
| FriendlyName | The friendly name of the user data. |

See Also

FriendlyData Class|ActionEngine.Api Namespace

API Class Library

FriendlyData.FriendlyName Property

The friendly name of the user data.

public string FriendlyName {get; set;}

Remarks

The friendly name of the user data. This cannot be set to null.

See Also

FriendlyData Class|ActionEngine.Api Namespace

API Class Library

FriendlyDataSet Class

This is the base class for various collections of user data that have friendly names.

For a list of all members of this type, see FriendlyDataSet Members.

System.Object

FriendlyDataSet

public abstract class FriendlyDataSet: IEnumerable

Requirements

Namespace: ActionEngine.Api

Assembly: aefwapi (in aefwapi.dll)

See Also

FriendlyDataSet Members|ActionEngine.Api Namespace

API Class Library

FriendlyDataSet Members

FriendlyDataSet overview

| | |
|---|---|
| Public Instance Methods | |
| Equals (inherited from Object) | Determines whether the specified Object is equal to |
| | the current Object. |
| GetEnumerator | This returns an IEnumerator for enumerating the |
| | collection of friendly data. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| SetPrimary | This sets the primary friendly data for the collection. |
| ToString | This returns an XML representation of the friendly |
| | data set. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

FriendlyDataSet Class|ActionEngine.Api Namespace

API Class Library

FriendlyDataSet Methods

The methods of the FriendlyDataSet class are listed below. For a complete list of FriendlyDataSet class members, see the FriendlyDataSet Members topic.

| | |
|---|---|
| Public Instance Methods | |
| Equals (inherited from Object) | Determines whether the specified Object is equal to |
| | the current Object. |
| GetEnumerator | This returns an IEnumerator for enumerating the |
| | collection of friendly data. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| SetPrimary | This sets the primary friendly data for the collection. |
| ToString | This returns an XML representation of the friendly |
| | data set. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

FriendlyDataSet Class|ActionEngine.Api Namespace

API Class Library

FriendlyDataSet.GetEnumerator Method

This returns an IEnumerator for enumerating the collection of friendly data.

public IEnumerator GetEnumerator( );

Return Value

The IEnumerator.

Implements

IEnumerable.GetEnumerator

See Also

FriendlyDataSet Class|ActionEngine.Api Namespace

API Class Library

FriendlyDataSet.SetPrimary Method

This sets the primary friendly data for the collection.

public void SetPrimary(

string friendlyName

);

Parameters

friendlyName

The friendly name of the friendly data to make primary.

Exceptions

| Exception Type | Condition |
|---|---|
| ApplicationException | This is thrown when the collection is empty or the |
| | given friendly name is not found. |

See Also

FriendlyDataSet Class|ActionEngine.Api Namespace

API Class Library

FriendlyDataSet.ToString Method

This returns an XML representation of the friendly data set.

public override string ToString( );

Return Value

An XML representation of the friendly data set.

See Also

FriendlyDataSet Class|ActionEngine.Api Namespace

API Class Library

FriendlyPair Class

This class represents a pairing of a friendly name with a FriendlyData object.

For a list of all members of this type, see FriendlyPair Members.

System.Object

FriendlyPair

public class FriendlyPair

Requirements

Namespace: ActionEngine.Api

Assembly: aefwapi (in aefwapi.dll)

See Also

FriendlyPair Members|ActionEngine.Api Namespace|FriendlyData

API Class Library

FriendlyPair Members

FriendlyPair overview

| | |
|---|---|
| Public Instance Constructors | |
| FriendlyPair Constructor | This constructs a friendly pair. |
| Public Instance Properties | |
| FriendlyData | The friendly data. |
| FriendlyName | The friendly name. |
| Public Instance Methods | |
| Equals (inherited from Object) | Determines whether the specified |
| | Object is equal to the current Object. |
| GetHashCode (inherited | Serves as a hash function for a |
| from Object) | particular type, suitable for use in |
| | hashing algorithms and data |
| | structures like a hash table. |
| GetType (inherited from Object) | Gets the Type of the current instance. |
| ToString (inherited from Object) | Returns a String that represents the |
| | current Object. |
| Protected Instance Methods | |
| Finalize (inherited from Object) | Allows an Object to attempt to free |
| | resources and perform other cleanup |
| | operations before the Object is |
| | reclaimed by garbage collection. |
| MemberwiseClone | Creates a shallow copy of the |
| (inherited from Object) | current Object. |

See Also

FriendlyPair Class|ActionEngine.Api Namespace|FriendlyData

API Class Library

FriendlyPair Constructor

This constructs a friendly pair.

public FriendlyPair(

string friendlyName,

FriendlyData friendlyData

);

Parameters

friendlyName

The friendly name.

friendlyData

The friendly data.

See Also

FriendlyPair Class|ActionEngine.Api Namespace

API Class Library

FriendlyPair Properties

The properties of the FriendlyPair class are listed below. For a complete list of FriendlyPair class members, see the FriendlyPair Members topic.

Public Instance Properties

| | |
|---|---|
| FriendlyData | The friendly data. |
| FriendlyName | The friendly name. |

See Also

FriendlyPair Class|ActionEngine.Api Namespace|FriendlyData

API Class Library

FriendlyPair.FriendlyData Property

The friendly data.

public FriendlyData FriendlyData {get; set;}

See Also

FriendlyPair Class|ActionEngine.Api Namespace

API Class Library

FriendlyPair.FriendlyName Property

The friendly name.

public string FriendlyName {get; set;}

See Also

FriendlyPair Class|ActionEngine.Api Namespace

API Class Library

HealthResponse Class

This class represents a response to report on the health of a module.

For a list of all members of this type, see HealthResponse Members.

System.Object

Response

Health Response

public class HealthResponse: Response

Remarks

This class represents a response to report on the health of a module. !@# MORE . . . EXPLAIN HOW TO SET UP INTERVALS, HOW HEALTH RESPONSES CAN BE RETURNED AT ANY TIME IN ANY API, ETC.

Requirements

Namespace: ActionEngine.Api

Assembly: aefwapi (in aefwapi.dll)

See Also

HealthResponse Members|ActionEngine.Api Namespace

API Class Library

HealthResponse Members

HealthResponse overview

| | |
|---|---|
| Public Instance | |
| Constructors | |
| HealthResponse | Overloaded. Initializes a new instance of the |
| | HealthResponse class. |
| Public Instance Methods | |
| Equals (inherited from | Determines whether the specified Object is |
| Object) | equal to the current Object. |
| GetHashCode | Serves as a hash function for a particular |
| (inherited from Object) | type, suitable for use in hashing |
| | algorithms and data structures |
| | like a hash table. |
| GetType (inherited | Gets the Type of the current instance. |
| from Object) | |
| ToString | This returns an XML representation of the |
| (inherited from Response) | response. |
| Protected Instance Methods | |
| Finalize (inherited | Allows an Object to attempt to free resources |
| from Object) | and perform other cleanup operations |
| | before the Object is reclaimed by |
| | garbage collection. |
| MemberwiseClone | Creates a shallow copy of the current Object. |
| (inherited from Object) | |

See Also

HealthResponse Class|ActionEngine.Api Namespace

API Class Library

HealthResponse Constructor

This constructs a health response.

Overload List

This constructs a health response.

public HealthResponse(IModule,Status);

This constructs a health response.

public HealthResponse(IModule,Status,string);

See Also

HealthResponse Class|ActionEngine.Api Namespace

API Class Library

HealthResponse Constructor (IModule, Status)

This constructs a health response.

public HealthResponse(

IModule module,

Status status

);

Parameters

module

The module whose health is being reported.

status

The health of the module.

Remarks

This constructs a health response. A default description is provided.

See Also

HealthResponse Class|ActionEngine.Api Namespace|HealthResponse Constructor Overload List

API Class Library

HealthResponse Constructor (IModule, Status, String)

This constructs a health response.

public HealthResponse(

IModule module,

Status status,

string description

);

Parameters

module

The module whose health is being reported.

status

The health of the module.

description

The description of the status (optional). If null, a default description is provided.

See Also

HealthResponse Class|ActionEngine.Api Namespace|HealthResponse Constructor

Overload List

API Class Library

HealthResponse.Status Enumeration

The enumeration of health statuses.

public enum HealthResponse.Status

Members

| Member Name | Description |
|---|---|
| Healthy | The module is healthy. |
| Sick | The module is sick. |

Requirements

Namespace: ActionEngine.Api

Assembly: aefwapi (in aefwapi.dll)

See Also

ActionEngine.Api Namespace

API Class Library

IAuthHandler Interface

This interface represents a user authentication handler, which can do custom authorization handling as well as taking ownership of various categories of user data.

For a list of all members of this type, see IAuthHandler Members.

public interface IAuthHandler: IModule, IHealth

Remarks

This interface represents a user authentication handler, which can do custom authorization handling as well as taking ownership of various categories of user data. To implement your own authentication handler:

Create a new plugin folder.

In the plugin folder, create a “cfg” subfolder. In the cfg folder, create an “install.xml” file. The install.xml file defines a component of type “auth.” Here is an example install.xml file: <install><content><component name=“myauthcomp” type=“auth”><class assembly=“myauthcomp.dll” lang=“.net”>MyCompany. MyAuthHandler</class></component></content><plugin><id>myauth</id><namespace>abc</namespace><version>0.1</version></plugin></install>

In the plugin folder, create a “dotnet” subfolder. The assembly referenced in install.xml is relative to this folder.

Implement the IAuthHandler interface using the class name defined in install.xml.

Edit aereg.xml to point to your auth handler for a given user namespace. Note that the namespace defined in install.xml is actually a “resource” namespace, not a user namespace. For example, to use your auth handler for user namespace “people,” add this to aereg.xml: <namespaces><ns id=“people”><auth compld=“abc:myauthcomp” password=“ . . . optional . . . ”/></ns></namespaces>

The “password” attribute above is optional. If provided, it is passed to every authentication related call to the plugin host. It serves no purpose in this .NET API, but for a pure HTTP/XML based implementation it allows the auth implementation to make sure it's getting requests from an authenticated source, not some random client on the internet.

At a minimum, implement CreateUser and GetSupportedData. Depending on what you advertise in GetSupportedData, you may need to implement other methods. To leave a method as not implemented, just return null or a new CodeResponse of E_NOT_IMPL.

Requirements

Namespace: ActionEngine.Api

Assembly: aefwapi (in aefwapi.dll)

See Also

IAuthHandler Members|ActionEngine.Api Namespace

API Class Library

IAuthHandler Members

IAuthHandler overview

Public Instance Methods

| | |
|---|---|
| CreateUser | This is called to create a new user. |
| DeleteUser | CURRENTLY NOT IMPLEMENTED. |
| DoesUserExist | This is called to check for the existence of a user. |
| GetSignupConcepts | This is called to retrieve custom concepts for |
| | collecting additional data during sign-up. |
| GetSupportedData | This is called to discover what user data and |
| | features this auth handler supports. |
| GetUserData | This is called to retrieve all user data owned by this |
| | auth handler. |
| LogOn | This is called to authenticate a user. |
| ModifyUserData | This is called to add, delete, and modify user data. |
| SetIdentity | This is called to set a user's identity. |
| SetPassword | This is called to set a user's password. |
| SetPrimaryUserData | This is called to set the primary flag for a particular |
| | user data category. |

See Also

IAuthHandler Interface|ActionEngine.Api Namespace

API Class Library

IAuthHandler Methods

The methods of the IAuthHandler interface are listed below. For a complete list of IAuthHandler interface members, see the IAuthHandler Members topic.

Public Instance Methods

| | |
|---|---|
| CreateUser | This is called to create a new user. |
| DeleteUser | CURRENTLY NOT IMPLEMENTED. |
| DoesUserExist | This is called to check for the existence of a user. |
| GetSignupConcepts | This is called to retrieve custom concepts for |
| | collecting additional data during sign-up. |
| GetSupportedData | This is called to discover what user data and |
| | features this auth handler supports. |
| GetUserData | This is called to retrieve all user data owned by this |
| | auth handler. |
| LogOn | This is called to authenticate a user. |
| ModifyUserData | This is called to add, delete, and modify user data. |
| SetIdentity | This is called to set a user's identity. |
| SetPassword | This is called to set a user's password. |
| SetPrimaryUserData | This is called to set the primary flag for a particular |
| | user data category. |

See Also

IAuthHandler Interface|ActionEngine.Api Namespace

API Class Library

IAuthHandler.CreateUser Method

This is called to create a new user.

Response CreateUser(

ClientInfo clientInfo,

User user,

string conceptValues,

Result result

);

Parameters

clientInfo

Information about the client making the request.

user

The user to create.

conceptValues

The values of the submitted custom concepts.

result

The result associated with the original AnswersResponse.

Return Value

A Response.

Remarks

This is called to create a new user. If successful, typically a CodeResponse of S_OK is returned. If you wish to return custom sign-up concepts to gather more data, return a ConceptsResponse. If you wish to return a custom solution at the end of a successful sign-up, return an AnswersResponse.

If you include SignupConcepts in the response to GetSupportedData, you can append your own concepts to those already present in sign-up. This is done in response to GetSignupConcepts. Once those concepts are submitted back to the server, the concept values and a Result are provided as arguments here.

If you include SilentSignup in your response to GetSupportedData, this method behaves a bit differently. Silent sign-up involves two basic ideas. One is that, if the framework finds that an account exists in this auth handler but not in the framework database, it will automatically (silently) create a framework account, in which case CreateUser is never called. The second idea is that, if the user explicitly signs up, CreateUser will be called, and its implementation should handle two cases:

The account does not exist in the auth handler. Your implementation should simply create the account.

The account DOES exist in the auth handler. Your implementation should try to do a logon request with the given user name and password. If successful, return S_OK. If not, return E_LOGON_FAILED.

See Also

IAuthHandler Interface|ActionEngine.Api Namespace|GetSignupConcepts

API Class Library

IAuthHandler.DeleteUser Method

CURRENTLY NOT IMPLEMENTED.

Response DeleteUser(

Clientinfo clientinfo,

UserName userName,

string password

);

Parameters

clientInfo

Information about the client making the request.

userName

The user name.

password

The user's password. Note: the password is null in cases where administrator-level functionality is driving this call.

Return Value

A Response.

Remarks

This is called to delete an existing user. If successful, or if the user doesn't exist, return S_OK. Otherwise, return an appropriate error code.

See Also

IAuthHandler Interface|ActionEngine.Api Namespace

API Class Library

IAuthHandler.DoesUserExist Method

This is called to check for the existence of a user.

Response DoesUserExist(

ClientInfo clientInfo,

UserName userName

);

Parameters

clientInfo

Information about the client making the request.

userName

The user name.

Return Value

A Response.

Remarks

This is called to check for the existence of a user. The appropriate BooleanResponse should be returned, or a CodeResponse in case of error. If SilentSignup is supported, this is never called in which case returning null is fine.

See Also

IAuthHandler Interface|ActionEngine.Api Namespace

API Class Library

IAuthHandler.GetSignupConcepts Method

This is called to retrieve custom concepts for collecting additional data during sign-up.

Response GetSignupConcepts(

ClientInfo clientInfo

);

Parameters

clientInfo

Information about the client making the request.

Return Value

A Response.

Remarks

This is called to retrieve custom concepts for collecting additional data during sign-up. To implement this, you must support SignupConcepts. A ConceptsResponse should be returned, or a CodeResponse in case of error.

See Also

IAuthHandler Interface|ActionEngine.Api Namespace|CreateUser

API Class Library

IAuthHandler.GetSupportedData Method

This is called to discover what user data and features this auth handler supports.

Response GetSupportedData(

ClientInfo clientInfo

);

Parameters

clientInfo

Information about the client making the request.

Return Value

A Response.

Remarks

This is called to discover what user data and features this auth handler supports. A SupportedAuthDataResponse should be returned, or a CodeResponse in case of error.

See Also

IAuthHandler Interface|ActionEngine.Api Namespace

API Class Library

IAuthHandler.GetUserData Method

This is called to retrieve all user data owned by this auth handler.

Response GetUserData(

ClientInfo clientInfo,

UserName userName,

string password

);

Parameters

clientInfo

Information about the client making the request.

userName

The user name.

password

The user's password. Note: the password is null in cases where administrator-level functionality is driving this call.

Return Value

A Response.

Remarks

This is called to retrieve all user data owned by this auth handler. A UserDataResponse should be returned, or a CodeResponse in case of error.

See Also

IAuthHandler Interface|ActionEngine.Api Namespace|UserDataResponse

API Class Library

IAuthHandler.LogOn Method

This is called to authenticate a user.

Response LogOn(

ClientInfo clientInfo,

User user,

UserName userName,

string password

);

Parameters

clientInfo

Information about the client making the request.

user

The user, or null in the case of silent sign-up where the auth handler has created the account but the framework has not yet done so, which would only happen once for the life of the user.

userName

The user name.

password

The user's password.

Return Value

A Response.

Remarks

This is called to authenticate a user. A BooleanResponse should be returned with true for success and false for access denied, or a CodeResponse in case of error.

See Also

IAuthHandler Interface|ActionEngine.Api Namespace

API Class Library

IAuthHandler.ModifyUserData Method

This is called to add, delete, and modify user data.

Response ModifyUserData(

ClientInfo clientInfo,

UserName userName,

string password,

FriendlyData [symbol] toDelete,

FriendlyPair [symbol] toModify,

FriendlyData [symbol] toAdd

);

Parameters

clientInfo

Information about the client making the request.

userName

The user name.

password

The user's password. Note: the password is null in cases where administrator-level functionality is driving this call.

toDelete

The friendly data to delete. This is never null, only potentially zero in length.

toModify

The friendly data to modify. This is never null, only potentially zero in length.

toAdd

The friendly data to add. This is never null, only potentially zero in length.

Return Value

A Response.

Remarks

This is called to add, delete, and modify user data. The order in which these modifications must be done is deletions, followed by modifications, followed by additions. If an error happens along the way, there is no need to roll back the changes already made, although this can be done if desired.

See Also

IAuthHandler Interface|ActionEngine.Api Namespace

API Class Library

IAuthHandler.SetIdentity Method

This is called to set a user's identity.

Response SetIdentity(

ClientInfo clientInfo,

UserName userName,

string password,

Identity identity

);

Parameters

clientInfo

Information about the client making the request.

userName

The user name.

password

The user's password. Note: the password is null in cases where administrator-level functionality is driving this call.

identity

The new identity.

Return Value

A Response.

Remarks

This is called to set a user's identity. If successful, return S_OK. Otherwise, return an appropriate error code.

See Also

IAuthHandler Interface|ActionEngine.Api Namespace

API Class Library

IAuthHandler.SetPassword Method

This is called to set a user's password.

Response SetPassword(

ClientInfo clientInfo,

UserName userName,

string password,

string newPassword

);

Parameters

clientInfo

Information about the client making the request.

userName

The user name.

password

The user's password. Note: the password is null in cases where administrator-level functionality is driving this call.

newPassword

The new password.

Return Value

A Response.

Remarks

This is called to set a user's password. If successful, return S_OK. Otherwise, return an appropriate error code. If password changes are not supported, return E_PASSWORD_CANT_CHANGE.

See Also

IAuthHandler Interface|ActionEngine.Api Namespace

API Class Library

IAuthHandler.SetPrimaryUserData Method

This is called to set the primary flag for a particular user data category.

Response SetPrimaryUserData(

ClientInfo clientInfo,

UserName userName,

string password,

string category,

string friendlyName

);

Parameters

clientInfo

Information about the client making the request.

userName

The user name.

password

The user's password. Note: the password is null in cases where administrator-level functionality is driving this call.

category

The category of friendly data.

friendlyName

The friendly name that is to be made primary within the FriendlyDataSet.

Return Value

A Response.

Remarks

This is called to set the primary flag for a particular user data category. If successful, return S_OK. Otherwise, return an appropriate error code.

The valid categories are:

ROOT_NAME

ROOT_NAME

ROOT_NAME

ROOT_NAME

See Also

IAuthHandler Interface|ActionEngine.Api Namespace

API Class Library

Identity Class

This class represents a person's name broken out into first name, last name, etc.

For a list of all members of this type, see Identity Members.

System.Object

Identity

public class Identity

Requirements

Namespace: ActionEngine.Api

Assembly: aefwapi (in aefwapi.dll)

See Also

Identity Members|ActionEngine.Api Namespace

API Class Library

Identity Members

Identity overview

| | |
|---|---|
| Public Instance | |
| Constructors | |
| Identity Constructor | This constructs an identity. |
| Public Instance | |
| Properties | |
| FirstName | The person's first name. |
| LastName | The person's last name. |
| MiddleName | The person's middle name. |
| Suffix | The person's suffix. |
| Title | The person's title. |
| Public Instance Methods | |
| Equals (inherited | Determines whether the specified Object is |
| from Object) | equal to the current Object. |
| GetHashCode | Serves as a hash function for a particular |
| (inherited from Object) | type, suitable for use in hashing |
| | algorithms and data structures |
| | like a hash table. |
| GetType (inherited from | Gets the Type of the current instance. |
| Object) | |
| ToString (inherited from | Returns a String that represents |
| Object) | the current Object. |
| Protected Instance | |
| Methods | |
| Finalize (inherited | Allows an Object to attempt to free resources |
| from Object) | and perform other cleanup operations before |
| | the Object is reclaimed by garbage collection. |
| MemberwiseClone | Creates a shallow copy of the current Object. |
| (inherited from Object) | |

See Also

Identity Class|ActionEngine.Api Namespace

API Class Library

Identity Constructor

This constructs an identity.

public Identity(

string first,

string middle,

string last

);

Parameters

first

The first name, or null if not specified.

middle

The middle name, or null if not specified.

last

The last name, or null if not specified.

See Also

Identity Class|ActionEngine.Api Namespace

API Class Library

Identity Properties

The properties of the Identity class are listed below. For a complete list of Identity class members, see the Identity Members topic.

Public Instance Properties

| | |
|---|---|
| FirstName | The person's first name. |
| LastName | The person's last name. |
| MiddleName | The person's middle name. |
| Suffix | The person's suffix. |
| Title | The person's title. |

See Also

Identity Class|ActionEngine.Api Namespace

API Class Library

Identity.FirstName Property

The person's first name.

public string FirstName {get; set;}

Remarks

The person's first name. When setting, null is valid. When getting, if not specified, an empty string (“ ”) is returned.

See Also

Identity Class|ActionEngine.Api Namespace

API Class Library

Identity.LastName Property

The person's last name.

public string LastName {get; set;}

Remarks

The person's last name. When setting, null is valid. When getting, if not specified, an empty string (“ ”) is returned.

See Also

Identity Class|ActionEngine.Api Namespace

API Class Library

Identity.MiddleName Property

The person's middle name.

public string MiddleName {get; set;}

Remarks

The person's middle name. When setting, null is valid. When getting, if not specified, an empty string (“ ”) is returned.

See Also

Identity Class|ActionEngine.Api Namespace

API Class Library

Identity.Suffix Property

The person's suffix.

public string Suffix {get; set;}

Remarks

The person's suffix. When setting, null is valid. When getting, if not specified, an empty string (“ ”) is returned.

See Also

Identity Class|ActionEngine.Api Namespace

API Class Library

Identity.Title Property

The person's title.

public string Title {get; set;}

Remarks

The person's title. When setting, null is valid. When getting, if not specified, an empty string (“ ”) is returned.

See Also

Identity Class|ActionEngine.Api Namespace

API Class Library

IHealth Interface

!@#

For a list of all members of this type, see IHealth Members.

public interface IHealth

Requirements

Namespace: ActionEngine.Api

Assembly: aefwapi (in aefwapi.dll)

See Also

IHealth Members|ActionEngine.Api Namespace

API Class Library

IHealth Members

IHealth overview

Public Instance Methods

| | |
|---|---|
| CheckHealth | This is called periodically to check on |
| | the health of a module. |

See Also

IHealth Interface|ActionEngine.Api Namespace

API Class Library

IHealth Methods

The methods of the IHealth interface are listed below. For a complete list of IHealth interface members, see the IHealth Members topic.

Public Instance Methods

| | |
|---|---|
| CheckHealth | This is called periodically to check |
| | on the health of a module. |

See Also

IHealth Interface|ActionEngine.Api Namespace

API Class Library

IHealth.CheckHealth Method

This is called periodically to check on the health of a module.

Response CheckHealth( );

Return Value

A Response.

Remarks

This is called periodically to check on the health of a module. Typically a HealthResponse is returned. !@# MUCH MORE NEEDED . . .

See Also

IHealth Interface|ActionEngine.Api Namespace

API Class Library

ImageResource Class

This class represents an image (graphic) resource.

For a list of all members of this type, see ImageResource Members.

System.Object

Resource

BinaryResource

ImageResource

public class ImageResource: BinaryResource

Requirements

Namespace: ActionEngine.Api

Assembly: aefwapi (in aefwapi.dll)

See Also

ImageResource Members|ActionEngine.Api Namespace

API Class Library

ImageResource Members

ImageResource overview

| | |
|---|---|
| Public Instance | |
| Constructors | |
| ImageResource | Overloaded. Initializes a new instance of the |
| | ImageResource class. |
| Public Instance | |
| Methods | |
| Equals (inherited | Determines whether the specified Object is equal to |
| from Object) | the current Object. |
| GetHashCode | Serves as a hash function for a particular type, |
| (inherited from | suitable for use in hashing algorithms and data |
| from Resource) | structures like a hash table. |
| GetType (inherited | Gets the Type of the current instance. |
| from Object) | |
| ToString (inherited | This returns an XML representation of the resource. |
| from Resource) | |
| Protected Instance | |
| Methods | |
| Finalize (inherited | Allows an Object to attempt to free resources and |
| from Object) | perform other cleanup operations before the Object |
| | is reclaimed by garbage collection. |
| MemberwiseClone | Creates a shallow copy of the current Object. |
| (inherited from | |
| Object) | |

See Also

ImageResource Class|ActionEngine.Api Namespace

API Class Library

ImageResource Constructor

This constructs an image resource.

Overload List

This constructs an image resource.

public ImageResource(ResourceReference,byte [symbol] );

This constructs an image resource.

public ImageResource(ResourceReference,Image);

See Also

ImageResource Class|ActionEngine.Api Namespace

API Class Library

ImageResource Constructor (ResourceReference, Byte [symbol] )

This constructs an image resource.

public ImageResource(

ResourceReference resourceReference,

byte [symbol] bytes

);

Parameters

resourceReference

The original reference to the image.

bytes

The binary content of the image.

See Also

ImageResource Class|ActionEngine.Api Namespace|ImageResource Constructor

Overload List

API Class Library

ImageResource Constructor (ResourceReference, Image)

This constructs an image resource.

public ImageResource(

ResourceReference resourceReference,

Image image

);

Parameters

resourceReference

The original reference to the image.

image

The image.

See Also

ImageResource Class|ActionEngine.Api Namespace|ImageResource Constructor

Overload List

API Class Library

IModule Interface

This interface represents a module, which is the base interface for IAuthHandler and IService but can also represent a module on its own.

For a list of all members of this type, see IModule Members.

public interface IModule

Remarks

This interface represents a module, which is the base interface for IAuthHandler and IService but can also represent a module on its own.

During start-up, all modules are loaded by the process. Then, ModuleInit is called on each one. After that, service and auth requests are processed if the IModule is an IAuthHandler or an IService.

If your plugin does any background tasks in a separate thread, make sure you register for the “die” event so you can gracefully shut down. For more information, see DieEvents.

Implementing a module that is not an IAuthHandler or an IService can be useful in ways that a standard Windows service is useful, but you have the advantage of working inside the framework and can make use of a configuration file and your plugin environment.

Modules can also dynamically obtain references to other modules running in the process. There are several benefits to this model. For more information, see the class overview for PluginEnvironment. If a module makes use of a type (interface, class, etc.) exposed by an assembly in another plugin, a dependency needs to be set up in install.xml. See the example below.

To implement a module that is not an IAuthHandler or an IService:

Create a new plugin folder.

In the plugin folder, create a “cfg” subfolder. In the cfg folder, create an “install.xml” file. The install.xml file defines a component of type “module.” Here is an example install.xml file: <install><content><component name=“mymodule” type=“module”><class assembly=“mymodule.dll” lang=“.net”>MyCompany.MyModule</class><dependencies><component>some_ns:some_componentOne</component><component>some_componentTwo</component></dependencies></component></content><plugin><id>mymodule</id><namespace>abc</namespace><version>0.1</version></plugin></install>

In the plugin folder, create a “dotnet” subfolder. The assembly referenced in install.xml is relative to this folder.

Implement the IModule interface using the class name defined in install.xml.

If the module makes use of a type (interface, class, etc.) exposed by an assembly in another plugin, set up a dependency to the component where the needed assembly exists by specifying its component ID. Otherwise, the process will fail to instantiate your module. Recursive dependencies are honored. In other words, if component A depends on component B, which depends on component C, component A will receive a local copy of the assemblies for both components B and C. The specified component IDs should be fully-qualified with the resource namespace. If not, the namespace of the local component is assumed, which is generally not what you want unless you are setting up a dependency between assemblies in the same plugin.

Requirements

Namespace: ActionEngine.Api

Assembly: aefwapi (in aefwapi.dll)

See Also

IModule Members|ActionEngine.Api Namespace

API Class Library

IModule Members

IModule overview

Public Instance Methods

| | |
|---|---|
| ModuleInit | This is called after all modules are loaded by the |
| | process but before any auth or service requests are |
| | processed (if this module is also an IAuthHandler or |
| | an IService). |

See Also

IModule Interface|ActionEngine.Api Namespace

API Class Library

IModule Methods

The methods of the IModule interface are listed below. For a complete list of IModule interface members, see the IModule Members topic.

Public Instance Methods

| | |
|---|---|
| ModuleInit | This is called after all modules are loaded by the |
| | process but before any auth or service requests are |
| | processed (if this module is also an IAuthHandler or |
| | an IService). |

See Also

IModule Interface|ActionEngine.Api Namespace

API Class Library

IModule.ModuleInit Method

This is called after all modules are loaded by the process but before any auth or service requests are processed (if this module is also an IAuthHandler or an IService).

void ModuleInit( );

See Also

IModule Interface|ActionEngine.Api Namespace

API Class Library

InfoRequest Class

This class represents the XML content returned by an IServiceInfo instance in response to GetInfoRequest.

For a list of all members of this type, see InfoRequest Members.

System.Object

InfoRequest

public class InfoRequest

Remarks

This class represents the XML content returned by an IServiceInfo instance in response to GetInfoRequest. The framework then passes the info request to various service info instances so that each one can reply with its own info. A file called actioninfo_cfg.xml in the framework's cfg directory defines the relationships of services that get called to provide info. After calling GetInfo on the appropriate services, the engine aggregates each chunk of info returned into a single deck that the user sees while waiting for the “actual” request to return.

Requirements

Namespace: ActionEngine.Api

Assembly: aefwapi (in aefwapi.dll)

See Also

InfoRequest Members|ActionEngine.Api Namespace|InfoRequestResponse

IServiceInfo

API Class Library

InfoRequest Members

InfoRequest overview

| | |
|---|---|
| Public Instance | |
| Constructors | |
| InfoRequest | Overloaded. Initializes a new instance of the |
| | InfoRequest class. |
| Public Instance | |
| Properties | |
| RootElement | This represents the root element of the info request |
| | XML. |
| Public Instance | |
| Methods | |
| Equals (inherited | Determines whether the specified Object is equal to |
| from Object) | the current Object. |
| GetHashCode | Serves as a hash function for a particular type, |
| (inherited from | suitable for use in hashing algorithms and data |
| Object) | structures like a hash table. |
| GetType (inherited | Gets the Type of the current instance. |
| from Object) | |
| ToString | This returns an XML representation of the info |
| | request. |
| Protected Instance | |
| Methods | |
| Finalize | Allows an Object to attempt to free resources and |
| (inherited from | perform other cleanup operations before the Object |
| Object) | is reclaimed by garbage collection. |
| MemberwiseClone | Creates a shallow copy of the current Object. |
| (inherited from | |
| Object) | |

See Also

InfoRequest Class|ActionEngine.Api Namespace|InfoRequestResponse|IServiceInfo

API Class Library

InfoRequest Constructor

This constructs an empty info request.

Overload List

This constructs an empty info request.

public InfoRequest( );

This constructs an info request using the given XML as its content.

public InfoRequest(XmlElement);

See Also

InfoRequest Class|ActionEngine.Api Namespace

API Class Library

InfoRequest Constructor( )

This constructs an empty info request.

public InfoRequest( );

Remarks

This constructs an empty info request. It is equivalent to calling InfoRequest(null).

See Also

InfoRequest Class|ActionEngine.Api Namespace|InfoRequest Constructor Overload List

API Class Library

InfoRequest Constructor (XmlElement)

This constructs an info request using the given XML as its content.

public InfoRequest(

XmlElement root

);

Parameters

root

The XML content.

Remarks

This constructs an info request using the given XML as its content. If the XML element is null, this is interpreted by the framework to mean that no info should be collected from various services. Otherwise, the XML is passed to GetInfo calls on various IServiceInfo instances.

See Also

InfoRequest Class|ActionEngine.Api Namespace|InfoRequest Constructor Overload List

API Class Library

InfoRequest Properties

The properties of the InfoRequest class are listed below. For a complete list of InfoRequest class members, see the InfoRequest Members topic.

Public Instance Properties

| | |
|---|---|
| RootElement | This represents the root element of the info request XML. |

See Also

InfoRequest Class|ActionEngine.Api Namespace|InfoRequestResponse IServiceInfo

API Class Library

InfoRequest.RootElement Property

This represents the root element of the info request XML.

public System.Xml.XmlElement RootElement {get; set;}

Remarks

This represents the root element of the info request XML. Null is allowed, although when the framework calls GetInfo the root element is never null.

See Also

InfoRequest Class|ActionEngine.Api Namespace

API Class Library

InfoRequest Methods

The methods of the InfoRequest class are listed below. For a complete list of InfoRequest class members, see the InfoRequest Members topic.

| | |
|---|---|
| Public Instance | |
| Methods | |
| Equals (inherited | Determines whether the specified Object is equal to |
| from Object) | the current Object. |
| GetHashCode | Serves as a hash function for a particular type, |
| (inherited from | suitable for use in hashing algorithms and data |
| Object) | structures like a hash table. |
| GetType (inherited | Gets the Type of the current instance. |
| from Object) | |
| ToString | This returns an XML representation of the info |
| | request. |
| Protected Instance | |
| Methods | |
| Finalize | Allows an Object to attempt to free resources and |
| (inherited from | perform other cleanup operations before the Object |
| Object) | is reclaimed by garbage collection. |
| MemberwiseClone | Creates a shallow copy of the current Object. |
| (inherited from | |
| Object) | |

See Also

InfoRequest Class|ActionEngine.Api Namespace|InfoRequestResponse IServiceInfo

API Class Library

InfoRequest.ToString Method

This returns an XML representation of the info request.

public override string ToString( );

Return Value

An XML representation of the info request.

See Also

InfoRequest Class|ActionEngine.Api Namespace

API Class Library

InfoRequest.Command Enumeration

The enumeration of valid primary commands associated with GetInfoRequest.

public enum InfoRequest.Command

Members

Members

| Member Name | Description |
|---|---|
| DoFeatureCommand | A doFeatureCommand command. |
| DoSolutionCommand | A doSolutionCommand command. |
| SubmitConcepts | A submitConcepts command. |

Requirements

Namespace: ActionEngine.Api

Assembly: aefwapi (in aefwapi.dll)

See Also

ActionEngine.Api Namespace

API Class Library

InfoRequestResponse Class

This class represents an “info request” response, which is returned by GetInfoRequest. For a list of all members of this type, see InfoRequestResponse Members.

System.Object

Response

InfoRequestResponse

public class InfoRequestResponse: Response

Requirements

Namespace: ActionEngine.Api

Assembly: aefwapi (in aefwapi.dll)

See Also

InfoRequestResponse Members|ActionEngine.Api Namespace

API Class Library

InfoRequestResponse Members

InfoRequestResponse overview

| | |
|---|---|
| Public Instance | |
| Constructors | |
| InfoRequestResponse | This constructs an “info request” response. |
| Constructor | |
| Public Instance | |
| Methods | |
| Equals (inherited | Determines whether the specified Object is |
| from Object) | equal to the current Object. |
| GetHashCode | Serves as a hash function for a particular type, |
| (inherited from | suitable for use in hashing algorithms and data |
| Object) | structures like a hash table. |
| GetType (inherited | Gets the Type of the current instance. |
| from Object) | |
| ToString (inherited | This returns an XML representation of the |
| from Response) | response. |
| Protected Instance | |
| Methods | |
| Finalize | Allows an Object to attempt to free resources and |
| (inherited from | perform other cleanup operations before the |
| Object) | Object is reclaimed by garbage collection. |
| MemberwiseClone | Creates a shallow copy of the current Object. |
| (inherited from | |
| Object) | |

See Also

InfoRequestResponse Class|ActionEngine.Api Namespace

API Class Library

InfoRequestResponse Constructor

This constructs an “info request” response.

public InfoRequestResponse(

InfoRequest InfoRequest

);

Parameters

InfoRequest

The info request, or null if no info request is intended.

See Also

InfoRequestResponse Class|ActionEngine.Api Namespace

API Class Library

InfoResponse Class

This class represents an info response (sometimes called an “action info” response).

For a list of all members of this type, see InfoResponse Members.

System.Object

Response

InfoResponse

public class InfoResponse: Response

Remarks

This class represents an info response (sometimes called an “action info” response). This is generally returned by GetInfo.

Requirements

Namespace: ActionEngine.Api

Assembly: aefwapi (in aefwapi.dll)

See Also

InfoResponse Members|ActionEngine.Api Namespace

API Class Library

InfoResponse Members

InfoResponse overview

| | |
|---|---|
| Public Instance | |
| Constructors | |
| InfoResponse | This constructs an info response. |
| Constructor | |
| Public Instance | |
| Methods | |
| Equals (inherited | Determines whether the specified Object is equal to |
| from Object) | the current Object. |
| GetHashCode | Serves as a hash function for a particular type, |
| (inherited from | suitable for use in hashing algorithms and data |
| Object) | structures like a hash table. |
| GetType (inherited | Gets the Type of the current instance. |
| from Object) | |
| ToString (inherited | This returns an XML representation of the |
| from Response) | response. |
| Protected Instance | |
| Methods | |
| Finalize | Allows an Object to attempt to free resources and |
| (inherited from | perform other cleanup operations before the Object |
| Object) | is reclaimed by garbage collection. |
| MemberwiseClone | Creates a shallow copy of the current Object. |
| (inherited from | |
| Object) | |

See Also

InfoResponse Class|ActionEngine.Api Namespace

API Class Library

InfoResponse Constructor

This constructs an info response.

public InfoResponse(

Result result

);

Parameters

result

The result, which can be null if no info is intended.

See Also

InfoResponse Class|ActionEngine.Api Namespace|GetInfo

API Class Library

IService Interface

This interface represents a service plugin, which processes requests and generally returns solutions to a client for viewing by the end user.

For a list of all members of this type, see IService Members.

public interface IService: IModule, IHealth

Remarks

This interface represents a service plugin, which processes requests and generally returns solutions to a client for viewing by the end user. To implement your own service:

Create a new plugin folder.

In the plugin folder, create a “cfg” subfolder. In the cfg folder, create an “install.xml” file with two components: one service and one feature. The feature needs to reference the service's component name. Here is an example install.xml file: <install><content><component name=“myservice” type=“service”><class assembly=“myservice.dll” lang=“.net”>MyCompany.MyService</class></component><component name=“myfeature” type=“feature”><description>This is my feature</description><service>myservice</service></component></content><plugin><id>myplugin</id><namespace>abc</namespace><version>0.1</version></plugin></install>

In the plugin folder, create a “dotnet” subfolder. The assembly referenced in install.xml is relative to this folder.

Implement the IService interface using the class name defined in install.xml. If desired, also implement IServiceInfo.

At a minimum, implement SubmitConcepts. You will most likely want to implement DoSolutionCommand as well. To leave a method as not implemented, just return null or a new CodeResponse of E_NOT_IMPL.

Requirements

Namespace: ActionEngine.Api

Assembly: aefwapi (in aefwapi.dll)

See Also

IService Members|ActionEngine.Api Namespace|IServiceInfo

API Class Library

IService Members

IService overview

Public Instance Methods

| | |
|---|---|
| DoFeatureCommand | This is called to process an ex:fc( ) command |
| | from a client. |
| DoSolutionCommand | This is called to process an ex:sc( ) command |
| | from a client. |
| GetDeck | This is called to process an ex:getDeck( ) |
| | command from a client. |
| GetResources | This is called to return one or more resources |
| | to the engine. |
| SubmitConcepts | This is called to process concept values |
| | submitted by the client. |

See Also

IService Interface|ActionEngine.Api Namespace IServiceInfo

API Class Library

IService Methods

The methods of the IService interface are listed below. For a complete list of IService interface members, see the IService Members topic.

Public Instance Methods

| | |
|---|---|
| DoFeatureCommand | This is called to process an ex:fc( ) command |
| | from a client. |
| DoSolutionCommand | This is called to process an ex:sc( ) command |
| | from a client. |
| GetDeck | This is called to process an ex:getDeck( ) |
| | command from a client. |
| GetResources | This is called to return one or more resources |
| | to the engine. |
| SubmitConcepts | This is called to process concept values |
| | submitted by the client. |

See Also

IService Interface|ActionEngine.Api Namespace|IServiceInfo

API Class Library

IService.DoFeatureCommand Method

This is called to process an ex:fc( ) command from a client.

Response DoFeatureCommand(

Clientinfo clientInfo,

User user,

string [symbol] args,

DateTime scheduledMoment

);

Parameters

clientInfo

Information about the client making the request.

user

The user related to the request.

args

Zero or more arguments as defined in the ex:fc( ) command. This is never null.

scheduledMoment

The date/time associated with the moment in a feature schedule that caused this to be called, or NoDateTime if this is unrelated to push. Because the actual time that DoFeatureCommand is called could be much later than the intended scheduled time in some cases, such as when messages back up in the push server's queue without the client picking them up, this provides the service with the link, essentially, to the original scheduled moment. For more information, see FeatureSchedule.

Return Value

A Response.

Remarks

This is called to process an ex:fc( ) command from a client. Typically an answer or concepts response is returned. A “feature command” is useful for switching contexts from one plugin to another. For example, feature A can return a solution with an ex:fc( ) that kicks off feature B by using feature B's feature ID.

See Also

IService Interface|ActionEngine.Api Namespace|AnswersResponse|ConceptsResponse

API Class Library

IService.DoSolutionCommand Method

This is called to process an ex:sc( ) command from a client.

Response DoSolutionCommand(

ClientInfo clientInfo,

User user,

Result result,

string [symbol] args

);

Parameters

clientInfo

Information about the client making the request.

user

The user related to the request.

result

The result that was previously generated by the service for the current user, or null if no previous result exists.

args

Zero or more arguments as defined in the ex:sc( ) command. This is never null.

Return Value

A Response.

Remarks

This is called to process an ex:sc( ) command from a client. Typically an answer or concepts response is returned.

See Also

IService Interface|ActionEngine.Api Namespace|AnswersResponse|ConceptsResponse

API Class Library

IService.GetDeck Method

This is called to process an ex:getdeck( ) command from a client.

Response GetDeck(

ClientInfo clientInfo,

User user,

string [symbol] args

);

Parameters

clientInfo

Information about the client making the request.

user

The user related to the request.

args

Zero or more arguments as defined in the ex:getDeck( ) command. This is never null.

Return Value

A Response.

Remarks

This is called to process an ex:getDeck( ) command from a client. Typically a deck response is returned. Answer and concepts responses are not allowed.

See Also

IService Interface|ActionEngine.Api Namespace|DeckResponse

API Class Library

IService.GetResources Method

This is called to return one or more resources to the engine.

Response GetResources(

ClientInfo clientInfo,

ResourceReference [symbol] resourceReferences

);

Parameters

clientInfo

Information about the client making the request.

resourceReferences

An array of one or more resource references for which the engine is requesting actual resources.

Return Value

A Response.

Remarks

This is called to return one or more resources to the engine. A resources response is expected.

See Also

IService Interface|ActionEngine.Api Namespace|ResourcesResponse

API Class Library

IService.SubmitConcepts Method

This is called to process concept values submitted by the client.

Response SubmitConcepts(

ClientInfo clientInfo,

User user,

Result result,

ConceptValues conceptValues

);

Parameters

clientInfo

Information about the client making the request.

user

The user related to the request.

result

The result that was previously generated by the service for the current user, or null if no previous result exists. Submitting dynamic concepts is the only time a previous result might exist.

conceptValues

The concept values posted by the client.

Return Value

A Response.

Remarks

This is called to process concept values submitted by the client. Typically an answer or concepts response is returned.

See Also

IService Interface|ActionEngine.Api Namespace|AnswersResponse|ConceptsResponse

API Class Library

IServiceInfo Interface

This interface represents “info” related functionality (sometimes called “action info”) for a service.

For a list of all members of this type, see IServiceInfo Members.

public interface IServiceInfo

Remarks

This interface represents “info” related functionality (sometimes called “action info”) for a service. If your service does not involve info, there is no need to implement this. If your service provides chunks of info that the engine aggregates into a single deck, implement the GetInfo method. If your service is called to drive the collection of other info, implement GetInfoRequest and set up the actioninfo_cfg.xml file appropriately. For more information on the latter, see InfoRequest.

Requirements

Namespace: ActionEngine.Api

Assembly: aefwapi (in aefwapi.dll)

See Also

IServiceInfo Members|ActionEngine.Api Namespace|InfoRequest

API Class Library

IServiceInfo Members

IServiceInfo overview

Public Instance Methods

| | |
|---|---|
| GetInfo | This is called to retrive info, which is potentially |
| | aggregated with info from other services and |
| | returned to the user while waiting for an “actual” |
| | request. |
| GetInfoRequest | This is called to determine if a service will drive the |
| | collection of info from other services. |

See Also

IServiceInfo Interface|ActionEngine.Api Namespace|InfoRequest

API Class Library

IServiceInfo Methods

The methods of the IServiceInfo interface are listed below. For a complete list of IServiceInfo interface members, see the IServiceInfo Members topic.

Public Instance Methods

| | |
|---|---|
| GetInfo | This is called to retrive info, which is potentially |
| | aggregated with info from other services and |
| | returned to the user while waiting for an “actual” |
| | request. |
| GetInfoRequest | This is called to determine if a service will drive the |
| | collection of info from other services. |

See Also

IServiceInfo Interface|ActionEngine.Api Namespace|InfoRequest

API Class Library

IServiceInfo.GetInfo Method

This is called to retrive info, which is potentially aggregated with info from other services and returned to the user while waiting for an “actual” request.

Response GetInfo(

ClientInfo clientInfo,

User user,

InfoRequest infoRequest

);

Parameters

clientInfo

Information about the client making the request.

user

The user related to the request.

infoRequest

The info request. This is originally generated by GetInfoRequest and then passed to various services to retrieve and aggregate various info.

Return Value

A Response.

Remarks

This is called to retrive info, which is potentially aggregated with info from other services and returned to the user while waiting for an “actual” request. Typically an InfoResponse is returned. To leave the method as not implemented, return null or a code response of E_NOT_IMPL.

See Also

IServiceInfo Interface|ActionEngine.Api Namespace

API Class Library

IServiceInfo.GetInfoRequest Method

This is called to determine if a service will drive the collection of info from other services.

Response GetInfoRequest(

ClientInfo clientInfo,

User user,

ConceptValues conceptValues,

Command primaryCommand

);

Parameters

clientInfo

Information about the client making the request.

user

The user related to the request.

conceptValues

The concept values posted by the client.

primaryCommand

The “actual” command that the client initiated.

Return Value

A Response.

Remarks

This is called to determine if a service will drive the collection of info from other services. Typically a InfoRequestResponse is returned. To leave the method as not implemented, return null or a code response of E_NOT_IMPL.

See Also

IServiceInfo Interface|ActionEngine.Api Namespace

API Class Library

Message Class

This class represents a message.

For a list of all members of this type, see Message Members.

System.Object

Message

public class Message

Remarks

This class represents a message. Messages are generally displayed on the client as a pop-up dialog.

Requirements

Namespace: ActionEngine.Api

Assembly: aefwapi (in aefwapi.dll)

See Also

Message Members|ActionEngine.Api Namespace

API Class Library

Message Members

Message overview

| | |
|---|---|
| Public Instance Constructors | |
| Message | Overloaded. Initializes a new |
| | instance of the Message class. |
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use |
| | in hashing algorithms and data |
| | structures like a hash table. |
| GetType (inherited from Object) | Gets the Type of the current instance. |
| ToString | This returns an XML representation |
| | of the message. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

Message Class|ActionEngine.Api Namespace

API Class Library

Message Constructor

This constructs a new message with no header and a severity of Misc.

Overload List

This constructs a new message with no header and a severity of Misc.

public Message(string);

This constructs a new message with no header.

public Message(string,Severity);

This constructs a new message with a severity of Misc.

public Message(string,string);

This constructs a new message.

public Message(string,string,Severity);

See Also

Message Class|ActionEngine.Api Namespace

API Class Library

Message Constructor (String)

This constructs a new message with no header and a severity of Misc.

public Message(

string text

);

Parameters

text

The message text.

See Also

Message Class|ActionEngine.Api Namespace|Message Constructor Overload List

API Class Library

Message Constructor (String, String)

This constructs a new message with a severity of Misc.

public Message(

string text,

string header

);

Parameters

text

The message text.

header

The message header. Some clients display the header at the top of a dialog box, but this is optional (pass null).

See Also

Message Class|ActionEngine.Api Namespace|Message Constructor Overload List

API Class Library

Message Constructor (String, Severity)

This constructs a new message with no header.

public Message(

string text,

Severity severity

);

Parameters

text

The message text.

severity

The message severity. Severity is interpreted by some clients to affect the icon in a message box dialog.

See Also

Message Class|ActionEngine.Api Namespace|Message Constructor Overload List

API Class Library

Message Constructor (String, String, Severity)

This constructs a new message.

public Message(

string text,

string header,

Severity severity

);

Parameters

text

The message text.

header

The message header. Some clients display the header at the top of a dialog box, but this is optional (pass null).

severity

The message severity. Severity is interpreted by some clients to affect the icon in a message box dialog.

See Also

Message Class|ActionEngine.Api Namespace|Message Constructor Overload List

API Class Library

Message Methods

The methods of the Message class are listed below. For a complete list of Message class members, see the Message Members topic.

| | |
|---|---|
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use in |
| | hashing algorithms and data |
| | structures like a hash table. |
| GetType (inherited from Object) | Gets the Type of the current instance. |
| ToString | This returns an XML representation |
| | of the message. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

Message Class|ActionEngine.Api Namespace

API Class Library

Message.ToString Method

This returns an XML representation of the message.

public override string ToString( );

Return Value

An XML representation of the message.

See Also

Message Class|ActionEngine.Api Namespace

API Class Library

Message.Severity Enumeration

The enumeration of message severities.

public enum Message.Severity

Members

| Member Name | Description |
|---|---|
| Error | An error message. |
| Misc | A miscellaneous (informational) message. |

Requirements

Namespace: ActionEngine.Api

Assembly: aefwapi (in aefwapi.dll)

See Also

ActionEngine.Api Namespace

API Class Library

MessageResponse Class

This class represents a message response.

For a list of all members of this type, see MessageResponse Members.

System.Object

Response

MessageResponse

public class MessageResponse: Response

Remarks

This class represents a message response. Messages are generally displayed on the client as a pop-up dialog.

Requirements

Namespace: ActionEngine.Api

Assembly: aefwapi (in aefwapi.dll)

See Also

MessageResponse Members|ActionEngine.Api Namespace|Message

API Class Library

MessageResponse Members

MessageResponse overview

| | |
|---|---|
| Public Instance Constructors | |
| MessageResponse Constructor | This constructs a message response. |
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use |
| | in hashing algorithms and data |
| | structures like a hash table. |
| GetType (inherited from Object) | Gets the Type of the current instance. |
| ToString (inherited from Response) | This returns an XML representation |
| | of the response. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

MessageResponse Class|ActionEngine.Api Namespace|Message

API Class Library

MessageResponse Constructor

This constructs a message response.

public MessageResponse(

Message message

);

Parameters

message

The message, which cannot be null.

See Also

MessageResponse Class|ActionEngine.Api Namespace

API Class Library

Phone Class

This class represents a phone number.

For a list of all members of this type, see Phone Members.

System.Object

FriendlyData

Phone

public class Phone: FriendlyData

Requirements

Namespace: ActionEngine.Api

Assembly: aefwapi (in aefwapi.dll)

See Also

Phone Members|ActionEngine.Api Namespace|Phones

API Class Library

Phone Members

Phone overview

| | |
|---|---|
| Public Instance Constructors | |
| Phone Constructor | This constructs a phone entry. |
| Public Instance Properties | |
| FriendlyName | The friendly name of the user data. |
| (inherited from FriendlyData) | |
| Number | The phone number itself. |
| PhoneType | The type of phone number. |
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use |
| | in hashing algorithms and data |
| | structures like a hash table. |
| GetType | Gets the Type of the current instance. |
| (inherited from Object) | |
| ToString | This returns an XML representation of |
| | the phone entry. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | |

See Also

Phone Class|ActionEngine.Api Namespace|Phones

API Class Library

Phone Constructor

This constructs a phone entry.

public Phone(

string friendlyName,

string number

);

Parameters

friendlyName

The friendly name of the phone number.

number

The phone number itself.

See Also

Phone Class|ActionEngine.Api Namespace

API Class Library

Phone Properties

The properties of the Phone class are listed below. For a complete list of Phone class members, see the Phone Members topic.

Public Instance Properties

| | |
|---|---|
| FriendlyName | The friendly name of the |
| (inherited from FriendlyData) | user data. |
| Number | The phone number itself. |
| PhoneType | The type of phone number. |

See Also

Phone Class|ActionEngine.Api Namespace|Phones

API Class Library

Phone.Number Property

The phone number itself.

public string Number {get; set;}

See Also

Phone Class|ActionEngine.Api Namespace

API Class Library

Phone.PhoneType Property

The type of phone number.

public Phone.Type PhoneType {get; set;}

See Also

Phone Class|ActionEngine.Api Namespace

API Class Library

Phone Methods

The methods of the Phone class are listed below. For a complete list of Phone class members, see the Phone Members topic.

| | |
|---|---|
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use in |
| | hashing algorithms and data |
| | structures like a hash table. |
| GetType (inherited from Object) | Gets the Type of the current instance. |
| ToString | This returns an XML representation of |
| | the phone entry. |
| Protected Instance Methods | |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

Phone Class|ActionEngine.Api Namespace|Phones

API Class Library

Phone.ToString Method

This returns an XML representation of the phone entry.

public override string ToString( );

Return Value

An XML representation of the phone entry.

See Also

Phone Class|ActionEngine.Api Namespace

API Class Library

Phone.Type Enumeration

The enumeration of valid phone types.

public enum Phone.Type

Members

| Member Name | Description |
|---|---|
| Cell | A cell/mobile phone. |
| Land | A land line phone (non-mobile). |
| Unknown | An unknown or unspecified phone type. |

Requirements

Namespace: ActionEngine.Api

Assembly: aefwapi (in aefwapi.dll)

See Also

ActionEngine.Api Namespace

API Class Library

Phones Class

This class represents a collection of Phone objects.

For a list of all members of this type, see Phones Members.

System.Object

FriendlyDataSet

Phones

public class Phones: FriendlyDataSet

Requirements

Namespace: ActionEngine.Api

Assembly: aefwapi (in aefwapi.dll)

See Also

Phones Members|ActionEngine.Api Namespace|Phone

API Class Library

Phones Members

Phones overview

| | |
|---|---|
| Public Instance Constructors | |
| Phones Constructor | This constructs an empty |
| | collection of phones. |
| Public Instance Properties | |
| GetPrimary | This retrieves the primary phone |
| | entry of the collection. |
| Item | This retrieves a phone entry by |
| | the given friendly name. |
| Public Instance Methods | |
| Add | This adds a phone entry to the collection. |
| Equals (inherited from Object) | Determines whether the specified |
| | Object is equal to the current Object. |
| GetEnumerator | This returns an IEnumerator for |
| (inherited from | enumerating the collection |
| FriendlyDataSet) | of friendly data. |
| GetHashCode | Serves as a hash function for a |
| (inherited from Object) | particular type, suitable for use in hashing |
| | algorithms and data structures like |
| | a hash table. |
| GetType | Gets the Type of the current instance. |
| (inherited from Object) | |
| Remove | This removes the phone entry with |
| | the given friendly name. |
| SetPrimary (inherited from | This sets the primary friendly data |
| FriendlyDataSet) | for the collection. This returns an XML |
| ToString (inherited from | representation of the friendly data set. |
| FriendlyDataSet) | |
| Protected Instance Methods | |
| Finalize | Allows an Object to attempt to free |
| (inherited from Object) | resources and perform other cleanup |
| | operations before the Object |
| | is reclaimed by garbage collection. |
| MemberwiseClone | Creates a shallow copy of the |
| (inherited from Object) | current Object. |

See Also

Phones Class|ActionEngine.Api Namespace|Phone

API Class Library

Phones Constructor

This constructs an empty collection of phones.

public Phones( );

See Also

Phones Class|ActionEngine.Api Namespace

API Class Library

Phones Properties

The properties of the Phones class are listed below. For a complete list of Phones class members, see the Phones Members topic.

Public Instance Properties

| | |
|---|---|
| GetPrimary | This retrieves the primary phone entry of the |
| | collection. |
| Item | This retrieves a phone entry by the given friendly |
| | name. |

See Also

Phones Class|ActionEngine.Api Namespace|Phone

API Class Library

Phones.GetPrimary Property

This retrieves the primary phone entry of the collection.

public Phone GetPrimary {get;}

Remarks

This retrieves the primary phone entry of the collection. If the collection is empty, null is returned.

See Also

Phones Class|ActionEngine.Api Namespace

API Class Library

Phones.Item Property

This retrieves a phone entry by the given friendly name.

public Phone this[

string friendlyName

] {get;}

Remarks

This retrieves a phone entry by the given friendly name. If none is found, null is returned.

See Also

Phones Class|ActionEngine.Api Namespace

API Class Library

Phones Methods

The methods of the Phones class are listed below. For a complete list of Phones class members, see the Phones Members topic.

| | |
|---|---|
| Public Instance Methods | |
| Add | This adds a phone entry to the |
| | collection. |
| Equals (inherited from Object) | Determines whether the specified |
| | Object is equal to the current Object. |
| GetEnumerator | This returns an IEnumerator for |
| (inherited from FriendlyDataSet) | enumerating the collection of |
| | friendly data. |
| GetHashCode | Serves as a hash function for a |
| (inherited from Object) | particular type, suitable for use in |
| | hashing algorithms and data |
| | structures like a hash table. |
| GetType (inherited from Object) | Gets the Type of the current instance. |
| Remove | This removes the phone entry with the |
| | given friendly name. |
| SetPrimary | This sets the primary friendly data for |
| (inherited from FriendlyDataSet) | the collection. |
| ToString | This returns an XML representation of |
| (inherited from FriendlyDataSet) | the friendly data set. |
| Protected Instance Methods | |
| Finalize | Allows an Object to attempt to free |
| | resources and |
| (inherited from Object) | perform other cleanup operations before |
| | the Object is reclaimed by garbage |
| | collection. |
| MemberwiseClone | Creates a shallow copy of the current |
| (inherited from Object) | |

See Also

Phones Class|ActionEngine.Api Namespace|Phone

API Class Library

Phones.Add Method

This adds a phone entry to the collection.

public void Add(

Phone phone

);

Parameters

phone

The phone entry to add to the collection.

See Also

Phones Class|ActionEngine.Api Namespace

API Class Library

Phones.Remove Method

This removes the phone entry with the given friendly name.

public Phone Remove(

string friendlyName

);

Parameters

friendlyName

The friendly name of the phone to remove.

Return Value

The phone removed is returned, or null if not found.

Remarks

This removes the phone entry with the given friendly name. If the phone entry is not found, no action is taken. If the phone entry removed was primary, a new one is selected.

See Also

Phones Class|ActionEngine.Api Namespace

API Class Library

PluginEnvironment Class

This class represents various aspects of a plugin's environment.

For a list of all members of this type, see PluginEnvironment Members.

System.Object

PluginEnvironment

public class PluginEnvironment

Remarks

This class represents various aspects of a plugin's environment. For example, you can discover your plugin's home directory, obtain a reference to your configuration file, and obtain references to other neighboring .NET assemblies running in the process.

Any .NET component with a main class that implements IModule can be obtained dynamically by calling one of the GetModules methods of this class. During start-up, all modules are loaded before any service, task, or auth handler requests are processed, and also before ModuleInit is called. If you want to request an IModule during your module's start-up, don't do so in the static constructor of your main class because not all modules are guaranteed to be loaded by then. Instead, wait until ModuleInit is called.

One situation where dynamically obtaining modules is useful is in creating a library of common code shared by multiple modules. You could create a component of type module, expose one or more interfaces on its main class, and allow other modules in other plugins to use it.

Another situation where this is useful is in creating a service/vendor type of model. A component of type service could be developed that calls into one or more vendors to do the work where each vendor is abstracted by the same interface. Each vendor, implemented as a separate component of type module, would implement an interface exposed publicly by the service module. After a vendor's ModuleInit method is called (not before—see above), it would call into the service to register itself.

Requirements

Namespace: ActionEngine.Api

Assembly: aefwapi (in aefwapi.dll)

See Also

PluginEnvironment Members|ActionEngine.Api Namespace

API Class Library

PluginEnvironment Members

PluginEnvironment overview

| | |
|---|---|
| Public Static Methods | |
| GetInstance | This returns an instance of the class. |
| GetModules | Overloaded. This returns all running |
| | modules in the process. |
| Public Static Events | |
| DieEvents | This event is fired when it's time to |
| | shut down the module. |
| Public Instance Properties | |
| ComponentId | This returns the fully-qualified |
| | component ID of the module as |
| | defined in the plugin's install.xml file. |
| ConfigFile | This returns the plugin's |
| | configuration file. |
| HomeDirectory | This returns the plugin's home |
| | directory, including the terminating |
| | backslash. |
| PluginId | This returns the plugin ID as defined in |
| | the plugin's install.xml file. |
| Public Instance Methods | |
| Equals (inherited from Object) | Determines whether the specified |
| | Object is equal to the current Object. |
| GetHashCode | Serves as a hash function for |
| | a particular type, |
| (inherited from Object) | suitable for use in hashing algorithms |
| | and data structures like a hash |
| | table. |
| GetType (inherited from Object) | Gets the Type of the current instance. |
| ToString (inherited from Object) | Returns a String that represents the |
| | current Object. |
| Protected Instance Methods | |
| Finalize (inherited from Object) | Allows an Object to attempt to free |
| | resources and perform other cleanup |
| | operations before the Object is |
| | reclaimed by garbage collection. |
| MemberwiseClone | Creates a shallow copy of the |
| (inherited from Object) | current Object. |

See Also

PluginEnvironment Class|ActionEngine.Api Namespace

API Class Library

PluginEnvironment Properties

The properties of the PluginEnvironment class are listed below. For a complete list of PluginEnvironment class members, see the PluginEnvironment Members topic.

Public Instance Properties

| | |
|---|---|
| ComponentId | This returns the fully-qualified component |
| | ID of the module as defined in the |
| | plugin's install.xml file. |
| ConfigFile | This returns the plugin's configuration file. |
| HomeDirectory | This returns the plugin's home directory, |
| | including the terminating backslash. |
| PluginId | This returns the plugin ID as defined in the |
| | plugin's install.xml file. |

See Also

PluginEnvironment Class|ActionEngine.Api Namespace

API Class Library

PluginEnvironment.ComponentId Property

This returns the fully-qualified component ID of the module as defined in the plugin's install.xml file.

public string ComponentId {get;}

See Also

PluginEnvironment Class|ActionEngine.Api Namespace

API Class Library

PluginEnvironment.ConfigFile Property

This returns the plugin's configuration file.

public ConfigFile ConfigFile {get;}

Remarks

This returns the plugin's configuration file. A non-null object is returned regardless of a physical config file existing. See Exists.

See Also

PluginEnvironment Class|ActionEngine.Api Namespace

API Class Library

PluginEnvironment.HomeDirectory Property

This returns the plugin's home directory, including the terminating backslash.

public string HomeDirectory {get;}

Remarks

This returns the plugin's home directory, including the terminating backslash. For example, a plugin called “widget” might have a home directory called C:\aeserver\plugins\widget\.

See Also

PluginEnvironment Class|ActionEngine.Api Namespace

API Class Library

PluginEnvironment.PluginId Property

This returns the plugin ID as defined in the plugin's install.xml file.

public string PluginId {get;}

See Also

PluginEnvironment Class|ActionEngine.Api Namespace

API Class Library

PluginEnvironment Methods

The methods of the PluginEnvironment class are listed below. For a complete list of PluginEnvironment class members, see the PluginEnvironment Members topic.

| | |
|---|---|
| Public Static Methods | |
| GetInstance | This returns an instance of the class. |
| GetModules | Overloaded. This returns all running |
| | modules in the process. |
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use |
| | in hashing algorithms and data |
| | structures like a hash table. |
| GetType (inherited from Object) | Gets the Type of the current instance. |
| ToString (inherited from Object) | Returns a String that represents the |
| | current Object. |
| Protected Instance Methods | |
| Finalize (inherited from Object) | Allows an Object to attempt to free |
| | resources and perform other cleanup |
| | operations before the Object is |
| | reclaimed by garbage collection. |
| MemberwiseClone | Creates a shallow copy of the current |
| (inherited from Object) | Object. |

See Also

PluginEnvironment Class|ActionEngine.Api Namespace

API Class Library

PluginEnvironment.GetInstance Method

This returns an instance of the class.

public static PluginEnvironment GetInstance(

IModule module

);

Parameters

module

The module.

Return Value

An instance of the class.

See Also

PluginEnvironment Class|ActionEngine.Api Namespace

API Class Library

PluginEnvironment.GetModules Method

This returns all running modules in the process.

Overload List

This returns all running modules in the process.

public static IModule [symbol] GetModules( );

This returns all running modules in the process filtered by namespace (optional) and interface name (optional).

public static IModule [symbol] GetModules(string,Type);

See Also

PluginEnvironment Class|ActionEngine.Api Namespace

API Class Library

PluginEnvironment.GetModules Method( )

This returns all running modules in the process.

public static IModule [symbol] GetModules( );

Return Value

An array of IModule, potentially zero in length but never null.

Remarks

This returns all running modules in the process. See the class overview for more information.

See Also

PluginEnvironment Class|ActionEngine.Api Namespace|PluginEnvironment.GetModules Overload List

API Class Library

PluginEnvironment.GetModules Method (String, Type)

This returns all running modules in the process filtered by namespace (optional) and interface name (optional).

public static IModule [symbol] GetModules(

string namespace,

Type interface

);

Parameters

namespace

The namespace to search for the modules, or null to consider all namespaces. Note that this represents the namespace of the modules being searched, not of the interface.

interface

The desired interface, or null for all interfaces.

Return Value

An array of IModule, potentially zero in length but never null.

Remarks

This returns all running modules in the process filtered by namespace (optional) and interface name (optional). The namespace is a .NET namespace, not to be confused with the framework's user and resource namespaces. See the class overview for more information.

In this C# example, all modules that exist in the MyCompany.Util namespace are returned that support ISomeInterface. IModule [symbol] modules=PluginEnvironment.GetModules( “MyCompany. Util”, typeof(ISomeInterface));

See Also

PluginEnvironment Class|ActionEngine.Api Namespace|PluginEnvironment.GetModules Overload List

API Class Library

PluginEnvironment Events

The events of the PluginEnvironment class are listed below. For a complete list of PluginEnvironment class members, see the PluginEnvironment Members topic.

Public Static Events

| | |
|---|---|
| DieEvents | This event is fired when it's time to shut down the |
| | module. |

See Also

PluginEnvironment Class|ActionEngine.Api Namespace

API Class Library

PluginEnvironment.DieEvents Event

This event is fired when it's time to shut down the module.

public static event DieHandler DieEvents;

Remarks

This event is fired when it's time to shut down the module. This is useful if your module has any background threads that need to be told to die to enable graceful shutdown.

See Also

PluginEnvironment Class|ActionEngine.Api Namespace

API Class Library

RequestProcessor Class

This class is for internal use only.

For a list of all members of this type, see RequestProcessor Members.

System.Object

RequestProcessor

public abstract class RequestProcessor

Requirements

Namespace: ActionEngine.Api

Assembly: aefwapi (in aefwapi.dll)

See Also

RequestProcessor Members|ActionEngine.Api Namespace

API Class Library

RequestProcessor Members

RequestProcessor overview

| | |
|---|---|
| Public Static Methods | |
| Die | This is for internal use only. |
| FlushCaches | This is for internal use only. |
| Process | This is for internal use only. |
| Start | This is for internal use only. |
| Public Instance Methods | |
| Equals | Determines whether the specified |
| (inherited from Object) | Object is equal to the current Object. |
| GetHashCode | Serves as a hash function for a |
| (inherited from Object) | particular type, suitable for use |
| | in hashing algorithms and data |
| | structures like a hash table. |
| GetType (inherited from Object) | Gets the Type of the current instance. |
| ToString (inherited from Object) | Returns a String that represents the |
| | current Object. |
| Protected Instance Constructors | |
| RequestProcessor Constructor | |
| Protected Instance Methods | |
| Finalize (inherited from Object) | Allows an Object to attempt to free |
| | resources and perform other cleanup |
| | operations before the Object is |
| | reclaimed by garbage collection. |
| MemberwiseClone | Creates a shallow copy of the current |
| (inherited from Object) | Object. |

See Also

RequestProcessor Class|ActionEngine.Api Namespace

API Class Library

RequestProcessor Constructor

protected RequestProcessor( );

See Also

RequestProcessor Class|ActionEngine.Api Namespace

API Class Library

RequestProcessor Methods

The methods of the RequestProcessor class are listed below. For a complete list of RequestProcessor class members, see the RequestProcessor Members topic.

| | |
|---|---|
| Public Static Methods | |
| Die | This is for internal use only. |
| FlushCaches | This is for internal use only. |
| Process | This is for internal use only. |
| Start | This is for internal use only. |
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use in |
| | hashing algorithms and data |
| | structures like a hash table. |
| GetType (inherited from Object) | Gets the Type of the current instance. |
| ToString (inherited from Object) | Returns a String that represents the |
| | current Object. |
| Protected Instance Methods | |
| Finalize (inherited from Object) | Allows an Object to attempt to free |
| | resources and perform other cleanup |
| | operations before the Object is |
| | reclaimed by garbage collection. |
| MemberwiseClone | Creates a shallow copy of the current |
| (inherited from Object) | Object. |

See Also

RequestProcessor Class|ActionEngine.Api Namespace

API Class Library

RequestProcessor.Die Method

This is for internal use only.

public static void Die( );

See Also

RequestProcessor Class|ActionEngine.Api Namespace

API Class Library

RequestProcessor.FlushCaches Method

This is for internal use only.

public static void FlushCaches( );

See Also

RequestProcessor Class|ActionEngine.Api Namespace

API Class Library

RequestProcessor.Process Method

This is for internal use only.

public static string Process(

int componentType,

string assemblyPath,

string className,

string request

);

See Also

RequestProcessor Class|ActionEngine.Api Namespace

API Class Library

RequestProcessor.Start Method

This is for internal use only.

public static void Start( );

See Also

RequestProcessor Class|ActionEngine.Api Namespace

API Class Library

Resource Class

This is the base class for all types of resources.

For a list of all members of this type, see Resource Members.

System.Object

Resource

public abstract class Resource

Requirements

Namespace: ActionEngine.Api

Assembly: aefwapi (in aefwapi.dll)

See Also

Resource Members|ActionEngine.Api Namespace|ResourcesResponse

API Class Library

Resource Members

Resource overview

| | |
|---|---|
| Public Instance Methods | |
| Equals (inherited from Object) | Determines whether the specified |
| | Object is equal to the current Object. |
| GetHashCode | Serves as a hash function for a |
| (inherited from Object) | particular type, suitable for use in |
| | hashing algorithms and data |
| | structures like a hash table. |
| GetType (inherited from Object) | Gets the Type of the current instance. |
| ToString | This returns an XML representation of |
| Protected Instance Methods | the resource. |
| Finalize (inherited from Object) | Allows an Object to attempt to free |
| | resources and perform other cleanup |
| | operations before the Object |
| | is reclaimed by garbage collection. |
| MemberwiseClone | Creates a shallow copy of the current |
| (inherited from Object) | Object. |

See Also

Resource Class|ActionEngine.Api Namespace|ResourcesResponse

API Class Library

Resource Methods

The methods of the Resource class are listed below. For a complete list of Resource class members, see the Resource Members topic.

| | |
|---|---|
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString | This returns an XML representation of the resource. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Resource Class|ActionEngine.Api Namespace|ResourcesResponse

API Class Library

Resource.ToString Method

This returns an XML representation of the resource.

public override string ToString( );

Return Value

An XML representation of the resource.

See Also

Resource Class|ActionEngine.Api Namespace

API Class Library

Resource.Type Enumeration

The enumeration of valid resource types.

public enum Resource.Type

Members

| Member Name | Description |
|---|---|
| Binary | An binary resource. |
| Image | An image (graphic) resource. |

Requirements

Namespace: ActionEngine.Api

Assembly: aefwapi (in aefwapi.dll)

See Also

ActionEngine.Api Namespace

API Class Library

ResourceReference Class

This class represents a resource reference, which is a description or “pointer” to an actual resource.

For a list of all members of this type, see ResourceReference Members.

System.Object

ResourceReference

public class ResourceReference

Remarks

This class represents a resource reference, which is a description or “pointer” to an actual resource. References are created by the service and added to the result returned to the engine. Later, when the engine calls GetResources, one or more resource references are passed as an argument.

Requirements

Namespace: ActionEngine.Api

Assembly: aefwapi (in aefwapi.dll)

See Also

ResourceReference Members|ActionEngine.Api Namespace

API Class Library

ResourceReference Members

ResourceReference overview

| | |
|---|---|
| Public Instance Constructors | |
| ResourceReference Constructor | This constructs a resource reference. |
| Public Instance Properties | |
| Cookie | The cookie associated with the GetResources |
| | protocol. |
| Id | The resource ID, chosen by the service. |
| Type | The type of resource. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ResourceReference Class|ActionEngine.Api Namespace

API Class Library

ResourceReference Constructor

This constructs a resource reference.

public ResourceReference(

Type type,

string id,

Priority fetchPriority,

Protocol protocol,

string protocolData

);

Parameters

type

The resource type.

id

The resource ID, chosen by the service.

fetchPriority

The engine's priority for fetching the resource.

protocol

The protocol for fetching the resource.

protocolData

The data associated with the protocol. If HttpGet, this is the URL that the engine follows. If GetResources, this is a cookie (optional, can be null) that the engine eventually passes back to the service when calling GetResources.

Exceptions

| Exception Type | Condition |
|---|---|
| ArgumentException | This is thrown when the protocol data is invalid. |

See Also

ResourceReference Class|ActionEngine.Api Namespace

API Class Library

ResourceReference Properties

The properties of the ResourceReference class are listed below. For a complete list of ResourceReference class members, see the ResourceReference Members topic.

Public Instance Properties

| | |
|---|---|
| Cookie | The cookie associated with the GetResources |
| | protocol. |
| Id | The resource ID, chosen by the service. |
| Type | The type of resource. |

See Also

ResourceReference Class|ActionEngine.Api Namespace

API Class Library

ResourceReference.Cookie Property

The cookie associated with the GetResources protocol.

public string Cookie {get;}

Remarks

The cookie associated with the GetResources protocol. When a cookie is provided in a resource reference in a result returned to the engine, the engine passes it back when calling GetResources.

See Also

ResourceReference Class|ActionEngine.Api Namespace

API Class Library

ResourceReference.Id Property

The resource ID, chosen by the service.

public string Id {get;}

See Also

ResourceReference Class|ActionEngine.Api Namespace

API Class Library

ResourceReference.Type Property

The type of resource.

public Resource.Type Type {get;}

See Also

ResourceReference Class|ActionEngine.Api Namespace

API Class Library

ResourceReference.Priority Enumeration

The enumeration of resource fetching priorities.

public enum ResourceReference.Priority

Remarks

The enumeration of resource fetching priorities. When a resource reference is included in a result returned to the engine, the priority determines when the engine will fetch the actual resource. If ClientDriven, the resource is not fetched until the client makes a request for it. All other priorities, however, cause the engine to initiate resource fetching in the background. Then, when the client needs the resource, it will often be pre-fetched in the engine's cache resulting in better performance for the end user.

The only difference between Low, Medium, and High is that the order in which resources are fetched and cached is done from highest to lowest.

Members

| Member Name | Description |
|---|---|
| ClientDriven | The client initiates the fetching of the resource. |
| Low | The engine pre-fetches the resource with a low |
| | priority. |
| Medium | The engine pre-fetches the resource with a medium |
| | priority. |
| High | The engine pre-fetches the resource with a high |
| | priority. |

Requirements

Namespace: ActionEngine.Api

Assembly: aefwapi (in aefwapi.dll)

See Also

ActionEngine.Api Namespace

API Class Library

ResourceReference. Protocol Enumeration

The enumeration of resource fetching protocols.

public enum ResourceReference.Protocol

Members

| Member Name | Description |
|---|---|
| GetResources | The engine calls GetResources to retrieve the |
| | resource. |
| HttpGet | The engine performs and HTTP “get” to retrieve the |
| | resource. |

Requirements

Namespace: ActionEngine.Api

Assembly: aefwapi (in aefwapi.dll)

See Also

ActionEngine.Api Namespace

API Class Library

ResourcesResponse Class

This class represents a response of zero or more resources.

For a list of all members of this type, see ResourcesResponse Members.

System.Object

Response

ResourcesResponse

public class ResourcesResponse: Response

Remarks

This class represents a response of zero or more resources. It is used in reply to GetResources.

Requirements

Namespace: ActionEngine.Api

Assembly: aefwapi (in aefwapi.dll)

See Also

ResourcesResponse Members|ActionEngine.Api Namespace

API Class Library

ResourcesResponse Members

ResourcesResponse overview

| | |
|---|---|
| Public Instance Constructors | |
| ResourcesResponse | Overloaded. Initializes a new instance of the |
| | ResourcesResponse class. |
| Public Instance Methods | |
| AppendResource | This appends a resource to the current list. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Response) | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ResourcesResponse Class|ActionEngine.Api Namespace

API Class Library

ResourcesResponse Constructor

This constructs an empty resources response.

Overload List

This constructs an empty resources response.

public ResourcesResponse( );

This constructs a response with one resource.

public ResourcesResponse(Resource);

This constructs a resources response using the given resources.

public ResourcesResponse(Resource [symbol] );

See Also

ResourcesResponse Class|ActionEngine.Api Namespace

API Class Library

ResourcesResponse Constructor( )

This constructs an empty resources response.

public ResourcesResponse( );

See Also

ResourcesResponse Class|ActionEngine.Api Namespace|ResourcesResponse Constructor Overload List

API Class Library

ResourcesResponse Constructor (Resource)

This constructs a response with one resource.

public ResourcesResponse(

Resource resource

);

Parameters

resource

The resource. If null, an empty resources response is constructed.

See Also

ResourcesResponse Class|ActionEngine.Api Namespace|ResourcesResponse Constructor Overload List

API Class Library

ResourcesResponse Constructor (Resource [symbol] )

This constructs a resources response using the given resources.

public ResourcesResponse(

Resource [symbol] resources

);

Parameters

resources

The resources, which cannot be null.

See Also

ResourcesResponse Class|ActionEngine.Api Namespace|ResourcesResponse Constructor Overload List

API Class Library

ResourcesResponse Methods

The methods of the ResourcesResponse class are listed below. For a complete list of ResourcesResponse class members, see the ResourcesResponse Members topic.

| | |
|---|---|
| Public Instance Methods | |
| AppendResource | This appends a resource to the current list. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Response) | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ResourcesResponse Class|ActionEngine.Api Namespace

API Class Library

ResourcesResponse.AppendResource Method

This appends a resource to the current list.

public void AppendResource(

Resource resource

);

Parameters

resource

The resource, which cannot be null.

See Also

ResourcesResponse Class|ActionEngine.Api Namespace

API Class Library

Response Class

This is the base class for various responses sent to the engine.

For a list of all members of this type, see Response Members.

System.Object

Response

public abstract class Response

Requirements

Namespace: ActionEngine.Api

Assembly: aefwapi (in aefwapi.dll)

See Also

Response Members|ActionEngine.Api Namespace

API Class Library

Response Members

Response overview

| | |
|---|---|
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Response Class|ActionEngine.Api Namespace

API Class Library

Response Methods

The methods of the Response class are listed below. For a complete list of Response class members, see the Response Members topic.

| | |
|---|---|
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Response Class|ActionEngine.Api Namespace

API Class Library

Response.ToString Method

This returns an XML representation of the response.

public override string ToString( );

Return Value

An XML representation of the response.

See Also

Response Class|ActionEngine.Api Namespace

API Class Library

Result Class

This class represents a result for managing state in your plugin as well as providing input to various XSLT transformations.

For a list of all members of this type, see Result Members.

System.Object

Result

public class Result

Remarks

This class represents a result for managing state in your plugin as well as providing input to various XSLT transformations. The contents of the document can have any structure you want with two exceptions:

1. A child element of the root called fw is reserved for use by the framework.

2. Child elements of the root called rsc are reserved for describing resource references.

Requirements

Namespace: ActionEngine.Api

Assembly: aefwapi (in aefwapi.dll)

See Also

Result Members|ActionEngine.Api Namespace|AnswersResponse|ConceptsResponse

API Class Library

Result Members

Result overview

| | |
|---|---|
| Public Static Fields | |
| ROOT_NAME | The name of the root element for any result XML. |
| Public Instance Constructors | |
| Result | Overloaded. Initializes a new instance of the Result |
| | class. |
| Public Instance Properties | |
| RootElement | This represents the root element of the result XML. |
| Public Instance Methods | |
| AppendResourceReference | This appends a resource reference to the result. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString | This returns a string representation of the result |
| | XML. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Result Class|ActionEngine.Api Namespace|AnswersResponse|ConceptsResponse

API Class Library

Result Constructor

This constructs an empty result.

Overload List

This constructs an empty result.

public Result( );

This constructs a result from the given XML.

public Result(string);

This constructs a result from the given XML.

public Result(XmlElement);

See Also

Result Class|ActionEngine.Api Namespace

API Class Library

Result Constructor( )

This constructs an empty result.

public Result( );

See Also

Result Class|ActionEngine.Api Namespace|Result Constructor Overload List

API Class Library

Result Constructor (String)

This constructs a result from the given XML.

public Result(

string xml

);

Parameters

xml

The result XML, or null for an empty result.

Remarks

This constructs a result from the given XML. The name of the root element must be ROOT_NAME.

Exceptions

| Exception Type | Condition |
|---|---|
| ApplicationException | This is thrown when the name of the root element |
| | is not ROOT_NAME. |
| XmlException | This is thrown when a load or parse error occurs. |

See Also

Result Class|ActionEngine.Api Namespace|Result Constructor Overload List

API Class Library

Result Constructor (XmlElement)

This constructs a result from the given XML.

public Result(

XmlElement root

);

Parameters

root

The root element of the result.

Remarks

This constructs a result from the given XML. The name of the root element must be ROOT_NAME.

Exceptions

| Exception Type | Condition |
|---|---|
| ApplicationException | This is thrown when the name of the root element |
| | is not ROOT_NAME. |

See Also

Result Class|ActionEngine.Api Namespace|Result Constructor Overload List

API Class Library

Result Fields

The fields of the Result class are listed below. For a complete list of Result class members, see the Result Members topic.

Public Static Fields

| | |
|---|---|
| ROOT_NAME | The name of the root element for any result XML. |

See Also

Result Class|ActionEngine.Api Namespace|AnswersResponse|ConceptsResponse

API Class Library

Result.ROOT_NAME Field

The name of the root element for any result XML.

public const string ROOT_NAME;

See Also

Result Class|ActionEngine.Api Namespace

API Class Library

Result Properties

The properties of the Result class are listed below. For a complete list of Result class members, see the Result Members topic.

Public Instance Properties

| | |
|---|---|
| RootElement | This represents the root element of the result XML. |

See Also

Result Class|ActionEngine.Api Namespace|AnswersResponse|ConceptsResponse

API Class Library

Result.RootElement Property

This represents the root element of the result XML.

public System.Xml.XmlElement RootElement {get; set;}

Remarks

This represents the root element of the result XML. Null is never allowed or returned. The name of the root element must be ROOT_NAME.

Exceptions

| Exception Type | Condition |
|---|---|
| ApplicationException | This is thrown when the root element name |
| | doesn't match ROOT_NAME. |

See Also

Result Class|ActionEngine.Api Namespace

API Class Library

Result Methods

The methods of the Result class are listed below. For a complete list of Result class members, see the Result Members topic.

| | |
|---|---|
| Public Instance Methods | |
| AppendResourceReference | This appends a resource reference to the result. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString | This returns a string representation of the result |
| | XML. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Result Class|ActionEngine.Api Namespace|AnswersResponse|ConceptsResponse

API Class Library

Result.AppendResourceReference Method

This appends a resource reference to the result.

public void AppendResourceReference(

ResourceReference resourceReference

);

Parameters

resourceReference

The resource reference.

See Also

Result Class|ActionEngine.Api Namespace

API Class Library

Result.ToString Method

This returns a string representation of the result XML.

public override string ToString( );

Return Value

A string representation of the result XML.

See Also

Result Class|ActionEngine.Api Namespace

API Class Library

SupportedAuthDataResponse Class

This class represents the categories of data supported by the authentication plugin.

For a list of all members of this type, see SupportedAuthDataResponse Members.

System.Object

Response

SupportedAuthDataResponse

public class SupportedAuthDataResponse: Response

Remarks

This class represents the categories of data supported by the authentication plugin. When a plugin declares a certain category to be supported (or “owned”), the framework delegates management of that data category to the plugin instead of managing the data itself. For example, if a plugin supports the Identity category, the framework will periodically call the plugin to retrieve a user's identity or to modify one or more aspects of it (such as a person's last name).

Requirements

Namespace: ActionEngine.Api

Assembly: aefwapi (in aefwapi.dll)

See Also

SupportedAuthDataResponse Members|ActionEngine.Api Namespace

API Class Library

SupportedAuthDataResponse Members

SupportedAuthDataResponse overview

| | |
|---|---|
| Public Instance Constructors | |
| SupportedAuthDataResponse Constructor | This constructs a response based on the given |
| | data. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Response) | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

SupportedAuthDataResponse Class|ActionEngine.Api Namespace

API Class Library

SupportedAuthDataResponse Constructor

This constructs a response based on the given data.

public SupportedAuthDataResponse(

Data supported

);

Parameters

supported

The supported data. To support more than one category, “or” them together.

See Also

SupportedAuthDataResponse Class|ActionEngine.Api Namespace

API Class Library

SupportedAuthDataResponse.Data Enumeration

The enumeration of valid data categories.

public enum SupportedAuthDataResponse.Data

Members

| Member Name | Description |
|---|---|
| AddressesAndCards | Addresses and credit cards are supported. The two |
| | categories are linked because credit cards depend |
| | on addresses. |
| Emails | E-mail addresses are supported. |
| Identity | Identities (peoples' names) are supported. |
| LogOn | Whenever a user requires authentication, LogOn is |
| | called regardless of your support for Password. In |
| | the case of supporting LogOn but not Password, |
| | the framework calls your LogOn method, then |
| | authenticates the password itself. Supporting both |
| | LogOn and Password is equivalent to just |
| | supporting Password. |
| Password | Password management is supported. |
| Phones | Phone numbers are supported. |
| SignupConcepts | Custom sign-up concepts are supported. |
| SilentSignup | The process of silently signing up is supported. |

Requirements

Namespace: ActionEngine.Api

Assembly: aefwapi (in aefwapi.dll)

See Also

ActionEngine.Api Namespace

API Class Library

ThreadStorage Class

This class manages framework-related storage for the current thread, and provides a way to spawn new threads while passing along the parent's thread storage.

For a list of all members of this type, see ThreadStorage Members.

System.Object

ThreadStorage

public class ThreadStorage

Remarks

This class manages framework-related storage for the current thread, and provides a way to spawn new threads while passing along the parent's thread storage.

Because thread-local storage is used by the framework, IT IS CRITICAL that your plugin calls CreateThread to create all new threads. Otherwise, any threads you spawn on your own won't have storage that's needed by the framework, such as trace information.

Requirements

Namespace: ActionEngine.Api

Assembly: aefwapi (in aefwapi.dll)

See Also

ThreadStorage Members|ActionEngine.Api Namespace|Tracer

API Class Library

ThreadStorage Members

ThreadStorage overview

| | |
|---|---|
| Public Static Methods | |
| CreateThread | This creates and starts a Thread using the given |
| | delegate. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ThreadStorage Class|ActionEngine.Api Namespace|Tracer

API Class Library

ThreadStorage Methods

The methods of the ThreadStorage class are listed below. For a complete list of ThreadStorage class members, see the ThreadStorage Members topic.

| | |
|---|---|
| Public Static Methods | |
| CreateThread | This creates and starts a Thread using the given |
| | delegate. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

ThreadStorage Class|ActionEngine.Api Namespace|Tracer

API Class Library

ThreadStorage.CreateThread Method

This creates and starts a Thread using the given delegate.

public static Thread CreateThread(

ThreadStart start

);

Parameters

start

The method that executes on the new thread.

Return Value

The new running thread.

Remarks

This creates and starts a Thread using the given delegate. The new thread's local storage is set up based on the parent's thread storage, and the running thread is returned.

See Also

ThreadStorage Class|ActionEngine.Api Namespace

API Class Library

Tracer Class

This class is used to add trace information to the response sent to the engine.

For a list of all members of this type, see Tracer Members.

System.Object

Tracer

public abstract class Tracer

Remarks

This class is used to add trace information to the response sent to the engine. The engine then places the trace information in a trace queue, and in some environments the queue is dumped into a database where the administration web site allows browsing of the data.

When you make calls to trace, the information is added to thread-local storage until a reply is sent to the engine. Because thread-local storage is used, and because there is nothing stopping you from spawning your own threads, IT IS CRITICAL that you use the ThreadStorage class to create all new threads you need to use. Otherwise, any threads you spawn will not retain trace information.

Requirements

Namespace: ActionEngine.Api

Assembly: aefwapi (in aefwapi.dll)

See Also

Tracer Members|ActionEngine.Api Namespace|ThreadStorage

API Class Library

Tracer Members

Tracer overview

| | |
|---|---|
| Public Static Properties | |
| WriteDirect | This affects whether individual traces accumulate in |
| | a buffer, or if each trace is written directly to the |
| | trace queue. |
| Public Static Methods | |
| Trace | Overloaded. This traces the given information. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Constructors | |
| Tracer Constructor | |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Tracer Class|ActionEngine.Api Namespace|ThreadStorage

API Class Library

Tracer Constructor

protected Tracer( );

See Also

Tracer Class|ActionEngine.Api Namespace

API Class Library

Tracer Properties

The properties of the Tracer class are listed below. For a complete list of Tracer class members, see the Tracer Members topic.

Public Static Properties

| | |
|---|---|
| WriteDirect | This affects whether individual traces accumulate in |
| | a buffer, or if each trace is written directly to the |
| | trace queue. |

See Also

Tracer Class|ActionEngine.Api Namespace|ThreadStorage

API Class Library

Tracer.WriteDirect Property

This affects whether individual traces accumulate in a buffer, or if each trace is written directly to the trace queue.

public static bool WriteDirect {get; set;}

Remarks

In general, plugins will not need to set this value. By default, most commands that a plugin processes come from the engine in which case using buffered tracing is highly desired to enable trace “squeezing” in the engine when a successful transaction occurs.

However, there are times when writing directly to the trace queue is desired. If your plugin spawns a long-running background thread unrelated to a user-initiated command, setting WriteDirect to true *in that thread* will ensure any tracing done by that thread will write directly to the trace queue.

Note that this setting affects thread local storage and is therefore inherited by child threads when calling ThreadStorage.CreateThread.

See Also

Tracer Class|ActionEngine.Api Namespace

API Class Library

Tracer Methods

The methods of the Tracer class are listed below. For a complete list of Tracer class members, see the Tracer Members topic.

| | |
|---|---|
| Public Static Methods | |
| Trace | Overloaded. This traces the given information. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Tracer Class|ActionEngine.Api Namespace ThreadStorage

API Class Library

Tracer.Trace Method

This traces the given information.

Overload List

This traces the given information.

public static void Trace(object,Level,string);

This traces the given information.

public static void Trace(object,Exception);

This traces the given information.

public static void Trace(string,Level,string);

This traces the given information.

public static void Trace(string,Exception);

See Also

Tracer Class|ActionEngine.Api Namespace

API Class Library

Tracer.Trace Method (Object, Level, String)

This traces the given information.

public static void Trace(

object module,

Level level,

string message

);

Parameters

module

The module doing the tracing.

level

The level assigned to the trace message.

message

The message to trace.

See Also

Tracer Class|ActionEngine.Api Namespace Tracer.Trace Overload List

API Class Library

Tracer.Trace Method (Object, Exception)

This traces the given information.

public static void Trace(

object module,

Exception exception

);

Parameters

module

The module doing the tracing.

exception

The exception to trace.

See Also

Tracer Class|ActionEngine.Api Namespace|Tracer.Trace Overload List

API Class Library

Tracer.Trace Method (String, Level, String)

This traces the given information.

public static void Trace(

string moduleName,

Level level,

string message

);

Parameters

moduleName

The name of the module doing the tracing.

level

The level assigned to the trace message.

message

The message to trace.

See Also

Tracer Class|ActionEngine.Api Namespace|Tracer.Trace Overload List

API Class Library

Tracer.Trace Method (String, Exception)

This traces the given information.

public static void Trace(

string moduleName,

Exception exception

);

Parameters

moduleName

The name of the module doing the tracing.

exception

The exception to trace.

See Also

Tracer Class|ActionEngine.Api Namespace|Tracer.Trace Overload List

API Class Library

Tracer.Level Enumeration

The enumeration of valid trace levels.

public enum Tracer.Level

Members

| Member Name | Description |
|---|---|
| Debug | Debug information. |
| Error | Error information. |
| Misc | Miscellaneous information. |
| Perf | Performance-related information, such as an |
| | activity taking an unusually long time. |
| Warning | Warning information. |

Requirements

Namespace: ActionEngine.Api

Assembly: aefwapi (in aefwapi.dll)

See Also

ActionEngine.Api Namespace

API Class Library

User Class

This class represents an end user of the framework.

For a list of all members of this type, see User Members.

System.Object

User

public class User

Requirements

Namespace: ActionEngine.Api

Assembly: aefwapi (in aefwapi.dll)

See Also

User Members|ActionEngine.Api Namespace

API Class Library

User Members

User overview

| | |
|---|---|
| Public Instance Properties | |
| Addresses | The user's addresses. |
| CreditCards | The user's credit cards. |
| Devices | The user's client devices. |
| Emails | The user's e-mail addresses. |
| Handle | A time-sensitive handle. |
| Identity | The user's identity (first name, last name, etc.). |
| Password | The user's password. |
| Phones | The user's phone numbers. |
| UserName | The user's user name. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

User Class|ActionEngine.Api Namespace

API Class Library

User Properties

The properties of the User class are listed below. For a complete list of User class members, see the User Members topic.

Public Instance Properties

| | |
|---|---|
| Addresses | The user's addresses. |
| CreditCards | The user's credit cards. |
| Devices | The user's client devices. |
| Emails | The user's e-mail addresses. |
| Handle | A time-sensitive handle. |
| Identity | The user's identity (first name, last name, etc.). |
| Password | The user's password. |
| Phones | The user's phone numbers. |
| UserName | The user's user name. |

See Also

User Class|ActionEngine.Api Namespace

API Class Library

User.Addresses Property

The user's addresses.

public Addresses Addresses {get;}

Remarks

This is never null.

See Also

User Class|ActionEngine.Api Namespace

API Class Library

User.CreditCards Property

The user's credit cards.

public CreditCards CreditCards {get;}

Remarks

This is never null.

See Also

User Class|ActionEngine.Api Namespace

API Class Library

User.Devices Property

The user's client devices.

public Devices Devices {get;}

Remarks

This is never null.

See Also

User Class|ActionEngine.Api Namespace

API Class Library

User.Emails Property

The user's e-mail addresses.

public Emails Emails {get;}

Remarks

This is never null.

See Also

User Class|ActionEngine.Api Namespace

API Class Library

User.Handle Property

A time-sensitive handle.

public string Handle {get;}

See Also

User Class|ActionEngine.Api Namespace

API Class Library

User.Identity Property

The user's identity (first name, last name, etc.).

public Identity Identity {get;}

Remarks

This is never null.

See Also

User Class|ActionEngine.Api Namespace

API Class Library

User.Password Property

The user's password.

public string Password {get;}

Remarks

The password is null when not provided by the framework.

See Also

User Class|ActionEngine.Api Namespace

API Class Library

User.Phones Property

The user's phone numbers.

public Phones Phones {get;}

Remarks

This is never null.

See Also

User Class|ActionEngine.Api Namespace

API Class Library

User.UserName Property

The user's user name.

public UserName UserName {get;}

Remarks

This is never null.

See Also

User Class|ActionEngine.Api Namespace

API Class Library

UserDataResponse Class

This class represents a user data response.

For a list of all members of this type, see UserDataResponse Members.

System.Object

Response

UserDataResponse

public class UserDataResponse: Response

Remarks

This class represents a user data response. By default, all properties on this class are set to null.

Requirements

Namespace: ActionEngine.Api

Assembly: aefwapi (in aefwapi.dll)

See Also

UserDataResponse Members|ActionEngine.Api Namespace|GetUserData

API Class Library

UserDataResponse Members

UserDataResponse overview

| | |
|---|---|
| Public Instance Constructors | |
| UserDataResponse Constructor | This constructs and empty user data response. |
| Public Instance Properties | |
| Addresses | The user's addresses. |
| CreditCards | The user's credit cards. |
| Emails | The user's e-mail addresses. |
| Identity | The user's identity. |
| Phones | The user's phone entries. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Response) | This returns an XML representation of the |
| | response. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

UserDataResponse Class|ActionEngine.Api Namespace|GetUserData

API Class Library

UserDataResponse Constructor

This constructs and empty user data response.

public UserDataResponse( );

See Also

UserDataResponse Class|ActionEngine.Api Namespace

API Class Library

UserDataResponse Properties

The properties of the UserDataResponse class are listed below. For a complete list of UserDataResponse class members, see the UserDataResponse Members topic.

Public Instance Properties

| | |
|---|---|
| Addresses | The user's addresses. |
| CreditCards | The user's credit cards. |
| Emails | The user's e-mail addresses. |
| Identity | The user's identity. |
| Phones | The user's phone entries. |

See Also

UserDataResponse Class|ActionEngine.Api Namespace|GetUserData

API Class Library

UserDataResponse.Addresses Property

The user's addresses.

public Addresses Addresses {get; set;}

Remarks

The user's addresses. Can be null.

See Also

UserDataResponse Class|ActionEngine.Api Namespace

API Class Library

UserDataResponse.CreditCards Property

The user's credit cards.

public CreditCards CreditCards {get; set;}

Remarks

The user's credit cards. Can be null.

See Also

UserDataResponse Class|ActionEngine.Api Namespace

API Class Library

UserDataResponse.Emails Property

The user's e-mail addresses.

public Emails Emails {get; set;}

Remarks

The user's e-mail addresses. Can be null.

See Also

UserDataResponse Class|ActionEngine.Api Namespace

API Class Library

UserDataResponse.Identity Property

The user's identity.

public Identity Identity {get; set;}

Remarks

The user's identity. Can be null.

See Also

UserDataResponse Class|ActionEngine.Api Namespace

API Class Library

UserDataResponse.Phones Property

The user's phone entries.

public Phones Phones {get; set;}

Remarks

The user's phone entries. Can be null.

See Also

UserDataResponse Class|ActionEngine.Api Namespace

API Class Library

UserDocument Class

This class provides functionality for processing user documents.

For a list of all members of this type, see UserDocument Members.

System.Object

UserDocument

public abstract class UserDocument

Remarks

This class provides functionality for processing user documents. A user document is a string stored per user. Documents are referenced by a document ID and password.

For security reasons, documents cannot be created through this class. To create a document, use the administration web site to create a new document ID and password. Or, to automate the creation of documents at plugin install time, add one or more <userDoc>sections to install.xml as follows:

<install><userDoc id=“My Doc 1” password=“My Password 1”/><userDoc id=“My Doc 2” password=“My Password 2”/> . . . etc . . . </install>

Using the install.xml-based approach, when the plugin is installed, if a document with the given document ID already exists, no action is taken. If the document ID does not exist, it is created and assigned the given password.

Because user documents are defined solely by a document ID and password, they can be shared across plugins and namespaces.

Requirements

Namespace: ActionEngine.Api

Assembly: aefwapi (in aefwapi.dll)

See Also

UserDocument Members|ActionEngine.Api Namespace|UserDocumentException

API Class Library

UserDocument Members

UserDocument overview

| | |
|---|---|
| Public Static Methods | |
| DeleteDocument | This deletes a user document. |
| GetDocument | This retrievs a user document. |
| SetDocument | This sets a document for a user. |
| SetDocumentPassword | This sets the password for a document ID. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Constructors | |
| UserDocument Constructor | |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

UserDocument Class|ActionEngine.Api Namespace|UserDocumentException

API Class Library

UserDocument Constructor

protected UserDocument( );

See Also

UserDocument Class|ActionEngine.Api Namespace

API Class Library

UserDocument Methods

The methods of the UserDocument class are listed below. For a complete list of UserDocument class members, see the UserDocument Members topic.

| | |
|---|---|
| Public Static Methods | |
| DeleteDocument | This deletes a user document. |
| GetDocument | This retrievs a user document. |
| SetDocument | This sets a document for a user. |
| SetDocumentPassword | This sets the password for a document ID. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

UserDocument Class|ActionEngine.Api Namespace|UserDocumentException

API Class Library

UserDocument.DeleteDocument Method

This deletes a user document.

public static void DeleteDocument(

string docId,

string docPassword

);

Parameters

docId

The document ID.

docPassword

The document password.

Exceptions

| Exception Type | Condition |
|---|---|
| UserDocumentException | This is thrown when a document-related error |
| | occurs. |

See Also

UserDocument Class|ActionEngine.Api Namespace

API Class Library

UserDocument.GetDocument Method

This retrievs a user document.

public static string GetDocument(

string docId,

string docPassword,

UserName userName,

string userHandle

);

Parameters

docId

The document ID.

docPassword

The document password.

userName

The user name.

userHandle

The user's handle. See Handle.

Return Value

The document, or the empty string if the user has no instance of the document.

Remarks

This retrievs a user document. If the document definition exists but the user has no instance of the document, an empty string “ ” is returned.

Exceptions

| Exception Type | Condition |
|---|---|
| UserDocumentException | This is thrown when a document-related error |
| | occurs. |

See Also

UserDocument Class|ActionEngine.Api Namespace

API Class Library

UserDocument.SetDocument Method

This sets a document for a user.

public static void SetDocument(

string docId,

string docPassword,

UserName userName,

string userHandle,

string doc

);

Parameters

docId

The document ID.

docPassword

The document password.

userName

The user name.

userHandle

The user's handle. See Handle.

doc

The document content.

Remarks

This sets a document for a user. The document ID and password must already exist by creating it using the administration web site or by install.xml.

Exceptions

| Exception Type | Condition |
|---|---|
| UserDocumentException | This is thrown when a document-related error |
| | occurs. |

See Also

UserDocument Class|ActionEngine.Api Namespace

API Class Library

UserDocument.SetDocumentPassword Method

This sets the password for a document ID.

public static void SetDocumentPassword(

string docId,

string docPassword,

string newPassword

);

Parameters

docId

The document ID.

docPassword

The old document password.

newPassword

The new document password.

Remarks

This sets the password for a document ID. The existing password, docPassword, must match in order to have authority to set the new password.

Exceptions

| Exception Type | Condition |
|---|---|
| UserDocumentException | This is thrown when a document-related error |
| | occurs. |

See Also

UserDocument Class|ActionEngine.Api Namespace

API Class Library

UserDocumentException Class

This exception class relates to the processing of user documents.

For a list of all members of this type, see UserDocumentException Members.

System.Object

Exception

ApplicationException

UserDocumentException

public class UserDocumentException: ApplicationException

Requirements

Namespace: ActionEngine.Api

Assembly: aefwapi (in aefwapi.dll)

See Also

UserDocumentException Members|ActionEngine.Api Namespace|UserDocument

API Class Library

UserDocumentException Members

UserDocumentException overview

| | |
|---|---|
| Public Instance Properties | |
| HelpLink (inherited from Exception) | Gets or sets a link to the help file associated with |
| | this exception. |
| InnerException (inherited from Exception) | Gets the Exception instance that caused the current |
| | exception. |
| Message | The text of the user document error message. |
| Source (inherited from Exception) | Gets or sets the name of the application or the |
| | object that causes the error. |
| StackTrace (inherited from Exception) | Gets a string representation of the frames on the |
| | call stack at the time the current exception was |
| | thrown. |
| TargetSite (inherited from Exception) | Gets the method that throws the current exception. |
| TheCode | The error code of the user document error. |
| Public Instance Methods | |
| Equals (inherited from Object) | Determines whether the specified Object is equal to |
| | the current Object. |
| GetBaseException (inherited from Exception) | When overridden in a derived class, returns the |
| | Exception that is the root cause of one or more |
| | subsequent exceptions. |
| GetHashCode (inherited from Object) | Serves as a hash function for a particular type, |
| | suitable for use in hashing algorithms and data |
| | structures like a hash table. |
| GetObjectData (inherited from Exception) | When overridden in a derived class, sets the |
| | SerializationInfo with information about the |
| | exception. |
| GetType (inherited from Object) | Gets the Type of the current instance. |
| ToString (inherited from Exception) | Creates and returns a string representation of the |
| | current exception. |
| Protected Instance Properties | |
| HResult (inherited from Exception) | Gets or sets HRESULT, a coded numerical value |
| | that is assigned to a specific exception. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

UserDocumentException Class|ActionEngine.Api Namespace|UserDocument

API Class Library

UserDocumentException Properties

The properties of the UserDocumentException class are listed below. For a complete list of UserDocumentException class members, see the UserDocumentException Members topic.

| | |
|---|---|
| Public Instance Properties | |
| HelpLink (inherited from Exception) | Gets or sets a link to the help file associated with |
| | this exception. |
| InnerException (inherited from Exception) | Gets the Exception instance that caused the current |
| | exception. |
| Message | The text of the user document error message. |
| Source (inherited from Exception) | Gets or sets the name of the application or the |
| | object that causes the error. |
| StackTrace (inherited from Exception) | Gets a string representation of the frames on the |
| | call stack at the time the current exception was |
| | thrown. |
| TargetSite (inherited from Exception) | Gets the method that throws the current exception. |
| TheCode | The error code of the user document error. |
| Protected Instance Properties | |
| HResult (inherited from Exception) | Gets or sets HRESULT, a coded numerical value |
| | that is assigned to a specific exception. |

See Also

UserDocumentException Class|ActionEngine.Api Namespace|UserDocument

API Class Library

UserDocumentException.Message Property

The text of the user document error message.

public override string Message {get;}

See Also

UserDocumentException Class|ActionEngine.Api Namespace

API Class Library

UserDocumentException.TheCode Property

The error code of the user document error.

public UserDocumentException.Code TheCode {get;}

See Also

UserDocumentException Class ActionEngine.Api Namespace

API Class Library

UserDocumentException.Code Enumeration

The enumeration of error codes related to this exception.

public enum UserDocumentException.Code

Members

| Member Name | Description |
|---|---|
| E_BAD_DOC_ID_OR_PASSWORD | The document ID or password is invalid. |
| E_BAD_NEW_PASSWORD | The new password is invalid. |
| E_BAD_USER_NAME_OR_HANDLE | The user name or handle is invalid. |
| E_DOC_EXISTS | The document already exists. |
| E_FAIL | A generic error was encountered. |

Requirements

Namespace: ActionEngine.Api

Assembly: aefwapi (in aefwapi.dll)

See Also

ActionEngine.Api Namespace

API Class Library

UserName Class

This class represents a user name.

For a list of all members of this type, see UserName Members.

System Object

UserName

public class UserName

Remarks

This class represents a user name. The “long” version of a user name includes the user's namespace. The “short” version does not.

The long user name is typically more useful because it is unique per server installation, regardless of the number of user namespaces installed. Long user names are not displayed to end users.

The short user name is appropriate for showing to end users, but is not guaranteed to be unique across all namespaces.

Requirements

Namespace: ActionEngine.Api

Assembly: aefwapi (in aefwapi.dll)

See Also

UserName Members|ActionEngine.Api Namespace

API Class Library

UserName Members

UserName overview

| | |
|---|---|
| Public Instance Constructors | |
| UserName | Overloaded. Initializes a new instance of the |
| | UserName class. |
| Public Instance Properties | |
| Long | The long user name, which includes the user |
| | namespace. |
| Namespace | The user namespace. |
| Short | The short user name, which includes no user |
| | namespace. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

UserName Class|ActionEngine.Api Namespace

API Class Library

UserName Constructor

This constructs a UserName from the given long user name.

Overload List

This constructs a UserName from the given long user name.

public UserName(string);

This constructs a UserName from the given namespace and short user name.

public UserName(string,string);

See Also

UserName Class|ActionEngine.Api Namespace

API Class Library

UserName Constructor (String)

This constructs a UserName from the given long user name.

public UserName(

string longUserName

);

Parameters

longUserName

The long user name, which includes the user namespace.

See Also

UserName Class|ActionEngine.Api Namespace|UserName Constructor Overload List

API Class Library

UserName Constructor (String, String)

This constructs a UserName from the given namespace and short user name.

public UserName(

string namespace,

string shortUserName

);

Parameters

namespace

The user namespace.

shortUserName

The short user name, which includes no user namespace.

See Also

UserName Class|ActionEngine.Api Namespace|UserName Constructor Overload List

API Class Library

UserName Properties

The properties of the UserName class are listed below. For a complete list of UserName class members, see the UserName Members topic.

Public Instance Properties

| | |
|---|---|
| Long | The long user name, which includes the user |
| | namespace. |
| Namespace | The user namespace. |
| Short | The short user name, which includes no user |
| | namespace. |

See Also

UserName Class|ActionEngine.Api Namespace

API Class Library

UserName.Long Property

The long user name, which includes the user namespace.

public string Long {get;}

See Also

UserName Class|ActionEngine.Api Namespace

API Class Library

UserName.Namespace Property

The user namespace.

public string Namespace {get;}

See Also

UserName Class|ActionEngine.Api Namespace

API Class Library

UserName.Short Property

The short user name, which includes no user namespace.

public string Short {get;}

See Also

UserName Class|ActionEngine.Api Namespace

API Class Library

ActionEngine.Api.Schedule Namespace

Namespace hierarchy

Classes

| Class | Description |
|---|---|
| DailyMoment | This class represents a moment that occurs at a |
| | certain time on certain days of the week. |
| DailyRecurring | This class represents a moment that occurs every |
| | N minutes, bounded by a start time and duration, on |
| | certain days of the week. |
| FeatureSchedule | This class represents a feature schedule. |
| MonthlyMoment | This class represents a moment that occurs at a |
| | certain time once a month. |
| Schedule | This class represents a schedule of one-time and |
| | recurring moments. |
| Scheduler | This class is responsible for managing schedules |
| | related to tasks and feature commands. |
| TaskSchedule | This class represents a task schedule. |

Interfaces

| Interface | Description |
|---|---|
| ITask | This interface represents a task, which is called into |
| | by the framework based on a schedule. |

Enumerations

| Enumeration | Description |
|---|---|
| DaysOfWeek | The enumeration of days in a week. |

API Class Library

DailyMoment Class

This class represents a moment that occurs at a certain time on certain days of the week.

For a list of all members of this type, see DailyMoment Members.

System.Object

DailyMoment

public class DailyMoment

Requirements

Namespace: ActionEngine.Api.Schedule

Assembly: aefwapi (in aefwapi.dll)

See Also

DailyMoment Members|ActionEngine.Api.Schedule Namespace

API Class Library

DailyMoment Members

DailyMoment overview

| | |
|---|---|
| Public Instance Constructors | |
| DailyMoment | Overloaded. Initializes a new instance of the |
| | DailyMoment class. |
| Public Instance Properties | |
| DaysOfWeek | This returns the days of the week for the daily |
| | moment. |
| MidnightOffset | This returns the midnight offset for the daily |
| | moment. |
| Public Instance Methods | |
| Equals | This compares two daily moments for equality. |
| GetHashCode | This returns a hash code for the daily moment. |
| GetType (inherited from Object) | Gets the Type of the current instance. |
| ToString | This returns an XML representation of the daily |
| | moment. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

DailyMoment Class|ActionEngine.Api.Schedule Namespace

API Class Library

DailyMoment Constructor

This constructs a new daily moment expressed as UTC.

Overload List

This constructs a new daily moment expressed as UTC.

public DailyMoment(DaysOfWeek,TimeSpan);

This constructs a new daily moment expressed as an offset from UTC.

public DailyMoment(DaysOfWeek,TimeSpan,TimeSpan);

See Also

DailyMoment Class|ActionEngine.Api.Schedule Namespace

API Class Library

DailyMoment Constructor (DaysOfWeek, TimeSpan)

This constructs a new daily moment expressed as UTC.

public DailyMoment(

DaysOfWeek daysOfWeek,

TimeSpan midnightOffset

);

Parameters

daysOfWeek

One or more days of the week.

midnightoffset

The offset from midnight in which the moment occurs.

Remarks

This constructs a new daily moment. At least one day of the week must be included, and the midnight offset must be >=0 and <24 hours.

Exceptions

| Exception Type | Condition |
|---|---|
| ApplicationException | This is thrown when one or more arguments are |
| | invalid. |

See Also

DailyMoment Class|ActionEngine.Api.Schedule Namespace|DailyMoment Constructor Overload List

API Class Library

DailyMoment Constructor (DaysOfWeek, TimeSpan, TimeSpan)

This constructs a new daily moment expressed as an offset from UTC.

public DailyMoment(

DaysOfWeek daysOfWeek,

TimeSpan midnightOffset,

TimeSpan utcOffset

);

Parameters

daysOfWeek

One or more days of the week.

midnightOffset

The offset from midnight in which the moment occurs.

utcOffset

The difference between Coordinated Universal Time (UTC) and the given midnight offset.

The value must be between −24 and 24 hours exclusive. See UtcOffset.

Remarks

This constructs a new daily moment. At least one day of the week must be included, and the midnight offset must be >=0 and <24 hours.

Exceptions

| Exception Type | Condition |
|---|---|
| ApplicationException | This is thrown when one or more arguments are |
| | invalid. |

See Also

DailyMoment Class|ActionEngine.Api.Schedule Namespace|DailyMoment Constructor Overload List

API Class Library

DailyMoment Properties

The properties of the DailyMoment class are listed below. For a complete list of DailyMoment class members, see the DailyMoment Members topic.

Public Instance Properties

| | |
|---|---|
| DaysOfWeek | This returns the days of the week for the daily |
| | moment. |
| MidnightOffset | This returns the midnight offset for the daily |
| | moment. |

See Also

DailyMoment Class|ActionEngine.Api.Schedule Namespace

API Class Library

DailyMoment.DaysOfWeek Property

This returns the days of the week for the daily moment.

public DaysOfWeek DaysOfWeek {get;}

See Also

DailyMoment Class|ActionEngine.Api.Schedule Namespace

API Class Library

DailyMoment.MidnightOffset Property

This returns the midnight offset for the daily moment.

public System.TimeSpan MidnightOffset {get;}

See Also

DailyMoment Class|ActionEngine.Api.Schedule Namespace

API Class Library

DailyMoment Methods

The methods of the DailyMoment class are listed below. For a complete list of DailyMoment class members, see the DailyMoment Members topic.

| | |
|---|---|
| Public Instance Methods | |
| Equals | This compares two daily moments for equality. |
| GetHashCode | This returns a hash code for the daily moment. |
| GetType (inherited from Object) | Gets the Type of the current instance. |
| ToString | This returns an XML representation of the daily |
| | moment. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

DailyMoment Class|ActionEngine.Api.Schedule Namespace

API Class Library

DailyMoment.Equals Method

This compares two daily moments for equality.

public override bool Equals(

object obj

);

Parameters

obj

The object to compare.

Return Value

True if equal, false otherwise.

See Also

DailyMoment Class|ActionEngine.Api.Schedule Namespace

API Class Library

DailyMoment.GetHashCode Method

This returns a hash code for the daily moment.

public override int GetHashCode( );

Return Value

A hash code.

See Also

DailyMoment Class|ActionEngine.Api.Schedule Namespace

API Class Library

DailyMoment.ToString Method

This returns an XML representation of the daily moment.

public override string ToString( );

Return Value

An XML representation of the daily moment.

See Also

DailyMoment Class|ActionEngine.Api.Schedule Namespace

API Class Library

DailyRecurring Class

This class represents a moment that occurs every N minutes, bounded by a start time and duration, on certain days of the week.

For a list of all members of this type, see DailyRecurring Members.

System.Object

DailyRecurring

public class DailyRecurring

Requirements

Namespace: ActionEngine.Api.Schedule

Assembly: aefwapi (in aefwapi.dll)

See Also

DailyRecurring Members|ActionEngine.Api.Schedule Namespace

API Class Library

DailyRecurring Members

DailyRecurring overview

| | |
|---|---|
| Public Instance Constructors | |
| DailyRecurring | Overloaded. Initializes a new instance of the |
| | DailyRecurring class. |
| Public Instance Properties | |
| DaysOfWeek | This returns the days of the week for the daily |
| | recurring moment. |
| Duration | This returns the duration for the daily recurring |
| | moment. |
| MidnightOffsetStart | This returns the start time for the daily recurring |
| | moment. |
| MinuteInterval | This returns the “every N minutes” interval in which |
| | the moment recurs. |
| Public Instance Methods | |
| Equals | This compares two daily recurring moments for |
| | equality. |
| GetHashCode | This returns a hash code for the daily recurring |
| | moment. |
| GetType (inherited from Object) | Gets the Type of the current instance. |
| ToString | This returns an XML representation of the daily |
| | recurring moment. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

DailyRecurring Class|ActionEngine.Api.Schedule Namespace

API Class Library

DailyRecurring Constructor

This constructs a new daily recurring moment expressed as UTC.

Overload List

This constructs a new daily recurring moment expressed as UTC.

public DailyRecurring(DaysOfWeek,int,TimeSpan,TimeSpan);

This constructs a new daily recurring moment expressed as an offset from UTC.

public DailyRecurring(DaysOfWeek,int,TimeSpan,TimeSpan,TimeSpan);

See Also

DailyRecurring Class|ActionEngine.Api.Schedule Namespace

API Class Library

DailyRecurring Constructor (DaysOfWeek, Int32, TimeSpan, TimeSpan)

This constructs a new daily recurring moment expressed as UTC.

public DailyRecurring(

DaysOfWeek daysOfWeek,

int minuteinterval,

TimeSpan midnightOffsetStart,

TimeSpan duration

);

Parameters

daysOfWeek

One or more days of the week on which the first of the recurring moments begins. Note that depending on the duration, the day might wrap to the next one, which is fine. For example, if defining Friday, 22:00 start time, 4 hour duration, 15 minute interval, the recurring moment will begin on Friday but will span to Saturday at 2:00.

minuteInterval

How often the moment occurs within the span, specified in minutes.

midnightOffsetStart

The time of the first moment.

duration

The duration after which minuteInterval ceases to have an effect. The value must be >0 and <24 hours.

Remarks

This constructs a new daily recurring moment. The recurring moment begins at the given time and happens every N minutes until the given duration is up.

Exceptions

| Exception Type | Condition |
|---|---|
| ApplicationException | This is thrown when one or more arguments are |
| | invalid. |

See Also

DailyRecurring Class|ActionEngine.Api.Schedule Namespace|DailyRecurring Constructor Overload List

API Class Library

DailyRecurring Constructor (DaysOfWeek, Int32, TimeSpan, TimeSpan, TimeSpan)

This constructs a new daily recurring moment expressed as an offset from UTC.

public DailyRecurring(

DaysOfWeek daysOfWeek,

int minuteInterval,

TimeSpan midnightOffsetStart,

TimeSpan duration,

TimeSpan utcOffset

);

Parameters

daysOfWeek

One or more days of the week on which the first of the recurring moments begins. Note that depending on the duration, the day might wrap to the next one, which is fine. For example, if defining Friday, 22:00 start time, 4 hour duration, 15 minute interval, the recurring moment will begin on Friday but will span to Saturday at 2:00.

minuteInterval

How often the moment occurs within the span, specified in minutes.

midnightOffsetStart

The time of the first moment.

duration

The duration after which minuteInterval ceases to have an effect. The value must be >0 and <24 hours.

utcOffset

The difference between Coordinated Universal Time (UTC) and the given start time. The value must be between −24 and 24 hours exclusive. See UtcOffset.

Remarks

This constructs a new daily recurring moment. The recurring moment begins at the given time and happens every N minutes until the given duration is up.

Exceptions

| Exception Type | Condition |
|---|---|
| ApplicationException | This is thrown when one or more arguments are |
| | invalid. |

See Also

DailyRecurring Class|ActionEngine.Api.Schedule Namespace|DailyRecurring Constructor Overload List

API Class Library

DailyRecurring Properties

The properties of the DailyRecurring class are listed below. For a complete list of DailyRecurring class members, see the DailyRecurring Members topic.

Public Instance Properties

| | |
|---|---|
| DaysOfWeek | This returns the days of the week for the daily |
| | recurring moment. |
| Duration | This returns the duration for the daily recurring |
| | moment. |
| MidnightOffsetStart | This returns the start time for the daily recurring |
| | moment. |
| MinuteInterval | This returns the “every N minutes” interval in which |
| | the moment recurs. |

See Also

DailyRecurring Class|ActionEngine.Api.Schedule Namespace

API Class Library

DailyRecurring.DaysOfWeek Property

This returns the days of the week for the daily recurring moment.

public DaysOfWeek DaysOfWeek {get;}

See Also

DailyRecurring Class|ActionEngine.Api.Schedule Namespace

API Class Library

DailyRecurring.Duration Property

This returns the duration for the daily recurring moment.

public System.TimeSpan Duration {get;}

See Also

DailyRecurring Class|ActionEngine.Api.Schedule Namespace

API Class Library

DailyRecurring.MidnightOffsetStart Property

This returns the start time for the daily recurring moment.

public System.TimeSpan MidnightOffsetStart {get;}

See Also

DailyRecurring Class|ActionEngine.Api.Schedule Namespace

API Class Library

DailyRecurring.MinuteInterval Property

This returns the “every N minutes” interval in which the moment recurs.

public int MinuteInterval {get;}

See Also

DailyRecurring Class|ActionEngine.Api.Schedule Namespace

API Class Library

DailyRecurring Methods

The methods of the DailyRecurring class are listed below. For a complete list of DailyRecurring class members, see the DailyRecurring Members topic.

| | |
|---|---|
| Public Instance Methods | |
| Equals | This compares two daily recurring moments for |
| | equality. |
| GetHashCode | This returns a hash code for the daily recurring |
| | moment. |
| GetType (inherited | Gets the Type of the current instance. |
| from Object) | |
| ToString | This returns an XML representation of the daily |
| | recurring moment. |
| Protected Instance | |
| Methods | |
| Finalize (inherited from | Allows an Object to attempt to free resources |
| Object) | and perform other cleanup operations before |
| | the Object is reclaimed by garbage collection. |
| MemberwiseClone | Creates a shallow copy of the current Object. |
| (inherited from Object) | |

See Also

DailyRecurring Class|ActionEngine.Api.Schedule Namespace

API Class Library

DailyRecurring.Equals Method

This compares two daily recurring moments for equality.

public override bool Equals(

object obj

);

Parameters

obj

The object to compare.

Return Value

True if equal, false otherwise.

See Also

DailyRecurring Class|ActionEngine.Api.Schedule Namespace

API Class Library

DailyRecurring.GetHashCode Method

This returns a hash code for the daily recurring moment.

public override int GetHashCode( );

Return Value

A hash code.

See Also

DailyRecurring Class|ActionEngine.Api.Schedule Namespace

API Class Library

DailyRecurring.ToString Method

This returns an XML representation of the daily recurring moment.

public override string ToString( );

Return Value

An XML representation of the daily recurring moment.

See Also

DailyRecurring Class|ActionEngine.Api.Schedule Namespace

API Class Library

DaysOfWeek Enumeration

The enumeration of days in a week.

public enum DaysOfWeek

Remarks

The enumeration of days in a week. The members can be combined to indicate multiple days, such as DaysOfWeek.Saturday|DaysOfWeek.Sunday.

Members

| Member Name | Description |
|---|---|
| Monday | Monday |
| Tuesday | Tuesday |
| Wednesday | Wednesday |
| Thursday | Thursday |
| Friday | Friday |
| Saturday | Saturday |
| Sunday | Sunday |

Requirements

Namespace: ActionEngine.Api.Schedule

Assembly: aefwapi (in aefwapi.dll)

See Also

ActionEngine.Api.Schedule Namespace

API Class Library

FeatureSchedule Class

This class represents a feature schedule.

For a list of all members of this type, see FeatureSchedule Members.

System.Object

FeatureSchedule

public class FeatureSchedule

Remarks

This class represents a feature schedule. Feature schedules are dependent on a “push” system being installed on client devices and the server. Without this system, feature schedules are ignored. Today, the push system is the “Action Lock” product, which utilizes SMS for initiating contact from the server to the client. If you are developing plugins that utilize feature schedules, make sure that the intended deployment has Action Lock installed.

According to the given schedule, “feature commands” are fired off by the client device that maps to the given phone number. A user's phone numbers can be retrieved through the User class's Devices property. For more information on feature commands, see DoFeatureCommand.

Note that the implementation of DoFeatureCommand in the context of push can only return responses of type AnswersResponse.

Requirements

Namespace: ActionEngine.Api.Schedule

Assembly: aefwapi (in aefwapi.dll)

See Also

FeatureSchedule Members|ActionEngine.Api.Schedule Namespace

API Class Library

FeatureSchedule Members

FeatureSchedule overview

| | |
|---|---|
| Public Instance Constructors | |
| FeatureSchedule Constructor | This constructs a new feature schedule. |
| Public Instance Properties | |
| AllowedEarly | This returns the interval that is acceptable for a |
| | scheduled event to fire early. |
| AllowedLate | This returns the interval that is acceptable for a |
| | scheduled event to fire late. |
| Args | This returns the arguments associated with the |
| | feature command. |
| Droppable | This returns whether or not a scheduled event can |
| | be dropped when the server is experiencing high |
| | load. |
| FeatureId | This returns the feature ID associated with the |
| | feature command. |
| FriendlyName | This returns the friendly name of the feature |
| | schedule. |
| Id | This returns the feature schedule's ID. |
| MaxTimeOnQueue | This returns the maximum amount of time a |
| | command can sit in the server's push queue without |
| | the client discovering it before it expires. |
| PhoneNumber | This returns the phone number of the client device |
| | to which the response to DoFeatureCommand is |
| | sent. |
| Schedule | This returns the schedule. |
| UserName | This returns the user name. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

FeatureSchedule Class|ActionEngine.Api.Schedule Namespace

API Class Library

FeatureSchedule Constructor

This constructs a new feature schedule.

public FeatureSchedule(

Schedule schedule,

string friendlyName,

string featureId,

string [symbol] args,

Device device,

ClientInfo clientInfo,

UserName userName,

TimeSpan maxTimeOnQueue,

bool droppable,

TimeSpan allowedEarly,

TimeSpan allowedLate

);

Parameters

schedule

The schedule.

friendlyName

The friendly name.

featureId

The feature ID associated with the feature command.

args

The arguments associated with the feature command.

device

The client device to which the response to DoFeatureCommand is sent.

clientInfo

Information about the client making the request.

userName

The user name.

max TimeOnQueue

The maximum amount of time a command can sit in the server's push queue without the client discovering it before it expires. For example, if a client device is turned off for a month, it may not make sense for a daily schedule to cause a month's worth of commands to queue up on the push server.

droppable

Whether or not a scheduled event can be dropped when the server is experiencing high load. In rare situations during high load, even if set to false, an event may be dropped if the system cannot catch up otherwise. Consider setting this to true if the content being pushed is non-essential or is not paid for by the user. Normally nothing will be dropped anyway.

allowedEarly

The interval that is acceptable for a scheduled event to fire early. Normally an event will fire at the precisely-scheduled time, but under high load the scheduler may try to spread out requests by starting some early and others late. This parameter allows the application to influence the scheduler, although there are no guarantees. Consider setting this to the maximum reasonable value.

allowedLate

The interval that is acceptable for a scheduled event to fire late.

See Also

FeatureSchedule Class|ActionEngine.Api.Schedule Namespace|Scheduler

API Class Library

FeatureSchedule Properties

The properties of the FeatureSchedule class are listed below. For a complete list of FeatureSchedule class members, see the FeatureSchedule Members topic.

Public Instance Properties

| | |
|---|---|
| AllowedEarly | This returns the interval that is acceptable for a |
| | scheduled event to fire early. |
| AllowedLate | This returns the interval that is acceptable for a |
| | scheduled event to fire late. |
| Args | This returns the arguments associated with the |
| | feature command. |
| Droppable | This returns whether or not a scheduled event can |
| | be dropped when the server is experiencing high |
| | load. |
| FeatureId | This returns the feature ID associated with the |
| | feature command. |
| FriendlyName | This returns the friendly name of the feature |
| | schedule. |
| Id | This returns the feature schedule's ID. |
| MaxTimeOnQueue | This returns the maximum amount of time a |
| | command can sit in the server's push queue without |
| | the client discovering it before it expires. |
| PhoneNumber | This returns the phone number of the client device |
| | to which the response to DoFeatureCommand is |
| | sent. |
| Schedule | This returns the schedule. |
| UserName | This returns the user name. |

See Also

FeatureSchedule Class|ActionEngine.Api.Schedule Namespace

API Class Library

FeatureSchedule.AllowedEarly Property

This returns the interval that is acceptable for a scheduled event to fire early.

public System.TimeSpan AllowedEarly {get;}

Remarks

For more information, see FeatureSchedule

See Also

FeatureSchedule Class|ActionEngine.Api.Schedule Namespace

API Class Library

FeatureSchedule.AllowedLate Property

This returns the interval that is acceptable for a scheduled event to fire late.

public System.TimeSpan AllowedLate {get;}

Remarks

For more information, see FeatureSchedule

See Also

FeatureSchedule Class|ActionEngine.Api.Schedule Namespace

API Class Library

FeatureSchedule.Args Property

This returns the arguments associated with the feature command.

public string [symbol] Args {get;}

See Also

FeatureSchedule Class|ActionEngine.Api.Schedule Namespace

API Class Library

FeatureSchedule.Droppable Property

This returns whether or not a scheduled event can be dropped when the server is experiencing high load.

public bool Droppable {get;}

See Also

FeatureSchedule Class|ActionEngine.Api.Schedule Namespace

API Class Library

FeatureSchedule.FeatureId Property

This returns the feature ID associated with the feature command.

public string Featureld {get;}

See Also

FeatureSchedule Class|ActionEngine.Api.Schedule Namespace

API Class Library

FeatureSchedule.FriendlyName Property

This returns the friendly name of the feature schedule.

public string FriendlyName {get;}

See Also

FeatureSchedule Class|ActionEngine.Api.Schedule Namespace

API Class Library

FeatureSchedule.Id Property

This returns the feature schedule's ID.

public System.Guid Id {get;}

Remarks

The ID is only available after retrieving the feature schedule from the database. Otherwise, the value is Guid.Empty.

See Also

FeatureSchedule Class|ActionEngine.Api.Schedule Namespace

API Class Library

FeatureSchedule.MaxTimeOnQueue Property

This returns the maximum amount of time a command can sit in the server's push queue without the client discovering it before it expires.

public System.TimeSpan MaxTimeOnQueue {get;}

Remarks

This returns the maximum amount of time a command can sit in the server's push queue without the client discovering it before it expires. For example, if a client device is turned off for a month, it may not make sense for a daily schedule to cause a month's worth of commands to queue up on the push server.

See Also

FeatureSchedule Class|ActionEngine.Api.Schedule Namespace

API Class Library

FeatureSchedule.PhoneNumber Property

This returns the phone number of the client device to which the response to DoFeatureCommand is sent.

public string PhoneNumber {get;}

See Also

FeatureSchedule Class|ActionEngine.Api.Schedule Namespace

API Class Library

FeatureSchedule.Schedule Property

This returns the schedule.

public Schedule Schedule {get;}

See Also

FeatureSchedule Class|ActionEngine.Api.Schedule Namespace

API Class Library

FeatureSchedule.UserName Property

This returns the user name.

public ActionEngine.Api.UserName UserName {get;}

See Also

FeatureSchedule Class|ActionEngine.Api.Schedule Namespace

API Class Library

ITask Interface

This interface represents a task, which is called into by the framework based on a schedule.

For a list of all members of this type, see ITask Members.

public interface ITask: IModule, IHealth

Remarks

This interface represents a task, which is called into by the framework based on a schedule.

The schedule can be defined programmatically or in an install.xml file. For more information on the relationship between tasks and schedules, see TaskSchedule.

To implement a task:

Create a new plugin folder.

In the plugin folder, create a “cfg” subfolder. In the cfg folder, create an “install.xml” file. The install.xml file defines a component of type “task.” Here is an example install.xml file: <install><content><component name=“mytask” type=“task”><class assembly=“mytask.dll” lang=“.net”>MyCompany.MyTask</class></component></content><plugin><id>mytask</id><namespace>abc</namespace><version>0.1</version></plugin></install>

In the plugin folder, create a “dotnet” subfolder. The assembly referenced in install.xml is relative to this folder.

Implement the ITask interface using the class name defined in install.xml.

If the task makes use of a type (interface, class, etc.) exposed by an assembly in another plugin, set up a dependency. For more information, see IModule.

Requirements

Namespace: ActionEngine.Api.Schedule

Assembly: aefwapi (in aefwapi.dll)

See Also

ITask Members|ActionEngine.Api.Schedule Namespace

API Class Library

ITask Members

ITask overview

Public Instance Methods

RunTask This is called to run a task.

See Also

ITask Interface|ActionEngine.Api.Schedule Namespace

API Class Library

ITask Methods

The methods of the ITask interface are listed below. For a complete list of ITask interface members, see the ITask Members topic.

Public Instance Methods

| | |
|---|---|
| RunTask | This is called to run a task. |

See Also

ITask Interface|ActionEngine.Api.Schedule Namespace

API Class Library

ITask.RunTask Method

This is called to run a task.

Response RunTask(

string taskData,

DateTime scheduledMoment,

string componentId

);

Parameters

taskData

The task data defined in the task schedule.

scheduledMoment

The date/time associated with the moment in a task schedule that caused this to be called.

This is provided because the actual time that RunTask is called could be different than the intended scheduled time in some cases, such as when the scheduler gets backed up under heavy load.

componentId

The component ID of the task schedule.

Return Value

A Response.

Remarks

This is called to run a task. Typically a CodeResponse of type S_OK is returned, but other codes can be returned, and responses of type HealthResponse are also allowed.

See Also

ITask Interface|ActionEngine.Api.Schedule Namespace

API Class Library

MonthlyMoment Class

This class represents a moment that occurs at a certain time once a month.

For a list of all members of this type, see MonthlyMoment Members.

System.Object

MonthlyMoment

public class MonthlyMoment

Requirements

Namespace: ActionEngine.Api.Schedule

Assembly: aefwapi (in aefwapi.dll)

See Also

MonthlyMoment Members|ActionEngine.Api.Schedule Namespace

API Class Library

MonthlyMoment Members

MonthlyMoment overview

| | |
|---|---|
| Public Instance Constructors | |
| MonthlyMoment | Overloaded. Initializes a new instance of the |
| | MonthlyMoment class. |
| Public Instance Properties | |
| DayOfMonth | This returns the day of the month for the monthly |
| | moment. |
| MidnightOffset | This returns the midnight offset for the monthly |
| | moment. |
| Public Instance Methods | |
| Equals | This compares two monthly moments for equality. |
| GetHashCode | This returns a hash code for the monthly moment. |
| GetType (inherited from Object) | Gets the Type of the current instance. |
| ToString | This returns an XML representation of the monthly |
| | moment. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

MonthlyMoment Class|ActionEngine.Api.Schedule Namespace

API Class Library

MonthlyMoment Constructor

This constructs a new monthly moment expressed as UTC.

Overload List

This constructs a new monthly moment expressed as UTC.

public MonthlyMoment(int,TimeSpan);

This constructs a new monthly moment expressed as an offset from UTC.

public MonthlyMoment(int,TimeSpan,TimeSpan);

See Also

MonthlyMoment Class|ActionEngine.Api.Schedule Namespace

API Class Library

MonthlyMoment Constructor (Int32, TimeSpan)

This constructs a new monthly moment expressed as UTC.

public MonthlyMoment(

int dayOfMonth,

TimeSpan midnightOffset

);

Parameters

dayOfMonth

The day of the month.

midnightOffset

The offset from midnight when the moment occurs.

Remarks

This constructs a new monthly moment. The given day of the month must be between 1 and 31. For months that have fewer than 31 days, the last day of the month is used. The midnight offset must be >=0 and <24 hours.

Exceptions

| Exception Type | Condition |
|---|---|
| ApplicationException | This is thrown when one or more arguments are |
| | invalid. |

See Also

MonthlyMoment Class|ActionEngine.Api.Schedule Namespace|MonthlyMoment Constructor Overload List

API Class Library

MonthlyMoment Constructor (Int32, TimeSpan, TimeSpan)

This constructs a new monthly moment expressed as an offset from UTC.

public MonthlyMoment(

int dayOfMonth,

TimeSpan midnightOffset,

TimeSpan utcOffset

);

Parameters

dayOfMonth

The day of the month.

midnightOffset

The offset from midnight when the moment occurs.

utcOffset

The difference between Coordinated Universal Time (UTC) and the given midnight offset.

The value must be between −24 and 24 hours exclusive. See UtcOffset. !@# EXPLAIN END OF MONTH BEHAVIOR

Remarks

This constructs a new monthly moment. The given day of the month must be between 1 and 31. For months that have fewer than 31 days, the last day of the month is used. The midnight offset must be >=0 and <24 hours.

Exceptions

| Exception Type | Condition |
|---|---|
| ApplicationException | This is thrown when one or more arguments are |
| | invalid. |

See Also

MonthlyMoment Class|ActionEngine.Api.Schedule Namespace|MonthlyMoment Constructor Overload List

API Class Library

MonthlyMoment Properties

The properties of the MonthlyMoment class are listed below. For a complete list of MonthlyMoment class members, see the MonthlyMoment Members topic.

Public Instance Properties

| | |
|---|---|
| DayOfMonth | This returns the day of the month for the monthly |
| | moment. |
| MidnightOffset | This returns the midnight offset for the monthly |
| | moment. |

See Also

MonthlyMoment Class|ActionEngine.Api.Schedule Namespace

API Class Library

MonthlyMoment.DayOfMonth Property

This returns the day of the month for the monthly moment.

public int DayOfMonth {get;}

See Also

MonthlyMoment Class|ActionEngine.Api.Schedule Namespace

API Class Library

MonthlyMoment.MidnightOffset Property

This returns the midnight offset for the monthly moment.

public System.TimeSpan MidnightOffset {get;}

See Also

MonthlyMoment Class|ActionEngine.Api.Schedule Namespace

API Class Library

MonthlyMoment Methods

The methods of the MonthlyMoment class are listed below. For a complete list of MonthlyMoment class members, see the MonthlyMoment Members topic.

| | |
|---|---|
| Public Instance Methods | |
| Equals | This compares two monthly moments for equality. |
| GetHashCode | This returns a hash code for the monthly moment. |
| GetType (inherited from Object) | Gets the Type of the current instance. |
| ToString | This returns an XML representation of the monthly |
| | moment. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

MonthlyMoment Class|ActionEngine.Api.Schedule Namespace

API Class Library

MonthlyMoment.Equals Method

This compares two monthly moments for equality.

public override bool Equals(

object obj

);

Parameters

obj

The object to compare.

Return Value

True if equal, false otherwise.

See Also

MonthlyMoment Class|ActionEngine.Api.Schedule Namespace

API Class Library

MonthlyMoment.GetHashCode Method

This returns a hash code for the monthly moment.

public override int GetHashCodeo( );

Return Value

A hash code.

See Also

MonthlyMoment Class|ActionEngine.Api.Schedule Namespace

API Class Library

MonthlyMoment.ToString Method

This returns an XML representation of the monthly moment.

public override string ToString( );

Return Value

An XML representation of the monthly moment.

See Also

MonthlyMoment Class|ActionEngine.Api.Schedule Namespace

API Class Library

Schedule Class

This class represents a schedule of one-time and recurring moments.

For a list of all members of this type, see Schedule Members.

System Object

Schedule

public class Schedule

Remarks

This class represents a schedule of one-time and recurring moments. Note that this class is NOT thread safe. Implement your own locking if multi-threaded access is required.

The schedule's resolution is to the minute. Seconds are ignored. All times are expressed as UTC. When defining offsets and absolute times in XML (parsed by the Schedule constructor), an exception is thrown if an offset or time includes seconds. For methods that take DateTime or TimeSpan structures, the seconds if provided are simply ignored.

Requirements

Namespace: ActionEngine.Api.Schedule

Assembly: aefwapi (in aefwapi.dll)

See Also

Schedule Members|ActionEngine.Api.Schedule Namespace

API Class Library

Schedule Members

Schedule overview

| | |
|---|---|
| Public Static Fields | |
| NoDateTime | This represents a DateTime that has no value or |
| | has not been specified. |
| Public Instance Constructors | |
| Schedule | Overloaded. Initializes a new instance of the |
| | Schedule class. |
| Public Instance Properties | |
| Beginning | This represents a beginning bound on the entire |
| | schedule. |
| DailyMoments | This returns the daily moments of the schedule. |
| DailyRecurring | This returns the daily recurring moments of the |
| | schedule. |
| End | This represents an ending bound on the entire |
| | schedule. |
| Moments | This returns the moments of the schedule. |
| MonthlyMoments | This returns the monthly moments of the schedule. |
| Public Instance Methods | |
| AddDailyMoment | This adds a daily moment to the schedule. |
| AddDailyRecurring | This adds a daily recurring moment to the schedule. |
| AddMoment | This adds a moment to the schedule. |
| AddMonthlyMoment | This adds a monthly moment to the schedule. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetNextMoment | This returns the first moment that follows the |
| | reference moment, or NoDateTime if none exists. |
| GetType (inherited from Object) | Gets the Type of the current instance. |
| RemoveDailyMoment | This removes a daily moment from the schedule. |
| RemoveDailyRecurring | This removes a daily recurring moment from the |
| | schedule. |
| RemoveMoment | This removes a moment from the schedule. |
| RemoveMonthlyMoment | This removes a monthly moment from the schedule. |
| ToString | This returns an XML representation of the schedule. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Schedule Class|ActionEngine.Api.Schedule Namespace

API Class Library

Schedule Constructor

This constructs an empty schedule.

Overload List

This constructs an empty schedule.

public Schedule( );

This constructs a new schedule from the given XML.

public Schedule(string);

See Also

Schedule Class|ActionEngine.Api.Schedule Namespace

API Class Library

Schedule Constructor( )

This constructs an empty schedule.

public Schedule( );

See Also

Schedule Class|ActionEngine.Api.Schedule Namespace|Schedule Constructor Overload List

API Class Library

Schedule Constructor (String)

This constructs a new schedule from the given XML.

public Schedule(

string xml

);

Parameters

xml

The XML.

Remarks

This constructs a new schedule from the given XML. All times are expressed as UTC. Here is an example document:

<schedule beginning=“200301010000” end=“200307312359”><dailyMoment><daysOfWeek>1111100</daysOfWeek><time>1230</time></dailyMoment><dailyRecurring><daysOfWeek>0000011</daysOfWeek><minuteInterval>60</minuteInterval><startTime>0800</startTime><duration>120</duration></dailyRecurring><moment>200304011800</moment><monthlyMoment><dayOfMonth>15</dayOfMonth><time>1200</time></monthlyMoment></schedule>

Any number of the four main element types can be included in the schedule (dailyMoment, dailyRecurring, moment, and monthlyMoment), but each one must be unique within its category. For example, you cannot add <moment>200310310000</moment>twice.

The beginning and end attributes are optional. If not provided, or if a value is NoDateTime, the schedule is not bounded on that end (front or back).

<startTime> is the time at which a daily recurring moment begins.

<duration> is the duration in minutes after which <minuteInterval> ceases to have an effect.

<daysOfWeek> is a string of seven 1s and 0s representing which days of the week are enabled, beginning with Monday.

All absolute times must be of the format YYMMDDHHMM, and all times (offsets from midnight) must be of the format HHMM. Anything else will generate an exception during the parse.

Exceptions

| Exception Type | Condition |
|---|---|
| ApplicationException | This is thrown when the XML is invalid. |
| XmlException | This is thrown when the XML fails to load or |
| | parse. |

See Also

Schedule Class|ActionEngine.Api.Schedule Namespace|Schedule Constructor Overload List

API Class Library

Schedule Fields

The fields of the Schedule class are listed below. For a complete list of Schedule class members, see the Schedule Members topic.

Public Static Fields

| | |
|---|---|
| NoDateTime | This represents a DateTime that has no value or |
| | has not been specified. |

See Also

Schedule Class|ActionEngine.Api.Schedule Namespace

API Class Library

Schedule.NoDateTime Field

This represents a DateTime that has no value or has not been specified.

public static readonly DateTime NoDateTime;

Remarks

This represents a DateTime that has no value or has not been specified. The value is Jan. 1, 2000, 12:00 AM.

See Also

Schedule Class|ActionEngine.Api.Schedule Namespace

API Class Library

Schedule Properties

The properties of the Schedule class are listed below. For a complete list of Schedule class members, see the Schedule Members topic.

Public Instance Properties

| | |
|---|---|
| Beginning | This represents a beginning bound on the entire |
| | schedule. |
| DailyMoments | This returns the daily moments of the schedule. |
| DailyRecurring | This returns the daily recurring moments of the |
| | schedule. |
| End | This represents an ending bound on the entire |
| | schedule. |
| Moments | This returns the moments of the schedule. |
| MonthlyMoments | This returns the monthly moments of the schedule. |

See Also

Schedule Class|ActionEngine.Api.Schedule Namespace

API Class Library

Schedule.Beginning Property

This represents a beginning bound on the entire schedule.

public System.DateTime Beginning {get; set;}

Remarks

This represents a beginning bound on the entire schedule. If not provided, a value of NoDateTime is used. In a similar way, to clear the beginning, assign a value of NoDateTime.

Exceptions

| Exception Type | Condition |
|---|---|
| ApplicationException | This is thrown if both the beginning and end are |
| | specified, and the beginning is not before the end. |

See Also

Schedule Class|ActionEngine.Api.Schedule Namespace|End

API Class Library

Schedule.DailyMoments Property

This returns the daily moments of the schedule.

public DailyMoment [symbol] DailyMoments {get;}

Remarks

This returns the daily moments of the schedule. If none is present, a zero-length array is returned.

See Also

Schedule Class|ActionEngine.Api.Schedule Namespace

API Class Library

Schedule.DailyRecurring Property

This returns the daily recurring moments of the schedule.

public DailyRecurring [symbol] DailyRecurring {get;}

Remarks

This returns the daily recurring moments of the schedule. If none is present, a zero-length array is returned.

See Also

Schedule Class|ActionEngine.Api.Schedule Namespace

API Class Library

Schedule.End Property

This represents an ending bound on the entire schedule.

public System.DateTime End {get; set;}

Remarks

This represents an ending bound on the entire schedule. If not provided, a value of NoDateTime is used. In a similar way, to clear the end, assign a value of NoDateTime.

Exceptions

| Exception Type | Condition |
|---|---|
| ApplicationException | This is thrown if both the beginning and end are |
| | specified, and the beginning is not before the end. |

See Also

Schedule Class|ActionEngine.Api.Schedule Namespace|Beginning

API Class Library

Schedule.Moments Property

This returns the moments of the schedule.

public System.DateTime [symbol] Moments {get;}

Remarks

This returns the moments of the schedule. If none is present, a zero-length array is returned.

See Also

Schedule Class|ActionEngine.Api.Schedule Namespace

API Class Library

Schedule.MonthlyMoments Property

This returns the monthly moments of the schedule.

public MonthlyMoment [symbol] MonthlyMoments {get;}

Remarks

This returns the monthly moments of the schedule. If none is present, a zero-length array is returned.

See Also

Schedule Class|ActionEngine.Api.Schedule Namespace

API Class Library

Schedule Methods

The methods of the Schedule class are listed below. For a complete list of Schedule class members, see the Schedule Members topic.

| | |
|---|---|
| Public Instance Methods | |
| AddDailyMoment | This adds a daily moment to the schedule. |
| AddDailyRecurring | This adds a daily recurring moment to the schedule. |
| AddMoment | This adds a moment to the schedule. |
| AddMonthlyMoment | This adds a monthly moment to the schedule. |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetNextMoment | This returns the first moment that follows the |
| | reference moment, or NoDateTime if none exists. |
| GetType (inherited from Object) | Gets the Type of the current instance. |
| RemoveDailyMoment | This removes a daily moment from the schedule. |
| RemoveDailyRecurring | This removes a daily recurring moment from the |
| | schedule. |
| RemoveMoment | This removes a moment from the schedule. |
| RemoveMonthlyMoment | This removes a monthly moment from the schedule. |
| ToString | This returns an XML representation of the schedule. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Schedule Class|ActionEngine.Api.Schedule Namespace

API Class Library

Schedule.AddDailyMoment Method

This adds a daily moment to the schedule.

public void AddDailyMoment(

DailyMoment dailyMoment

);

Parameters

dailyMoment

The daily moment to add.

Exceptions

See Also

Schedule Class|ActionEngine.Api.Schedule Namespace

API Class Library

Schedule.AddDailyRecurring Method

This adds a daily recurring moment to the schedule.

public void AddDailyRecurring(

DailyRecurring dailyRecurring

);

Parameters

dailyRecurring

The daily recurring moment to add.

Exceptions

| Exception Type | Condition |
|---|---|
| ApplicationException | This is thrown if the daily recurring moment |
| | already exists. |

See Also

Schedule Class|ActionEngine.Api.Schedule Namespace

API Class Library

Schedule.AddMoment Method

This adds a moment to the schedule.

public void AddMoment(

DateTime moment

);

Parameters

moment

The moment to add.

Exceptions

| Exception Type | Condition |
|---|---|
| ApplicationException | This is thrown if the moment already exists or if |
| | NoDateTime is attempted to be added. |

See Also

Schedule Class|ActionEngine.Api.Schedule Namespace

API Class Library

Schedule.AddMonthlyMoment Method

This adds a monthly moment to the schedule.

public void AddMonthlyMoment(

MonthlyMoment monthlyMoment

);

Parameters

monthlyMoment

The monthly moment to add.

Exceptions

| Exception Type | Condition |
|---|---|
| ApplicationException | This is thrown if the monthly moment already |
| | exists. |

See Also

Schedule Class|ActionEngine.Api.Schedule Namespace

API Class Library

Schedule.GetNextMoment Method

This returns the first moment that follows the reference moment, or NoDateTime if none exists.

public DateTime GetNextMoment(

DateTime reference

);

Parameters

reference

The reference moment.

Return Value

The next moment, or NoDateTime if none exists.

Remarks

This returns the first moment that follows the reference moment, or NoDateTime if none exists. It's possible for a schedule to have several instances of the same moment scheduled in different ways. For example, a monthly moment could be scheduled for 8:00 AM on the first of every month, and a daily moment could also be scheduled for 8:00 AM. In this case, the 8:00 AM moment would exist twice at times, but the implementation of this method does not return 8:00 if given 8:00. It would find the next moment that follows 8:00.

If the schedule has a Beginning and you want to search for the first moment, pass in any DateTime earlier than the beginning (but not the NoDateTime value).

Exceptions

| Exception Type | Condition |
|---|---|
| ApplicationException | This is thrown when the reference moment is |
| | NoDateTime. |

See Also

Schedule Class|ActionEngine.Api.Schedule Namespace

API Class Library

Schedule.RemoveDailyMoment Method

This removes a daily moment from the schedule.

public bool RemoveDailyMoment(

DailyMoment dailyMoment

);

Parameters

dailyMoment

The daily moment to remove.

Return Value

True if found, false otherwise.

See Also

Schedule Class|ActionEngine.Api.Schedule Namespace

API Class Library

Schedule.RemoveDailyRecurring Method

This removes a daily recurring moment from the schedule.

public bool RemoveDailyRecurring(

DailyRecurring dailyRecurring

);

Parameters

dailyRecurring

The daily recurring moment to remove.

Return Value

True if found, false otherwise.

See Also

Schedule Class|ActionEngine.Api.Schedule Namespace

API Class Library

Schedule.RemoveMoment Method

This removes a moment from the schedule.

public bool RemoveMoment(

DateTime moment

);

Parameters

moment

The moment to remove.

Return Value

True if found, false otherwise.

See Also

Schedule Class|ActionEngine.Api.Schedule Namespace

API Class Library

Schedule.RemoveMonthlyMoment Method

This removes a monthly moment from the schedule.

public bool RemoveMonthlyMoment(

MonthlyMoment monthlyMoment

);

Parameters

monthlyMoment

The monthly moment to remove.

Return Value

True if found, false otherwise.

See Also

Schedule Class|ActionEngine.Api.Schedule Namespace

API Class Library

Schedule.ToString Method

This returns an XML representation of the schedule.

public override string ToString( );

Return Value

An XML representation of the schedule.

Remarks

This returns an XML representation of the schedule. For more information on the format of the XML, see the Schedule constructor.

See Also

Schedule Class|ActionEngine.Api.Schedule Namespace

API Class Library

Scheduler Class

This class is responsible for managing schedules related to tasks and feature commands.

For a list of all members of this type, see Scheduler Members.

System.Object

Scheduler

public abstract class Scheduler

Requirements

Namespace: ActionEngine.Api.Schedule

Assembly: aefwapi (in aefwapi.dll)

See Also

Scheduler Members|ActionEngine.Api.Schedule Namespace

API Class Library

Scheduler Members

Scheduler overview

| | |
|---|---|
| Public Static Methods | |
| AddFeatureSchedule | This adds a feature schedule to the scheduler. |
| AddTaskSchedule | This adds a task schedule to the scheduler. |
| GetFeatureSchedules | Overloaded. This returns all feature schedules for |
| | the given user. |
| GetTaskSchedule | This returns the task schedule for the given |
| | component ID. |
| RemoveFeatureSchedule | This removes a feature schedule from the |
| | scheduler. |
| RemoveTaskSchedule | This removes a task schedule from the scheduler. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Constructors | |
| Scheduler Constructor | |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Scheduler Class|ActionEngine.Api.Schedule Namespace

API Class Library

Scheduler Constructor

protected Scheduler( );

See Also

Scheduler Class|ActionEngine.Api.Schedule Namespace

API Class Library

Scheduler Methods

The methods of the Scheduler class are listed below. For a complete list of Scheduler class members, see the Scheduler Members topic.

| | |
|---|---|
| Public Static Methods | |
| AddFeatureSchedule | This adds a feature schedule to the scheduler. |
| AddTaskSchedule | This adds a task schedule to the scheduler. |
| GetFeatureSchedules | Overloaded. This returns all feature schedules for |
| | the given user. |
| GetTaskSchedule | This returns the task schedule for the given |
| | component ID. |
| RemoveFeatureSchedule | This removes a feature schedule from the |
| | scheduler. |
| RemoveTaskSchedule | This removes a task schedule from the scheduler. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

Scheduler Class|ActionEngine.Api.Schedule Namespace

API Class Library

Scheduler.AddFeatureSchedule Method

This adds a feature schedule to the scheduler.

public static void AddFeatureSchedule(

FeatureSchedule featureSchedule

);

Parameters

featureSchedule

The feature schedule to add.

Remarks

Before calling this, make sure you check the device's IsPushable property.

See Also

Scheduler Class|ActionEngine.Api.Schedule Namespace

API Class Library

Scheduler.AddTaskSchedule Method

This adds a task schedule to the scheduler.

public static void AddTaskSchedule(

TaskSchedule taskSchedule

);

Parameters

taskSchedule

The task schedule to add.

Exceptions

| Exception Type | Condition |
|---|---|
| ApplicationException | This is thrown if a task schedule already exists for |
| | the component ID, or if there are other problems. |

See Also

Scheduler Class|ActionEngine.Api.Schedule Namespace

API Class Library

Scheduler.GetFeatureSchedules Method

This returns all feature schedules for the given user.

Overload List

This returns all feature schedules for the given user.

public static FeatureSchedule [symbol] GetFeatureSchedules(UserName);

This returns all feature schedules for the given user and feature ID.

public static FeatureSchedule [symbol] GetFeatureSchedules(UserName,string);

See Also

Scheduler Class|ActionEngine.Api.Schedule Namespace

API Class Library

Scheduler.GetFeatureSchedules Method (UserName)

This returns all feature schedules for the given user.

public static FeatureSchedule [symbol] GetFeatureSchedules(

UserName userName

);

Parameters

userName

The user name.

Return Value

All feature schedules for the given user. If none is present, a zero-length array is returned.

See Also

Scheduler Class|ActionEngine.Api.Schedule Namespace Scheduler.GetFeatureSchedules Overload List

API Class Library

Scheduler.GetFeatureSchedules Method (UserName, String)

This returns all feature schedules for the given user and feature ID.

public static FeatureSchedule [symbol] GetFeatureSchedules(

UserName userName,

string featureId

);

Parameters

userName

The user name.

featureId

The feature ID, fully qualified with the resource namespace, or null to ignore feature ID.

Return Value

All feature schedules for the given feature ID and user. If none is present, a zero-length array is returned.

See Also

Scheduler Class|ActionEngine.Api.Schedule Namespace Scheduler.GetFeatureSchedules Overload List

API Class Library

Scheduler.GetTaskSchedule Method

This returns the task schedule for the given component ID.

public static TaskSchedule GetTaskSchedule(

string componentId

);

Parameters

componentId

The ID of the component that implements the ITask interface.

Return Value

The task schedule for the given component ID, or null if none is defined.

See Also

Scheduler Class|ActionEngine.Api.Schedule Namespace

API Class Library

Scheduler.RemoveFeatureSchedule Method

This removes a feature schedule from the scheduler.

public static bool RemoveFeatureSchedule(

Guid featureScheduleId

);

Parameters

feature ScheduleId

The ID of the feature schedule to remove. See Id.

Return Value

True if found, false otherwise.

See Also

Scheduler Class|ActionEngine.Api.Schedule Namespace

API Class Library

Scheduler.RemoveTaskSchedule Method

This removes a task schedule from the scheduler.

public static bool RemoveTaskSchedule(

Guid taskScheduleId

);

Parameters

taskScheduleId

The ID of the task schedule to remove. See Id

Return Value

True if found, false otherwise.

See Also

Scheduler Class|ActionEngine.Api.Schedule Namespace

API Class Library

TaskSchedule Class

This class represents a task schedule.

For a list of all members of this type, see TaskSchedule Members.

System.Object

TaskSchedule

public class TaskSchedule

Remarks

This class represents a task schedule. The scheduler causes RunTask to be called according to the defined schedule. In an environment where scalability is achieved through running several instances of the plugin host, the scheduler ensures that only one instance picks up the request at a time.

Task schedules can also be defined in a plugin's install.xml file. Here is an example:

```
<install>
    <content>
        <component name=“mytask” type=“task”>
            <class assembly=“mytask.dll”
        lang=“.net”>MyCompany.MyTask</class>
            <taskSchedule>
                <friendlyName>My task schedule</friendlyName>
                <schedule beginning=“2003... See the Schedule(string
            xml) constructor for more information on the schedule
            XML
            schema.
                </schedule>
                <taskData>my data</taskData>
            </taskSchedule>
        </component>
    </content>
    ...
</install>
```

For more information on the schedule XML schema, see Schedule.

When it's time to call into ITask.RunTask( ), the scheduler passes in the task data that is defined in either install.xml as <taskData>my data</taskData> or as passed to the TaskSchedule constructor.

Only one task schedule is allowed per component ID. During plugin install, if install.xml defines a task schedule, it replaces any existing task schedule that might have been defined for that component. Task schedules can be added and removed programatically as well (see AddTaskSchedule and RemoveTaskSchedule).

Requirements

Namespace: ActionEngine.Api.Schedule

Assembly: aefwapi (in aefwapi.dll)

See Also

TaskSchedule Members|ActionEngine.Api.Schedule Namespace

API Class Library

TaskSchedule Members TaskSchedule overview

| | |
|---|---|
| Public Instance Constructors | |
| TaskSchedule Constructor | This constructs a new task schedule. |
| Public Instance Properties | |
| ComponentId | This returns the component ID associated with the |
| | task schedule. |
| FriendlyName | This returns the friendly name of the task schedule. |
| Id | This returns the task schedule's ID. |
| Schedule | This returns the schedule. |
| TaskData | This returns the task data, which is the data passed |
| | into RunTask each time the scheduler initiates a |
| | call. |
| Public Instance Methods | |
| Equals (inherited from Object) | Determines whether the specified Object is equal to |
| | the current Object. |
| GetHashCode (inherited from Object) | Serves as a hash function for a particular type, |
| | suitable for use in hashing algorithms and data |
| | structures like a hash table. |
| GetType (inherited from Object) | Gets the Type of the current instance. |
| ToString (inherited from Object) | Returns a String that represents the current Object. |
| Protected Instance Methods | |
| Finalize (inherited from Object) | Allows an Object to attempt to free resources and |
| | perform other cleanup operations before the Object |
| | is reclaimed by garbage collection. |
| MemberwiseClone (inherited from Object) | Creates a shallow copy of the current Object. |

See Also

TaskSchedule Class|ActionEngine.Api.Schedule Namespace

API Class Library

TaskSchedule Constructor

This constructs a new task schedule.

public TaskSchedule(

Schedule schedule,

string friendlyName,

string taskData,

string componentId

);

Parameters

schedule

The schedule.

friendlyName

The friendly name used for administrative purposes.

taskData

The task data that is passed into RunTask each time the scheduler initiates a call.

componentId

The fully-qualified component ID of the ITask module, which is defined in install.xml.

See Also

TaskSchedule Class|ActionEngine.Api.Schedule Namespace|Scheduler

API Class Library

TaskSchedule Properties

The properties of the TaskSchedule class are listed below. For a complete list of TaskSchedule class members, see the TaskSchedule Members topic.

Public Instance Properties

| | |
|---|---|
| ComponentId | This returns the component ID associated with the |
| | task schedule. |
| FriendlyName | This returns the friendly name of the task schedule. |
| Id | This returns the task schedule's ID. |
| Schedule | This returns the schedule. |
| TaskData | This returns the task data, which is the data passed |
| | into RunTask each time the scheduler initiates a |
| | call. |

See Also

TaskSchedule Class ActionEngine.Api.Schedule Namespace

API Class Library

TaskSchedule.ComponentId Property

This returns the component ID associated with the task schedule.

public string Componentid {get;}

See Also

TaskSchedule Class|ActionEngine.Api.Schedule Namespace

API Class Library

TaskSchedule.FriendlyName Property

This returns the friendly name of the task schedule.

public string FriendlyName {get;}

See Also

TaskSchedule Class|ActionEngine.Api.Schedule Namespace

API Class Library

TaskSchedule.Id Property

This returns the task schedule's ID.

public System.Guid Id {get;}

Remarks

The ID is only available after retrieving the task schedule from the database. Otherwise, the value is Guid.Empty.

See Also

TaskSchedule Class|ActionEngine.Api.Schedule Namespace

API Class Library

TaskSchedule.Schedule Property

This returns the schedule.

public Schedule Schedule {get;}

See Also

TaskSchedule Class|ActionEngine.Api.Schedule Namespace

API Class Library

TaskSchedule.TaskData Property

This returns the task data, which is the data passed into RunTask each time the scheduler initiates a call.

public string TaskData {get;}

See Also

TaskSchedule Class|ActionEngine.Api.Schedule Namespace

1. A computer implemented method for accessing a wireless mobile device service provider server via a programming interface layer, the method comprising:
encapsulating a function call encapsulation of a function-specific parameter identified a associated with an executable programming interface layer function;
generating a programming interface function call directed to said executable programming interface layer function, wherein said programming interface function call includes said function call encapsulation of data; and
obtaining an indication of an programming interface response from said executable programming interface layer function.

2. The method of claim 1, further comprising directing said programming interface response to a specific wireless mobile device.

3. A computer system comprising:
a processor; and
memory coupled to the processor having a plurality of programming instructions implementing a programming interface layer for service provider delivery of data services to client devices, the programming interface layer including solution delivery functions usable by any of a plurality of vendors to deliver solutions via the service provider, the programming interface layer including
a plurality of executable service functions;
a parameter processing module for processing function-specific parameters, including device information for the wireless mobile device, for one of said plurality of executable service functions wherein said function-specific parameters are associated with one of said executable service functions; and
a response generating module for generating a function-specific response from one of said executable service functions, wherein said function-specific response is associated with one of said executable service functions and includes said device information.

4. The computer system of claim 3, wherein the programming interface layer further comprises a scheduling module for scheduling tasks via said executable service functions.

5. The computer system of claim 3, wherein said programming interface layer defines a plurality of classes including at least a selected one of AnswersResponse, BinaryResource, BooleanResponse, ClientInfo, CodeResponse, Concepts, ConceptsResponse, ConceptValues, ConfigFile, DeckResponse, Device, Devices, Identity, ImageResource, InfoRequest, InfoRequestResponse, InfoResponse, Message, MessageResponse, Resource, ResourceReference, ResourcesResponse, Response, Result, User, and UserDataResponse.

6. The computer system of claim 3, wherein said programming interface layer defines a plurality of methods including at least a selected one of AddMessage, Equals, AddData, GetString, GetEnumerator, CreateUser, DeleteUser, DoesUserExist, GetSignupConcepts, GetSupportedData, GetUserData, LogOn, ModifyUserData, SetIdentity, SetPassword, SetPrimaryUserData, AppendResource, AppendResourceReference, DoFeatureCommand, DoSolutionCommand, GetDeck, GetResources, SubmitConcepts, GetInfo, and GetInfoRequest.

7. A programming interface layer for service provider delivery of data services to wireless mobile devices, the programming interface layer including solution delivery functions usable by any of a plurality of vendors to deliver solutions via the service provider, the programming interface layer comprising:
a plurality of executable service functions;
a parameter processing module for processing function-specific parameters, including device information for the wireless mobile device, for one of said plurality of executable service functions wherein said function-specific parameters are associated with one of said executable service functions; and
a response generating module for generating a function-specific response from one of said executable service functions, wherein said function-specific response is associated with one of said executable service functions and includes said device information.

8. The programming interface layer of claim 7, further comprising a scheduling module for scheduling tasks via said executable service functions.

9. The programming interface layer of claim 7, further defining a plurality of classes including at least a selected one of AnswersResponse, BinaryResource, BooleanResponse, ClientInfo, CodeResponse, Concepts, ConceptsResponse, ConceptValues, ConfigFile, DeckResponse, Device, Devices, Identity, ImageResource, InfoRequest, InfoRequestResponse, InfoResponse, Message, MessageResponse, Resource, ResourceReference, ResourcesResponse, Response, Result, User, and UserDataResponse.

10. The programming interface layer of claim 7, further defining a plurality of methods including at least a selected one of AddMessage, Equals, AddData, GetString, GetEnumerator, CreateUser, DeleteUser, DoesUserExist, GetSignupConcepts, GetSupportedData, GetUserData, LogOn, ModifyUserData, SetIdentity, SetPassword, SetPrimaryUserData, AppendResource, AppendResourceReference, DoFeatureCommand, DoSolutionCommand, GetDeck, GetResources, SubmitConcepts, GetInfo, and GetInfoRequest.

11. A computer readable medium containing computer executable instructions for a programming interface layer for service provider delivery of data services to client devices, the programming interface layer including solution delivery functions usable by any of a plurality of vendors to deliver solutions via the service provider, the programming interface layer including
a plurality of executable service functions;
a parameter processing module for processing function-specific parameters, including device information for the wireless mobile device, for one of said plurality of executable service functions wherein said function-specific parameters are associated with one of said executable service functions; and
a response generating module for generating a function-specific response from one of said executable service functions, wherein said function-specific response is associated with one of said executable service functions and includes said device information.

12. The computer readable medium of claim 11, wherein the programming interface layer further comprises a scheduling module for scheduling tasks via said executable service functions.

13. The computer readable medium of claim 11, wherein said programming interface layer defines a plurality of classes including at least a selected one of AnswersResponse, BinaryResource, BooleanResponse, ClientInfo, CodeResponse, Concepts, ConceptsResponse, ConceptValues, ConfigFile, DeckResponse, Device, Devices, Identity, ImageResource, InfoRequest, InfoRequestResponse, InfoResponse, Message, MessageResponse, Resource, ResourceReference, ResourcesResponse, Response, Result, User, and UserDataResponse.

14. The computer readable medium of claim 11, wherein said programming interface layer defines a plurality of methods including at least a selected one of AddMessage, Equals, AddData, GetString, GetEnumerator, CreateUser, DeleteUser, DoesUserExist, GetSignupConcepts, GetSupportedData, GetUserData, LogOn, ModifyUserData, SetIdentity, SetPassword, SetPrimaryUserData, AppendResource, AppendResourceReference, DoFeatureCommand, DoSolutionCommand, GetDeck, GetResources, SubmitConcepts, GetInfo, and GetInfoRequest.
